(19) United States
(12) Patent Application Publication
(10) Pub. No.: US 2013/0032547 A1
(43) Pub. Date: Feb. 7, 2013

(54) STABILIZATION AND DISINFECTION OF WASTES USING HIGH ENERGY E-BEAM AND CHEMICAL OXIDANTS

(71) Applicants: Suresh D. Pillai, College Station, TX (US); Robert S. Reimers, Houston, TX (US)

(72) Inventors: Suresh D. Pillai, College Station, TX (US); Robert S. Reimers, Houston, TX (US)

(21) Appl. No.: 13/410,018

(22) Filed: Mar. 1, 2012

Related U.S. Application Data
(60) Provisional application No. 61/448,037, filed on Mar. 1, 2011.

(51) Int. Cl. C02F 9/12

(52) U.S. Cl. 210/748.16

(57) ABSTRACT

Methods relating to the synergistic application of chemical oxidants and E-beam radiation including methods of treating water and biosolids comprising providing a quantity of water or biosolid; treating the quantity of water or biosolid with a chemical oxidant; and treating the quantity of water or biosolid with E-beam radiation.

### CROSS-REFERENCE TO RELATED APPLICATIONS

The application claims the benefit of U.S. Provisional Application Ser. No. 61/448,037, filed Mar. 1, 2011, the entire disclosure of which is hereby incorporated by reference.

### BACKGROUND

Municipal sewage and sludge harbor a variety of infectious microorganisms as well as man-made and natural chemical compounds and their metabolites. Wastewater effluent is often released into nearby streams and rivers, eventually ending up in groundwater and irrigation water. Biosolids and other residuals generated from municipal wastewater treatment facilities may be used for beneficial purposes such as land application. This can create health risks for both humans and other animals.

One chemical compound in particular, namely estrogen, has been cause for concern recently. Estrogenic compounds in wastewater effluent may disrupt normal endocrine function and can lead to the “feminization” of fish, low sperm count in males, and an increased risk for breast cancer in females. The U.S. EPA and the World Health Organization (WHO) have identified endocrine disrupting chemicals (EDCs), such as estrogen and its metabolites, to be a critical emerging environmental concern.

A relatively high percentage of estrogenic compounds (estradiol, estrone, and estriol) are expected to partition into the biological suspended solids in activated sludge due to their low aqueous solubility and moderately hydrophobic character. Biosolids therefore could serve as a sink for estrogenic compounds. It is estimated that approximately, 5-10% of the estrogenic activity is associated with processed biosolids. Furthermore, estrogenic activity appears to increase as the treatment progresses in aerobic and anaerobic digestion. Thus, the ability to reduce or eliminate estrogenic activity in biosolids in conjunction with disinfection and stabilization would be a significant technological achievement.

To reduce the potential for adverse environmental and human impacts, it is critical that these municipal biosolids and wastewater effluent be disinfected to reduce pathogen loads, deactivate estrogenic compounds, and stabilize biosolids to prevent putrefication and vector attraction.

Chemicals are part of most disinfection processes. These processes can occur in the acidic range (<pH 3), in the mid range (pH 5-9), and in the alkaline range (>pH 10). Chlorine is one of the most common disinfectants used in wastewater treatment. A major problem associated with chlorination is the production of harmful (e.g., endocrine disrupting) by-products such as trihalomethanes and halo acidic acids, as a result of the high reactivity between the chlorine and organic constituents present in the sewage sludge. Studies at Tulane University have noted an increase in endocrine disrupting activity of about 70% after treatment with chlorine. Chlorine dioxide (ClO₂) is reported to be a better replacement for chlorine since it induces the production of only very low levels of carcinogenic by-products.

Ferrate has also been reported in the literature to be an effective disinfectant. Ferrates have been reportedly effective in disinfection, stabilization, odor control, nutrient immobilization, and the oxidation and destruction of refractory organics for water treatment, wastewater treatment and waste residuals treatment. Ferrate has the added advantage of being environmentally friendly compared to other common disinfectants like chlorine, in use for water treatment. Unlike halogenated disinfectants like bromine, iodine, chloramines, and chlorine, ferrate does not produce carcinogenic or mutagenic by-products which make it a better alternative for conventional water treatment. High reactivity and selectivity enables ferrate to achieve desired levels of disinfection with low doses and less contact time over a wide pH range.

However, chemical treatment alone may not be sufficient in treating water, wastewater, and biosolids.

### SUMMARY

The present disclosure generally relates to methods of treating water and biosolids using chemical treatment and E-Beam radiation. More particularly, the present disclosure relates to methods for treating water and biosolids utilizing a combined E-beam radiation and chemical treatment.

In one embodiment, the present disclosure provides a method of treating water comprising: providing a quantity of water; treating the quantity of water with a chemical oxidant; and treating the quantity of water with E-beam radiation.

In another embodiment, the present disclosure provides a method of treating a biosolid comprising: providing a biosolid, treating the biosolid with a chemical oxidant; and treating the biosolid with E-beam radiation.

In another embodiment, the present disclosure provides a method of treating a biosolid comprising: providing a biosolid, treating the biosolid with a first chemical oxidant; treating the biosolid with E-beam radiation, and treating the biosolid with a second chemical oxidant.

The features and advantages of the present invention will be apparent to those skilled in the art. While numerous changes may be made by those skilled in the art, such changes are within the spirit of the invention.

### DRAWINGS

Some specific example embodiments of the disclosure may be understood by referring, in part, to the following description and the accompanying drawings.

FIG. 1 is a chart depicting the inactivation of E. coli as a function of E-beam dose in aerobically digested biosolids collected on different days.

FIG. 2 is a chart depicting the inactivation of E. coli as a function of E-beam dose in anaerobically digested biosolids collected on different days.

FIG. 3 is a chart depicting the inactivation of aerobic spores as a function of E-beam dose in aerobically digested biosolids collected on different days.

FIG. 4 is a chart depicting the inactivation of aerobic spores as a function of E-beam dose in anaerobically digested biosolids collected on different days.

FIG. 5 is a chart depicting the inactivation of anaerobic spores (C. perfringens) as a function of E-beam dose in aerobically digested biosolids.

FIG. 6 is a chart depicting the inactivation of anaerobic spores (C. perfringens) as a function of E-beam dose in anaerobically digested biosolids.

FIG. 7 is a chart depicting the inactivation of Salmonella spp. as a function of E-beam dose in aerobically digested biosolids collected on different days.

FIG. 8 is a chart depicting the inactivation of Salmonella spp. as a function of E-beam dose in anaerobically digested biosolids collected on different days.

FIG. 9 is a chart depicting the inactivation of somatic coliphages as a function of E-beam dose in aerobically digested biosolids.

FIG. 10 is a chart depicting the inactivation of somatic coliphages as a function of E-beam dose in anaerobically digested biosolids.

FIG. 11 is a chart depicting the inactivation of male-specific coliphages as a function of E-beam dose in aerobically digested biosolids.

FIG. 12 is a chart depicting the inactivation of male-specific coliphages as a function of E-beam dose in anaerobically digested biosolids.

FIG. 13 is a chart depicting the inactivation of poliovirus type 1 as a function of E-beam dose in anaerobically digested biosolids.

FIG. 14 is a chart depicting the inactivation of rotavirus as a function of E-beam dose in anaerobically digested Biosolids.

FIG. 15 is a chart depicting the inactivation of S. Typhimurium as a function of chlorine dioxide concentration alone and in combination with a 2 kGy E-beam dose in aerobically digested biosolids.

FIG. 16 is a chart depicting the inactivation of S. Typhimurium as a function of chlorine dioxide concentration alone and in combination with a 2 kGy E-beam dose in anaerobically digested biosolids.

FIG. 17 is a chart depicting the inactivation of E. coli as a function of chlorine dioxide concentration alone and in combination with a 2 kGy E-beam dose in aerobically digested biosolids.

FIG. 18 is a chart depicting the inactivation of E. coli as a function of chlorine dioxide concentration alone and in combination with a 2 kGy E-beam dose in anaerobically digested biosolids.

FIG. 19 is a chart depicting the inactivation of aerobic spores (Bacillus subtilis) as a function of chlorine dioxide concentration alone and in combination with a 2 kGy E-beam dose in aerobically digested biosolids.

FIG. 20 is a chart depicting the inactivation of aerobic spores (Bacillus subtilis) as a function of chlorine dioxide concentration alone and in combination with a 2 kGy E-beam dose in anaerobically digested biosolids.

FIG. 21 is a chart depicting the inactivation of anaerobic spores (C. perfringens) as a function of chlorine dioxide concentration alone and in combination with a 2 kGy E-beam dose in aerobically digested biosolids.

FIG. 22 is a chart depicting the inactivation of anaerobic spores (C. perfringens) as a function of chlorine dioxide concentration alone and in combination with a 2 kGy E-beam dose in anaerobically digested biosolids.

FIG. 23 is a chart depicting the inactivation of somatic coliphages as a function of chlorine dioxide concentration alone and in combination with a 2 kGy E-beam dose in aerobically digested biosolids.

FIG. 24 is a chart depicting the inactivation of somatic coliphages as a function of chlorine dioxide concentration alone and in combination with a 2 kGy E-beam dose in anaerobically digested biosolids.

FIG. 25 is a chart depicting the inactivation of male-specific coliphages as a function of chlorine dioxide concentration alone and in combination with a 2 kGy E-beam dose in aerobically digested biosolids.

FIG. 26 is a chart depicting the inactivation of male-specific coliphages as a function of chlorine dioxide concentration alone and in combination with a 2 kGy E-beam dose in anaerobically digested biosolids.

FIG. 27 is a chart depicting the inactivation of Poliovirus Type 1 as a function of chlorine dioxide concentration alone and in combination with a 2 kGy E-beam dose in aerobically digested biosolids.

FIG. 28 is a chart depicting the inactivation of Poliovirus Type 1 as a function of chlorine dioxide concentration alone and in combination with a 2 kGy E-beam dose in anaerobically digested biosolids.

FIG. 29 is a schematic representation of the experimental design involving ferrate and ferrate combined with E-Beam

FIG. 30 is a chart depicting the inactivation of S. Typhimurium as a function of ferrate concentration alone and in combination with an 8 kGy E-beam dose in aerobically digested biosolids.

FIG. 31 is a chart depicting the inactivation of S. Typhimurium as a function of ferrate concentration alone and in combination with an 8 kGy E-beam dose in anaerobically digested biosolids.

FIG. 32 is a chart depicting the inactivation of E. coli as a function of ferrate concentration alone and in combination with an 8 kGy E-beam dose in aerobically digested biosolids.

FIG. 33 is a chart depicting the inactivation of E. coli as a function of ferrate concentration alone and in combination with an 8 kGy E-beam dose in anaerobically digested biosolids.

FIG. 34 is a chart depicting the inactivation of aerobic spores as a function of ferrate concentration alone and in combination with an 8 kGy E-beam dose in aerobically digested biosolids.

FIG. 35 is a chart depicting the inactivation of aerobic spores as a function of ferrate concentration alone and in combination with an 8 kGy E-beam dose in anaerobically digested biosolids.

FIG. 36 is a chart depicting the inactivation of anaerobic spores as a function of ferrate concentration alone and in combination with an 8 kGy E-beam dose in aerobically digested biosolids.

FIG. 37 is a chart depicting the inactivation of anaerobic spores as a function of ferrate concentration alone and in combination with an 8 kGy E-beam dose in anaerobically digested biosolids.

FIG. 38 is a chart depicting the inactivation of somatic coliphages as a function of ferrate concentration alone and in combination with an 8 kGy E-Beam dose in aerobically digested biosolids.

FIG. 39 is a chart depicting the inactivation of somatic coliphages as a function of ferrate concentration alone and in combination with an 8 kGy E-Beam dose in anaerobically digested biosolids.

FIG. 40 is a chart depicting the inactivation of male-specific coliphages as a function of ferrate concentration alone and in combination with an 8 kGy E-Beam dose in aerobically digested biosolids.

FIG. 41 is a chart depicting the inactivation of male-specific coliphages as a function of ferrate concentration alone and in combination with an 8 kGy E-beam dose in anaerobically digested biosolids.

FIG. 42 is a chart depicting the inactivation of Poliovirus Type 1 as a function of ferrate concentration alone and in combination with an 8 kGy E-Beam dose in aerobically digested biosolids.

FIG. 43 is a chart depicting the inactivation of Poliovirus Type 1 as a function of ferrate concentration alone and in combination with an 8 kGy E-Beam dose in anaerobically digested biosolids.

FIG. 44 shows the destruction of estrogenic activity of water soluble 17 βEstradiol in treated effluent by E-Beam at 8 kGy. The samples were analyzed using the ZR-75 cancer cell line.

FIG. 45 shows the destruction of estrogenic activity in drinking water by 10 MeV E-Beam at varying doses. The samples were analyzed using the ZR-75 cancer cell line. Error Bars Represent Standard Error (n=3)

FIG. 46 shows the destruction of estrogenic activity in chlorine treated effluent by 10 MeV E-Beam at varying doses. The samples were analyzed using the ZR-75 cancer cell Line. Error bars represent standard error (n=3).

FIG. 47 shows the destruction of estrogenic activity in biosolids by 10 MeV E-Beam at varying doses. The samples were analyzed using the ZR-75 cancer cell line. Error bars represent standard error (n=3).

FIG. 48 shows the relationship between absorbance readings using the YES assay and known E2 concentrations.

FIG. 49 shows the relationship between E2 concentrations (estrogenic activity) and absorbance as measured by the YES assay.

FIG. 50 shows the estrogenic activity in the liquid portion of aerobically digested biosolid samples spiked with E2 and treated with varying E-Beam doses and measured at 26 hours using the YES assay. Error bars represent standard error (n=3).

FIG. 51 shows the estrogenic activity in the liquid portion of aerobically digested biosolid samples spiked with E2 and treated with varying E-Beam doses and measured at 27 hours using the YES assay. Error bars represent standard error.

FIG. 52 shows the estrogenic activity in the liquid portion of aerobically digested biosolid samples spiked with E2 and treated with varying E-Beam doses and analyzed using the ZR-75 cancer cell line. Error bars represent standard error (n=3).

FIG. 53 shows the estrogenic activity in the liquid portion of aerobically digested biosolid samples spiked with E2 and treated with 100 ppm and 125 ppm chlorine dioxide and analyzed using the YES assay. Error bars represent standard error (n=3).

FIG. 54 shows the estrogenic activity in the liquid portion of anaerobically digested biosolid samples spiked with E2 and treated with 100 ppm and 125 ppm chlorine dioxide and analyzed using the YES Assay. Error bars represent standard error (n=3).

FIG. 55 shows the estrogenic activity in the liquid portion of aerobically digested biosolid samples spiked with E2 and treated with 100 ppm and 125 ppm chlorine dioxide and 8 kGy of E-Beam and analyzed at 25 hours using the YES assay. Error bars represent standard error (n=3).

FIG. 56 shows the estrogenic activity in the liquid portion of anaerobically digested biosolid samples spiked with E2 and treated with 100 ppm and 125 ppm chlorine dioxide and 8 kGy of E-Beam and analyzed at 25 hours using the YES assay. Error bars represent standard error (n=3).

FIG. 57 shows the estrogenic activity in the liquid portion of aerobically digested biosolid samples spiked with E2 and treated with 50 ppm, 100 ppm, and 200 ppm ferrate alone and in combination with 8 kGy E-Beam and analyzed using the ZR-75 breast cancer cell assay. Error bars represent standard error (n=3).

FIG. 58 shows the estrogenic activity in the liquid portion of anaerobically digested biosolid samples spiked with E2 and treated with 50 ppm, 100 ppm, and 200 ppm ferrate alone and in combination with 8 kGy E-Beam and analyzed using the ZR-75 breast cancer cell assay. Error bars represent standard error (n=3).

FIG. 59 shows the estrogenic activity in the solid portion of aerobically digested biosolid samples spiked with E2 and treated with 50 ppm, 100 ppm, and 200 ppm ferrate alone and in combination with 8 kGy E-Beam and analyzed using the YES assay. Error bars represent standard error (n=3).

FIG. 60 shows the estrogenic activity in the solid portion of anaerobically digested biosolid samples spiked with E2 and treated with 50 ppm, 100 ppm, and 200 ppm ferrate alone and in combination with 8 kGy E-Beam and analyzed using the YES assay. Error bars represent standard error (n=3).

FIG. 61 shows the geometry surface card specification.

FIG. 62 shows the geometry cell card specification.

FIG. 63 shows an XZ Slice of the voxelized problem geometry.

FIG. 64 shows the YZ slice of the voxelized problem geometry.

FIG. 65 shows an SDEF card representing the top rectangular E-Beam source.

FIG. 66 shows an SDEF card representing the bottom rectangular E-Beam surface source.

FIG. 67 shows tally cards used to calculate energy deposited per source particle in each problem voxel.

FIG. 68 shows depth-dose curves for all (x,y) positions in aerobically digested municipal biosolids material.

FIG. 69 shows depth-dose curves for all (x,y) positions in anaerobically digested municipal biosolids material.

FIG. 70 shows depth-dose curves for all (x,y) positions in water.

FIG. 71 shows depth-dose curves for perturbation of mass solids concentration in aerobically digested municipal biosolids.

FIG. 72 shows depth-dose curves for perturbation of mass solids concentration in anaerobically digested municipal biosolids.

FIG. 73 shows top-to-bottom dosimeter dose values for the experimental the simplified, and the detailed model benchmark studies.

FIG. 74 shows a schematic representation of an exemplary process according to one embodiment of the present disclosure.

### DESCRIPTION

The present disclosure generally relates to methods of treating water and biosolids using chemical treatment and E-Beam radiation. More particularly, the present disclosure relates to methods for treating water and biosolids utilizing the synergistic effect of a E-beam radiation and chemical oxidant treatments.

The present disclosure is based, in part, on the observation that E-beam (electron beam) radiation and chemical oxidants have a complementary and/or synergistic affect on the removal of contaminants from water (e.g., wastewater) and related solids (e.g., sludge).

The combined treatment of water with chemical oxidants and E-beam radiation include, among other things: the ability process water without aerobic and/or anaerobic digesters; enhanced solubilzation of organic material after treatment, which may enhance the efficiency of digesters; energy recovery; nutrient recovery; reduced hold time of digesters; increased cost savings; and the ability to treat water to remove microorganisms and chemicals so as to allow beneficial re-use of material (e.g., water recovery).

As used herein, the term “water” and/or “wastewater” refers to any type of water or water-solid slurry (e.g., having a solid portion and a liquid portion) or solid derived from a wastewater. For example, water may refer to surface water, drinking water, wastewater, wastewater treatment effluents, and the like. In some embodiments, wastewater may comprise a biosolid and/or sludge, wastewater generated from an aerobic and/or anaerobic treatment plant. Water and/or wastewater may comprise a microorganisms and/or pathogen such as, for example, fecal indicator organisms (such as fecal coliforms, E. coli, Enterococci, aerobic spore formers, Clostridium perfringens, and somatic coliphages), specific pathogens (namely, Salmonella and total culturable viruses), bacterial agents, viruses, spores, phages, and man made and natural chemical compounds and their metabolites. In some embodiments, the treatment methods described herein may be used to treat wastewater such as, for example, livestock waste, medical waste, animal waste, human waste, and waste from portable toilets.

In one embodiment, the present disclosure provides a method of treating water comprising: providing a quantity of water; treating the quantity of water with a chemical oxidant; and treating the quantity of water with E-beam radiation. In general, treating the quantity of water with a chemical oxidant may occur separately from treating the quantity of water with E-beam radiation. In some embodiments, the E-beam treatment may occur before and/or after treatment with the chemical oxidant. In other embodiments, chemical oxidant treatment may occur before and/or after treatment with the E-beam.

In general, any chemical oxidant may be used. Examples of suitable chemical oxidants include, but are not limited to, ozone, ozone radicals, peroxides, peroxide radicals, mixed oxidants with hydroxide radicals, Pearson soft acid oxidants (e.g., halogenated oxides), ferrate, ferrate compounds (e.g., potassium ferrate, sodium ferrate, and the like), and chlorine dioxide. In some embodiments, the chemical oxidant may comprise at least one chemical oxidant selected from the group consisting of chlorine dioxide and ferrate. In some embodiments, the chemical oxidant may comprise a Pearson soft acid oxidant. In some embodiments, the chemical oxidant may be a combination of more than one chemical oxidant. In some embodiments, the chemical oxidant may be applied to the water in a dose of 2 mg/L to about 200 mg/L. In other embodiments, the chemical oxidant may be applied to the water in a dose of 10 mg/L to about 100 mg/L. In other embodiments, the chemical oxidant may be applied to the water in a dose of 15 mg/L to about 50 mg/L. In certain examples, in which ferrate is the chemical oxidant, the pH of the water may be at or below about 7.5. In other examples, in which ferrate is the chemical oxidant, the pH of the water may be at or above about pH 5.

In some embodiments, the E-Beam radiation may result from a high energy E-Beam. E-beam radiation is a reducing process because there is significant flux of added electrons into the system. This has been confirmed through empirical estimations of oxidation-reduction (ORP) readings. High energy E-Beam is an effective disinfection technology that can be cost-effectively used in wastewater treatment plants. Without wishing to be limited by theory, it is believed that the accelerated electrons during E-beam irradiation damage the nucleic acids either by direct or indirect “hits”. The damage to the nucleic acids can occur when the E-beam radiation ionizes an adjacent molecule, which in turn reacts with the genetic material (indirect hit). Water is very often the adjacent molecule that ends up producing a lethal product. Ionizing radiation, among other effects, causes water molecules to lose an electron, producing H₂O⁺ and e⁻. These products may react with other water molecules to produce a number of compounds including hydrogen and hydroxyl radicals, molecular hydrogen, oxygen, and hydrogen peroxide. These products in turn may react with other water molecules, with nucleic acids, and other biologically sensitive molecules. The most reactive by-products arising from the hydrolysis of water are thought to be hydroxyl radicals (OH⁻) and hydrogen peroxide (H₂O₂). These molecules are known to react with the nucleic acids and the chemical bonds that bind one nucleic acid to another in a single strand as well as with the bonds that link the adjacent base pair in an opposite strand. The damage sites on the DNA molecule may be random. The indirect effects can also cause single and double-stranded breaks of the nucleic acids molecules. Though biological systems do have a capacity to repair both single- and double-stranded breaks of the DNA backbone, the damage occurring from ionizing radiation may be so extensive that the bacterial repair of radiation damage is nearly impossible. In addition to the direct and indirect “hits” to the nucleic acids, microorganisms may be inactivated when the cellular macromolecules such as proteins, carbohydrates and lipids get damaged due to the direct “hits” or indirect effects.

In some embodiments, the E-beam radiation may be applied to the water in a dose in the range of 2 kGy to about 20 kGy. In other embodiments, the E-beam radiation may be applied to the water in a dose in the range of 8 kGy to about 15 kGy. In other embodiments, the E-beam radiation may be applied to the water in a dose in the range of 10 kGy to about 12 kGy. With wishing to be limited to theory, it is believed that the disinfection properties of some oxidants may depend upon the effective penetration of the compound into the floc particles and also upon the innate resistance of various microorganisms to the treatment. Hence supplementing the chemical oxidant treatment with E-beam irradiation may enhance microbial inactivation in wastewaters. Incorporation of E-beam irradiation also prevents the requirement of adding excess chlorine dioxide that may in turn result in the formation of toxic by-products. It is believed that the presence of suspended particles in sludge may protect target organisms from being destroyed by a treatment with a chemical oxidant. It is believed that E-beam irradiation may solubilize the sludge particles and cause a reduction in the floc size, thereby exposing the target organisms to the oxidant. It is believed that this synergistic activity leads to an enhanced reduction of target organisms during the combined disinfection of E-beam irradiation and treatment with chemical oxidant.

In some embodiments, application of E-beam radiation to the water may ionize oxygen and generate ozone. Ozone is an oxidant that may aid in disinfection of water. Accordingly, in some embodiments, at least a portion of the ozone generated by E-beam radiation may be recovered and introduced back into the water to aid disinfection.

In general, the chemical oxidant and E-beam radiation may be applied to the water sequentially or substantially simultaneously (e.g., in overlapping or simultaneous treatments). In some embodiments, the chemical oxidant may be applied to the water before the E-beam radiation is applied. For example, the water may be treated with chlorine dioxide followed by to E-beam radiation. In other embodiments, the chemical oxidant may be applied to the water after the E-beam radiation is applied. For example, the water may be treated with E-beam radiation followed by ferrate treatment. In some embodiments, the chemical oxidant may be applied both before and after the E-beam radiation is applied. For example, the water may be treated with chlorine dioxide, followed by to E-beam radiation, followed by ferrate. In some embodiments, the E-beam radiation may be applied both before and after the chemical oxidant is applied.

In some embodiments, the application of the chemical oxidant and the E-bream radiation to the water results in an increase in organic carbon that is greater than which occurs using the chemical oxidant or E-beam radiation alone. It is believed that the increased amount of organic carbon decreases the digester holding time (e.g., a greater than or equal to 50% reduction) of the treated water and increases the amount of methane produced in the digester. The reduction in holding time offers a significant cost savings, as well as improved process efficiency. In some embodiments, the increased methane produced may be recovered as an energy source.

In some embodiments, the methods described herein result in the stabilization of biosolids (e.g., municipal sludge). In other embodiments, the methods described herein result in inhibiting growth and re-growth of microorganisms in the treated water and/or biosolids. In some embodiments, the treated biosolids may be used an organically enhanced fertilizers and soil amender for the restoration of rangelands, forestation, acid-mine regions, and desertificated soils. Such treated biosolids represent a form of nutrient recovery in that such materials can be land-applied without restrictions, resulting in a cost-effective and environmentally-sustainable end-use for the material.

In certain embodiments, the combined E-beam and chemical oxidant treatments of the present disclosure may result in biosolids classified by the United States Environmental Protection Agency (U.S. EPA) as Class-A biosolids. In Class A biosolids either the density of fecal coliforms in the biosolids shall be less than 1000 MPN/g of total solids (dry-weight basis) or the density of Salmonella sp. shall be less than three MPN per four grams of total solids (dry-weight basis); the density of enteric viruses shall be less than one Plaque-Forming Unit per four grams of total solids (dry weight basis); and the density of viable helminth ova shall be less than one per four grams of total solids (dry-weight basis). In some embodiments, the methods of the present disclosure may be used in improved processes that substantially simultaneously disinfect and break-up biosolids. For example, the methods of the present disclosure may be used in an anaerobic, mesophilic digester (for example, operating at temperatures of from about 35° C. to about 50° C.), which produce methane and may result in generation of Class-A biosolids.

In certain embodiments, the combined E-beam and chemical oxidant treatments of the present disclosure may be used in a process having a step in which E-beam radiation is applied during a primary treatment and/or primary clarification of wastewater. Such an approach may reduce the number of microbial pathogens and breakdown refractory organic compounds, which may allow shorter residence time for subsequent steps providing significant cost savings.

In certain embodiments, the combined E-beam and chemical oxidant treatments of the present disclosure may utilize both reductive and oxidative treatments. One such process may be an electron beam-chemical oxidation (EChO) process. In the EchO process, E-beam radiation may be used in conjunction with a chemical oxidant. Although E-beam radiation is normally considered to initiate an oxidative process on the matter it irradiates, when using E-beam radiation at high does rates, it has been discovered a reductive process is initiated. When a chemical oxidant is further utilized in this process, a synergistic effect may be utilized in the treatment of water and biosolids.

To facilitate a better understanding of the present invention, the following examples of certain aspects of some embodiments are given. In no way should the following examples be read to limit, or define, the entire scope of the invention.

### EXAMPLES

### Example 1

### Disinfection of Municipal Biosolids Using High Energy E-Beam

In this example, electron Beam (E-beam) irradiation experiments were carried out to determine the D-10 values of the target indicator organisms and pathogens. The D-10 value is defined as the E-beam dose (kGy) that is required for 90% reduction. The absorbed dose is proportional to the ionizing energy absorbed per unit mass of irradiated material. Identifying the D-10 value may be critical in identifying the E-beam process parameters that could be used to achieve defined orders of magnitude reduction in microbial titers. The D-10 value may also useful in comparing the radiation sensitivities of different organisms.

Five successive biosolid samples were obtained from the College Station (aerobic) and from the Texas A&M University (anaerobic) plants. Preliminary studies were performed to determine the indigenous levels of target organisms. The samples were screened for the presence of specific fecal indicator organisms (fecal coliforms, E. coli, Enterococci, aerobic spore formers, Clostridium perfringens, and somatic coliphages) and specific pathogens (namely, Salmonella and total culturable viruses).

Fecal coliforms were assayed using the 5-tube most probable number (MPN) assay as recommended by the Standard Methods. The production of acid and gas in EC medium at elevated temperatures (44.5° C.) was used as the criterion. E. coli levels were based on the formation of fluorescent colonies on LST-MUG media. Enterococci numbers were based on the use of the Enterolert™ chromogenic media by IDEXX (IDEXX Laboratories, Inc) in conjunction with the IDEXX Quanti-Tray/2000. This medium has been approved by the U.S. Environmental Protection Agency (EPA) and the American Society for Testing and Materials (ASTM) (D-6503-99) for the use of enumerating Enterococci in recreational waters. Appropriate positive and negative controls were employed to authenticate the results. Aerobic spore formers were enumerated by heat-treating aliquots of the biosolid samples for 15 minutes at 60° C. Fifty milliliters of the sample were placed in a sterile flask and heated to 60° C. for 15 minutes in a water bath. The sample was cooled down to room temperature, serially diluted and plated on LB agar and incubated 16-18 hours at 37° C. for enumeration. The protocol for anaerobic spore formers (primarily Clostridium perfringens) was adapted from the U.S. EPA, 1996, EPA Information Collection Rule microbial laboratory manual (Washington, D.C., EPA/600/R-95/178, section XI) using the mCP agar medium. The sample was processed similarly to that of the aerobic spore former enumeration. Serial dilutions (10-1 to 10-5) were prepared and aliquots of all dilutions were plated on the mCP agar. The plates were incubated anaerobically in a GasPak bag at 41° C. for 24 hours. The colonies were exposed to ammonium hydroxide fumes in a fume-hood and the formation of magenta colored colonies was noted. Magenta colored colonies were enumerated as Clostridium perfringens colonies. Phages were recovered from biosolids by repeated desorption of phages. Fifty milliliters (50 mL-wet weight) of the biosolid sample were collected and centrifuged at 15,100×g for 10 minutes in a SupraSpeed Centrifuge. The supernatant was collected in a clean sterile flask. 100 mL of sterile distilled water were added to the pellet and re-suspended using a vortex mixer or by hand. The sample was again centrifuged at 15,100×g for 10 minutes in the SupraSpeed Centrifuge. The supernatant was collected and pooled with the supernatant collected in the previous step. The total volume was measured. The pooled supernatant was filter sterilized using a 0.2 μm filter to remove any interfering bacterial cells. The filtrate was collected in a sterile container and the total filtered volume was measured. Enumeration of somatic coliphages was carried out using the Single Agar Layer method (Method 1602) (U.S. EPA, 2001) with the host bacteria E. coli CN-13. The plates were incubated overnight at 37° C. and plaques were counted after 24 hours. Serially diluted viral extracts were analyzed using the Single Agar Layer Method (Method 1602) (U.S. EPA, 2001) with host bacteria E. coli Famp+ specific for male specific coliphages. After overnight incubation at 37° C., plaques were enumerated.

Salmonella spp were enumerated in biosolid samples using the MPN format as described by the U.S. EPA method 1682 using the Modified Semisolid Rappaport-Vassiliadis (MSRV) medium. Salmonella spp were confirmed using the prescribed selective media. The ASTM Method (D-4994-89-Appendix H) (EPA White House Protocol) was used as the basis for the sample processing, and concentration of culturable viruses. The enumeration of culturable viruses from the biosolid samples was based on an in-house protocol. For the infectivity assay, the Buffalo Green Monkey Kidney (BGMK) cell line was used. One milliliter (1 ml) of elute was used to make 10-fold serial dilutions. For each dilution, 2 columns (16 wells) in 96 well plates were used. Each well was inoculated with 25 μl of the diluted samples. The levels of indigenous surrogate organisms and specific pathogens are shown in below in Tables 1-4.

TABLE 1

| | | Fecal | | Salmonella | Aerobic | Clostridium | |
|---|---|---|---|---|---|---|---|
| | % | coliforms | E. coli | spp | spores | sp. | Enterococci |
| Sample | solids | (MPN/4 g) | (MPN/4 g) | (MPN/4 g) | (CFU/4 g) | (CFU/4 g) | (MPN/4 g) |
| 1 | 3.7% | 28.1 | 28.1 | Bd^{*} | 1.7 × 10⁷ | 2.9 × 10⁴ | >2.4 × 10⁴ |
| 2 | 2.8% | 2.2 × 10⁷ | 42.9 | <0.93 | 2.20 × 10⁷ | 1.4 × 10⁵ | >2.4 × 10⁴ |
| 3 | 3.1% | 5.2 | 51.8 | <0.84 | 2.2 × 10⁸ | 1.5 × 10⁵ | >2.4 × 10⁴ |
| 4 | 3.1% | NA | 52.1 | 0.94 | 4.7 × 10⁷ | Bd | >2.4 × 10⁴ |
| 5 | 2.8% | 8.4 | 47.7 | 2.93 | 2.9 × 10⁷ | 2.1 × 10⁴ | >2.4 × 10⁴ |

Bd: below detection
CFU: Colony forming unit

TABLE 2

| | | Somatic Coliphages | Culturable Viruses |
|---|---|---|---|
| Sample | Total Solids | (PFU/4 g) | (PFU/4 g) |
| 1 | 3.7% | bd* | Bd |
| 2 | 2.8% | 3.3 | Bd |
| 3 | 3.1% | 5.9 | Bd |
| 4 | 3.1% | bd* | Bd |
| 5 | 2.8% | bd* | Bd |

Bd: below detection
PFU: Plaque forming unit

TABLE 3

| | | Fecal | | Salmonella | Aerobic | Clostridium | |
|---|---|---|---|---|---|---|---|
| | % | coliforms | E. coli | spp | spores | sp. | Enterococci |
| Sample | solids | (MPN/4 g) | (MPN/4 g) | (MPN/4 g) | (CFU/4 g) | (CFU/4 g) | (MPN/4 g) |
| 1 | 2.4% | >1.8 × 10³ | 2.7 × 10³ | 1.2 | 4.8 × 10⁷ | 2.9 × 10⁴ | >2.4 × 10⁴ |
| 2 | 3.4% | 1.9 × 10³ | 1.1 × 10³ | 1.69 | 1.0 × 10⁸ | 1.3 × 10⁷ | >2.4 × 10⁴ |
| 3 | 3.4% | 1.9 × 10³ | 1.9 × 10³ | 0.84 | 5.6 × 10⁸ | 7.4 × 10⁶ | >2.4 × 10⁴ |
| 4 | 3.6% | >1.6 × 10³ | >1.6 × 10³ | 5.52 | 2.5 × 10⁷ | 7.7 × 10⁴ | >2.4 × 10⁴ |
| 5 | 3.5% | >1.6 × 10³ | >1.6 × 10³ | 7.95 | 5.5 × 10⁷ | 3.6 × 10⁵ | >2.4 × 10⁴ |

TABLE 4

| | | Somatic Coliphages | Culturable Viruses |
|---|---|---|---|
| Sample | Total Solids | (PFU/4 g) | (PFU/4 g) |
| #1 | 2.4% | 1.9 × 10² | Bd |
| #2 | 3.4% | 1.8 × 10² | Bd |
| #3 | 3.4% | 1.4 × 10² | Bd |
| #4 | 3.6% | 1.5 × 10² | Bd |
| #5 | 3.5% | 2.0 × 10² | Bd |

Bd: below detection

E-Beam irradiation experiments were then carried out to determine the D-10 values of the target indicator organisms and pathogens. Given the relatively low number of the target specific pathogens such as Salmonella and enteric viruses, the irradiation experiments employing these organisms were performed using spiked samples. Initial experiments using a MPN method for the quantification of target organisms were not successful. Subsequently, enumeration using selective media methods was chosen as the quantification method for the target bacteria. Conventional tissue culture methods were followed for the enteric viruses. The D-10 values of the indigenous spore-forming bacteria and E. coli were determined using biosolid samples collected from different days. Multiple trials were performed to determine the variability in the sensitivity of the different target organisms to the E-Beam.

Twenty milliliter samples were spiked with high titer of laboratory grown strains of Salmonella Typhimurium (accession #87-26254, obtained from the National Veterinary Service Laboratory, Ames, Iowa), E. coli phages-phi X 174 (ATCC #13706-B1) and MS-2 (ATCC #15597-B1) and Enteric virus-Poliovirus-1 (VR-1562). The samples were mixed evenly and triple packaged in Whirl-Pak™ bags (Nasco) to make them leak proof and to provide adequate protection during irradiation with the E-beam. All experiments were performed in triplicates. The inoculated samples were subjected to different target doses of E-beam irradiation based on the target microorganism. Lower doses ranging from 0.2-1 kGy were employed for samples spiked with bacterial agents, whereas higher doses ranging between 1 and 10 kGy were employed for samples with viruses, spores, and phages.

E-beam irradiation was carried out at the National Center for Electron Beam Research on the Texas A&M University campus using the 10 MeV E-beam source. The absorbed E-beam dose was measured using L-α-alanine dosimeters (tablets) and an electron spin paramagnetic resonance spectrometer (Bruker BioSpin Corp., Billerica). The irradiated samples were stored at 4° C. until they were subjected to microbiological analysis.

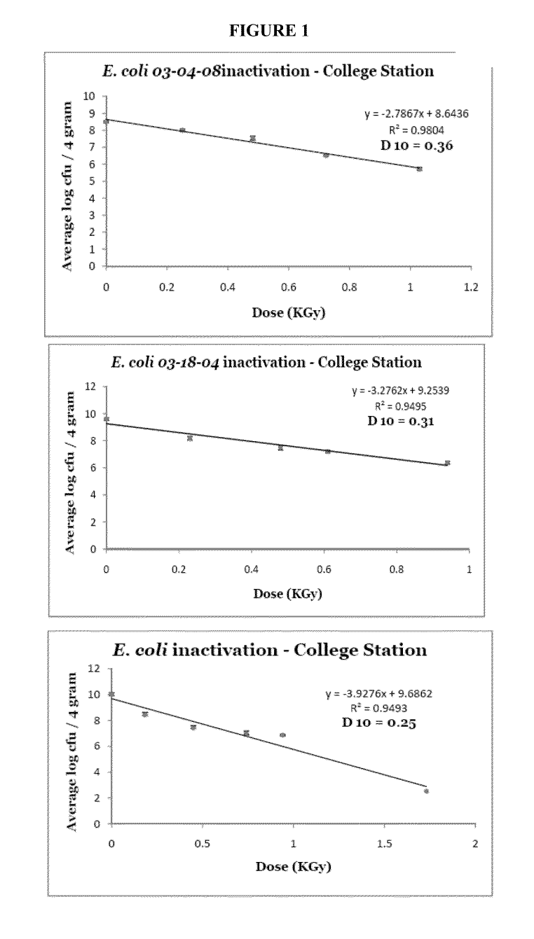

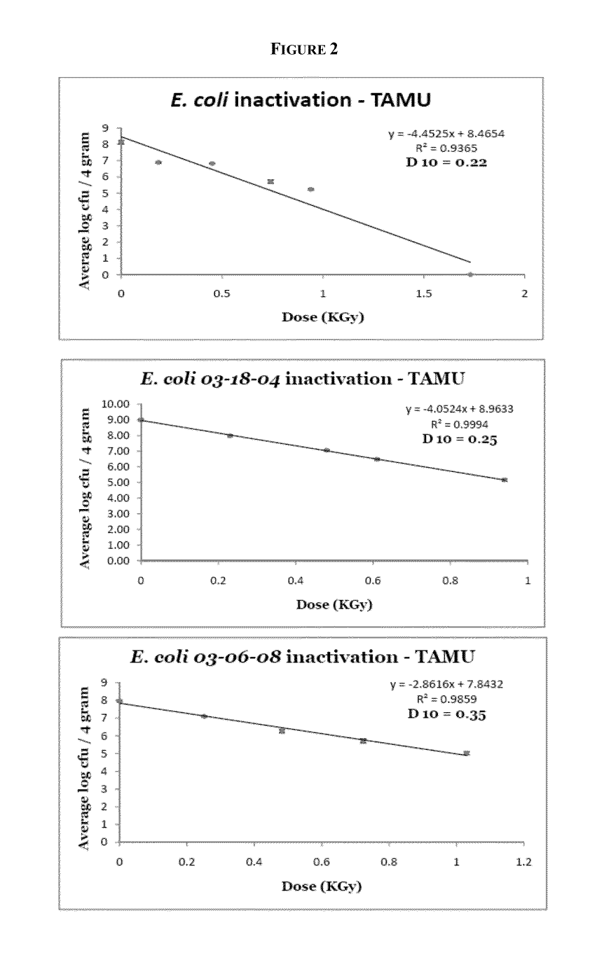

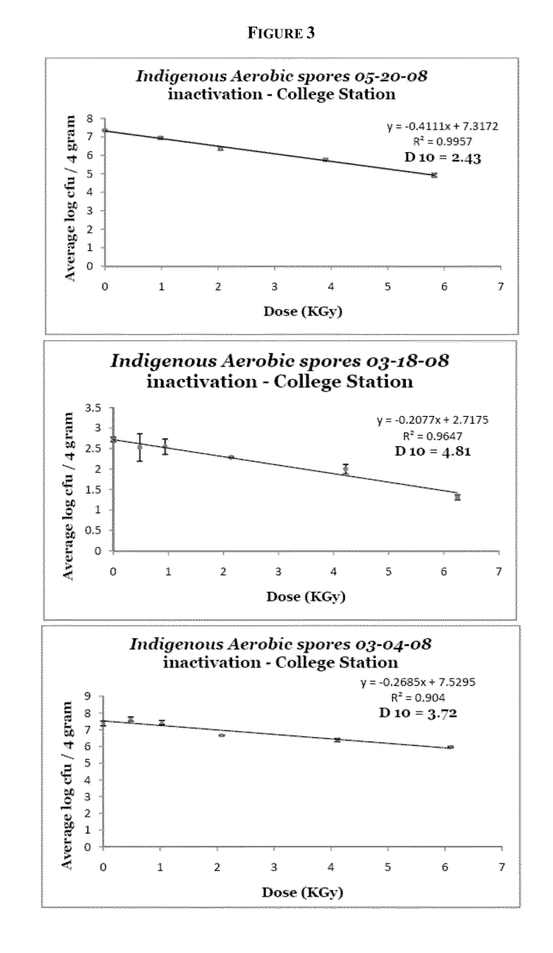

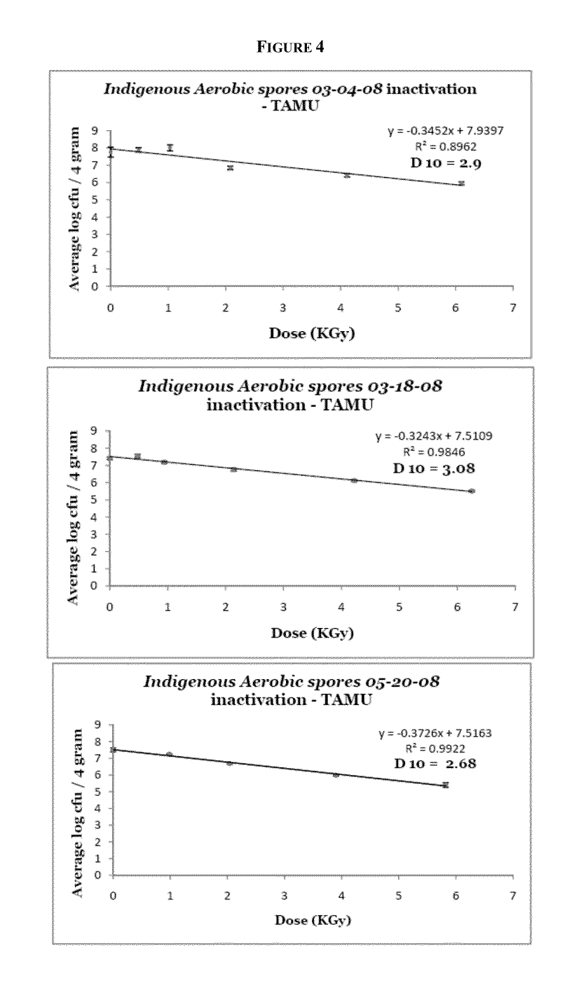

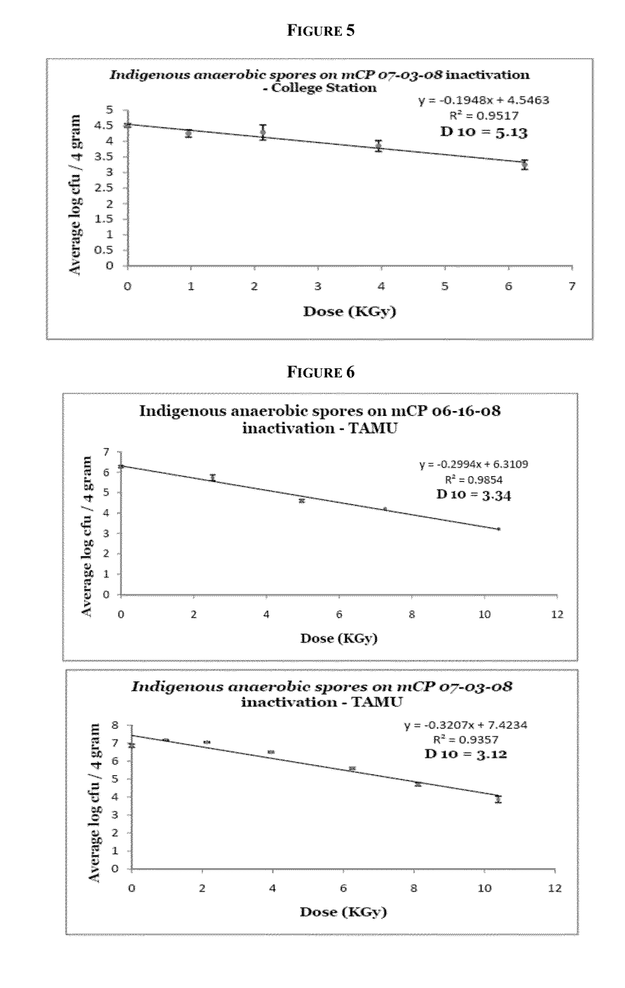

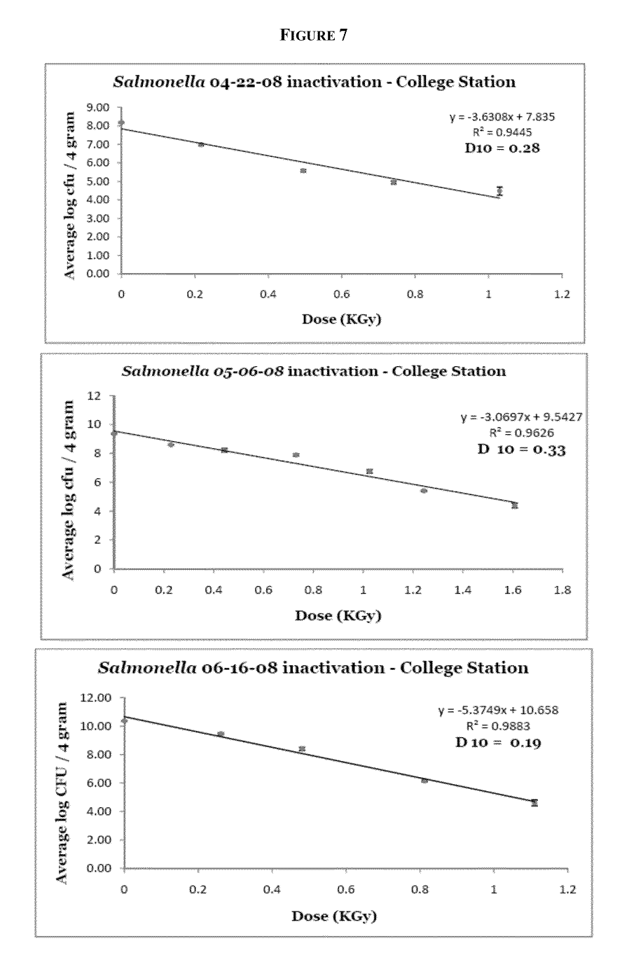

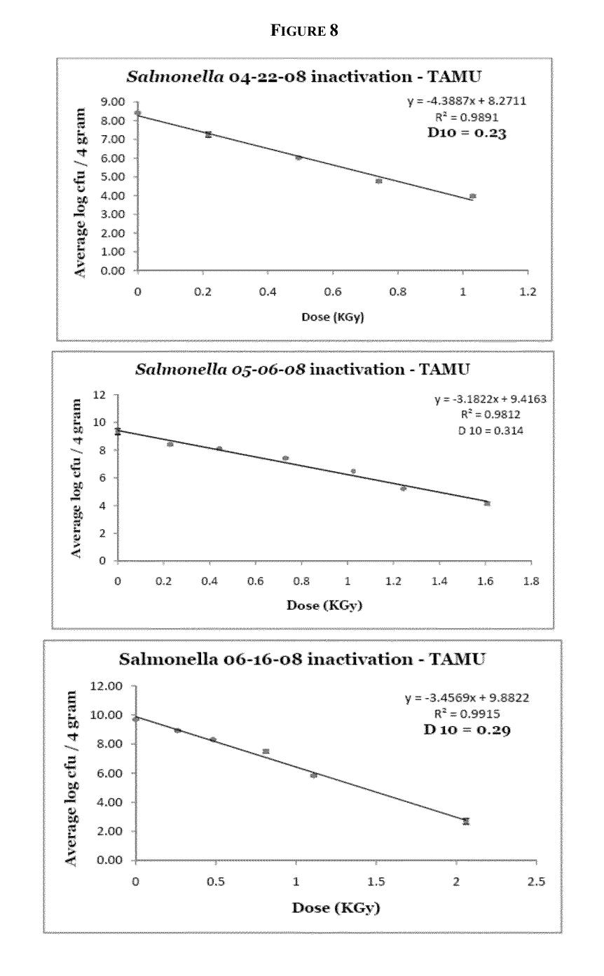

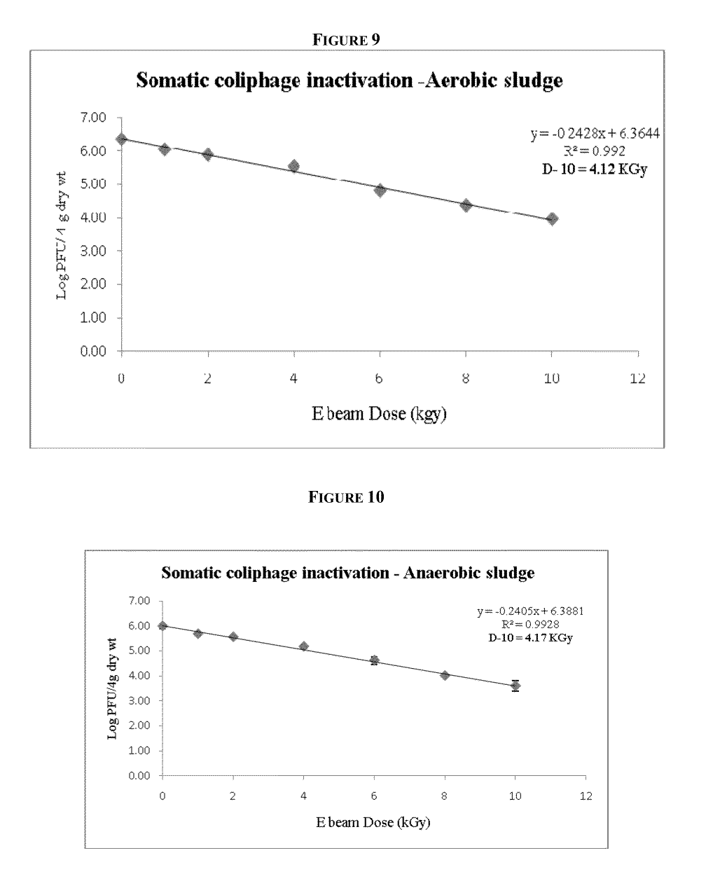

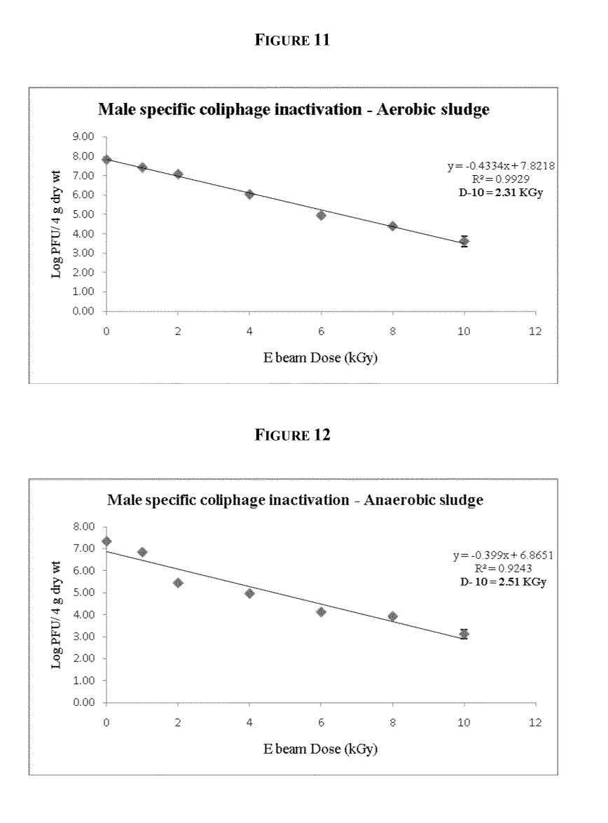

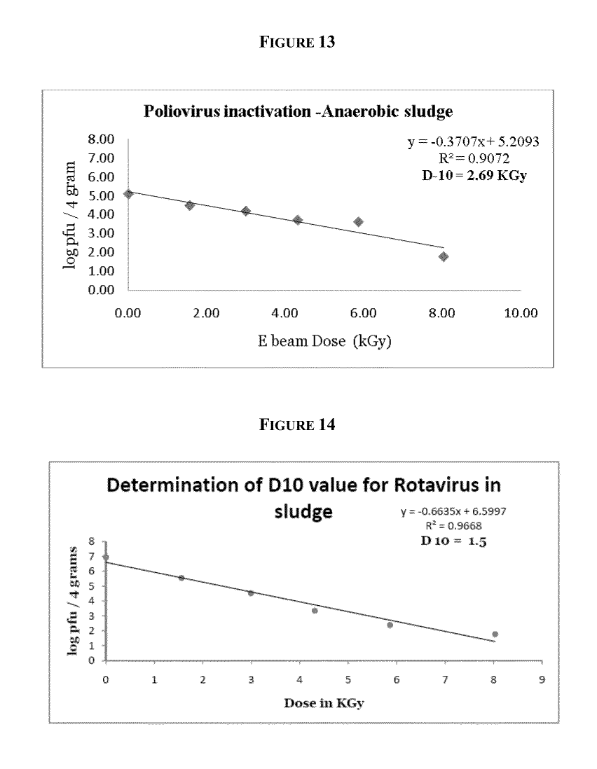

A survivor curve was plotted using a linear regression function, based on the counts obtained for each of the microorganism from the samples irradiated with different doses. The slope of the survivor or pathogen inactivation curve was determined and the D-10 value was calculated by taking the negative reciprocal of the slope. The inactivation of the target microorganisms as a function of E-beam dose is shown in FIGS. 1-14.

The radiation sensitivity of specific microorganisms is expressed in terms of its decimal reduction dose or D-10 value, which indicates the amount of absorbed dose required to kill 90% of the microbial population. The D-10 value (in aerobic and anaerobic sludge samples) was calculated for all the organisms that were included in this example. Table 5 summarizes the D-10 values of the target organisms in aerobically and anaerobiocally treated sludge samples.

TABLE 5

| | | D₁₀ value |
|---|---|---|
| Target Organism | Biosolid Matrix | (range) kGy |
| Indigenous E. coli | Aerobic digester sample | 0.26-0.41 |
| Indigenous E. coli | Anaerobic digester sample | 0.25-0.35 |
| Spiked Salmonella sp. | Aerobic digester sample | 0.18-0.35 |
| Spiked Salmonella sp. | Anaerobic digester sample | 0.23-0.33 |
| Indigenous Aerobic spores | Aerobic digester sample | 2.43-4.81 |
| Indigenous Aerobic spores | Anaerobic digester sample | 2.68-3.08 |
| Indigenous Anaerobic spores* | Aerobic digester sample | 3.34-5.13 |
| Indigenous Anaerobic spores* | Anaerobic digester sample | 3.12 |
| Indigenous somatic coliphages | Aerobic digester sample | 4.12 |
| Indigenous somatic coliphages | Anaerobic digester sample | 4.17 |
| Spiked male-specific | Aerobic digester sample | 2.31 |
| coliphages | | |
| Spiked male-specific | Anaerobic digester sample | 2.51 |
| coliphages | | |
| Spiked Poliovirus | Anaerobic digester sample | 2.69 |
| Spiked Rotavirus | Anaerobic digester sample | 1.5 |

The results indicate that the sensitivity to E-beam irradiation may differ between the different groups of organisms and may also be influenced by the matrix (aerobic digester sample or anaerobic digester sample) in which the organisms are present. The D-10 value of 0.18 and 0.33 kGy observed for Salmonella lies within the range of 0.14-2.5 kGy previously reported for the sludge pathogens. The decimal reduction dose of bacterial pathogens such as Salmonella Typhimurium and E. coli in buffer solutions using E beam irradiation has previously been studied and D-10 values of 0.30 and 0.34 kGy respectively were reported. These results are in general agreement with those previously reported values. It is important to realize that the D-10 value may not remain constant for a particular target organism. It can be a function of initial microbial population, innate genetic, and metabolic characteristics of the target organism, the physical-chemical conditions to which the organisms may have been previously exposed as well as the properties of the matrix on which the organisms are present when E-beam irradiated.

Table 5 points demonstrates that the D-10 values of E. coli and Salmonella Typhimurium were strikingly lower compared to viruses as well as spore formers. Previous experiments have been carried out to study the D-10 values of different bacteriophages in tap water using both gamma and E-beam irradiation. Those results showed that the somatic coliphages, φ X 174 were extremely resistant to radiation treatments when compared to male-specific coliphages. Somatic coliphages required a dose of approximately 0.34 kGy of gamma radiation and 0.7 kGy of E-beam radiation to bring about a 1-log reduction in the phage population. The male-specific coliphage, MS-2 was found to be more susceptible to radiation requiring only 0.045 kGy and 0.020 kGy of gamma and E-beam radiation respectively. Based on the results obtained in this example, the estimated D-10 values of somatic coliphages in aerobically and anaerobically treated sludge samples were relatively high, i.e. 4.12 kGy and 4.17 kGy, whereas that of male-specific coliphages was only 2.31 kGy and 2.51 kGy in aerobically and anaerobically digested samples respectively. This data also supports that somatic coliphages may be an ideal indicator organism for assessing the virological quality of water and sewage sludge treated by different ionizing radiation. Aerobic as well as anaerobic spore formers were also found to be resistant to E-beam radiation as indicated by their higher D-10 value compared to that of the bacterial cells. The D-10 values of spore formers were on par with that of somatic coliphages, implying their potential as indicator organisms for radiation treatment of sludge.

### Example 2

### Synergistic Disinfection of Municipal Biosolids When E-Beam is Combined with Chlorine Dioxide

The objective of this example was to understand whether the E-beam in combination with chemical oxidants such as chlorine dioxide would lead to enhanced disinfection of municipal biosolids.

Sludge samples were collected from the aerobic and anaerobic treatment plants in College Station, Tex. The samples were collected in sterile polypropylene bottles (Nalgene, Rochester, N.Y.) and transported to the laboratory in a cooler and were maintained at 4° C. until analysis. Dry weight data of the samples were recorded to determine the percentage of total solids and dry weight equivalent of the sludge.

The samples were spiked with high titers of laboratory grown strains of different organisms, which included bacteria—Salmonella Typhimurium (accession #87-26254, obtained from the National Veterinary Service Laboratory, Ames, Iowa), Escherichia coli (ATCC #25922), coliphages phi X 174 (ATCC #13706-B1) (somatic) and MS-2 (ATCC #15597-B1) (male-specific), enteric virus—Poliovirus-1 (VR-1562), aerobic spore former—Bacillus subtilis (ATCC #6633) and anaerobic spore former—Clostridium perfringens (ATCC #13124). For these experiments, the microorganisms were classified into two different groups namely “susceptible” and “resistant” groups (based upon their E-beam radiation resistance). The susceptible group was made up of Salmonella Typhimurium, E. coli and poliovirus whereas the resistant group was made up of somatic coliphages, male specific coliphages, aerobic spores and anaerobic spores. The experimental conditions were different for these two groups based on (i) E-beam doses that were employed and (ii) the chlorine dioxide concentrations used.

The spiked samples were mixed evenly and subjected to different concentrations of chlorine dioxide. Chlorine dioxide was prepared in situ through a direct reaction between 1.2 ml of 15% sodium chlorite solution and 1.2 ml of 50% sulfuric acid (H₂SO₄). The resulting solution was dissolved in 500 ml of water to obtain approximately a 300 parts per million (ppm) solution of chlorine dioxide. The protocol for the preparation of chlorine dioxide was provided by BCR Environmental, St. Augustine, Fla. In this process the chlorine dioxide gas that is produced as a result of the reaction between sodium chlorite and sulfuric acid was dissolved in water to prevent the escape of the gas. The dissolved chlorine dioxide was more stable compared to the gaseous compound. The concentration of chlorine dioxide produced was measured using a spectrophotometer (HACH DR/2010, Loveland, Colo.) with an in-built program specific for measuring chlorine dioxide concentration. The accuracy of the spectrophotometer readings was ensured by comparing them to a digital titrator which utilizes a colorimetric iodine-based titration protocol.

The “susceptible” group of microorganisms was subjected to 10, 20, and 30 ppm concentrations of chlorine dioxide, whereas the “resistant” group received higher concentrations, namely 25, 50, and 75 ppm. After the addition of different chlorine dioxide concentrations, the samples were mixed gently for two hours at room temperature to allow for sufficient contact with the sludge matrix. Spiked controls were maintained without chlorine dioxide treatment to enumerate the amount of spiked microorganisms present in each of the samples. A matrix control of the sludge samples was also stored without chlorine dioxide or E-beam treatment to quantify the indigenous population of the different target microorganism. After two hours of chlorine dioxide treatment, the samples were neutralized using 2% sodium thiosulfate which inactivated the chlorine dioxide present in the treated samples. The samples were mixed evenly and 20 ml of the samples were triple packaged in whirl pack bags (Nasco, N.Y.), to make them leak proof and to provide adequate protection while irradiating using E-beam. All of the experiments were carried out in triplicate.

The chlorine dioxide treated samples were subjected to E-beam irradiation at the National Center for Electron Beam Research on the Texas A&M University campus using a 10 MeV (megaelectron volt) linear accelerator (LINAC). The “susceptible” group of both aerobically and anaerobically treated sludge samples (which contained the spiked organisms) were E-beam irradiated at a dose of 2 kGy whereas the “resistant” group received a dose of 8 kGy. If the irradiation experiments would have been performed at 15 kGy, all microbial counts would have been zero and hence would not have been amenable for data analysis. The absorbed dose was measured using L-α-alanine dosimeter tablets and an electron spin paramagnetic resonance spectrometer (Bruker BioSpin Corp., Billerica, Mass.). The irradiated samples were stored at 4° C. until they were subjected to microbiological analysis. Another set of chlorine dioxide treated samples was also maintained without E-beam irradiation to study the effect of chlorine dioxide alone for disinfection. Those samples were packaged in the same manner as the E-beam irradiated ones but were not subjected to irradiation and were labeled as “0 kGy”.

The irradiated and non-irradiated bags were opened under sterile conditions and the samples were analyzed for the presence of the spiked microorganisms.

A portion of the sludge samples were serially diluted in 1× phosphate buffered saline (PBS) and 0.1 ml of the dilutions were plated on Tryptic Soy Agar (TSA) (Difco Laboratories, MI) plates containing Nalidixic acid (25 μg/ml) (Sigma, St. Louis, Mo.) and Novobiocin (25 μg/ml) (Sigma, St. Louis, Mo.). The plates were incubated overnight at 37° C. and the characteristic Salmonella colonies were enumerated.

A portion of the irradiated samples were serially diluted and 0.1 ml of the dilutions was plated on EC-MUG media (Difco Laboratories, MI) and plates were incubated overnight at 37° C. The plates were read under long wave (366 nm) ultra violet light and the fluorescent colonies were enumerated.

A portion of the sludge samples were thermally inactivated at 60° C. for 15 minutes using a hot water bath to destroy the vegetative cells. The heat-inactivated samples were serially diluted, and 0.1 ml of the dilutions were plated on TSA (Difco Laboratories, MI) plates and incubated overnight at 37° C.

A portion of the sludge samples were heated at 60° C. for 15 minutes (to destroy vegetative cells), and the heat-inactivated samples were serially diluted in 1×PBS. Perfringens agar base, including tryptose sulfite cycloserine (TSC) and Shahidi Ferguson perfringens (SFP) (Oxoid, Hampshire) media was prepared and m-CP selective supplement I (Fluka, Buchs, Switzerland) was added (1 vial/500 ml). The media was dispensed into petri plates along with 1 ml of the samples and swirled. The plates were then incubated overnight in anaerobic jars at 37° C. Black colored colonies were enumerated which indicated the presence of Clostridium perfringens.

A portion of the sludge samples were extracted using 3% beef extract (pH 9.0) to extract coliphages. An in-house protocol was standardized for virus extraction from biosolids samples using 3% beef extract. It was found that the recovery efficiency of the viral extract obtained using beef extract was high compared to the viral extract obtained using the Chetochine protocol. The viral extracts were filtered using 0.22 μm filters (Millipore, Billerica, Mass.) to remove bacterial interferences. The viral extracts were serially diluted for phage and enteric virus analysis. The somatic phages were enumerated using the Single Agar Layer Method (Method 1602) (U.S. EPA, 2001) with the host bacteria E. coli CN-13. The plates were incubated overnight at 37° C. and plaques were counted after 24 hours.

The male-specific coliphages were analyzed using the Single Agar Layer Method (Method 1602), (U.S. EPA, 2001) with host bacteria E. coli Fₐₘₚ⁺ specific for male specific coliphages. After overnight incubation at 37° C., plaques were enumerated.

The viral extract obtained from the sludge samples were also used for Poliovirus Type 1 estimation using tissue culture methods. Infectivity assays were carried out in 6 well plates using the BGMK cell line. 0.2 ml of the samples as well as dilutions were used for infection of the BGMK cells and the plates were incubated at 37° C. at 5% CO₂ atmosphere for 24 hours. Plaques were enumerated after staining the plates with 0.1% crystal violet.

The values obtained from the resulting inactivation data were converted to log₁₀ and plotted against the respective chlorine dioxide concentrations and the combined E-beam+chlorine dioxide treatments. The disinfection efficiencies of ClO₂ by itself and the combination treatment of ClO₂ and E-beam were determined by analyzing the log₁₀ reduction in the microbial population subjected to different treatments as compared to that of the spiked control, which did not receive any disinfection treatment. In order to compare the pathogen reduction between the different treatments, and within treatments, paired-t-tests were carried out using the statistical software package SPSS (SPSS Inc., Chicago, Ill.).

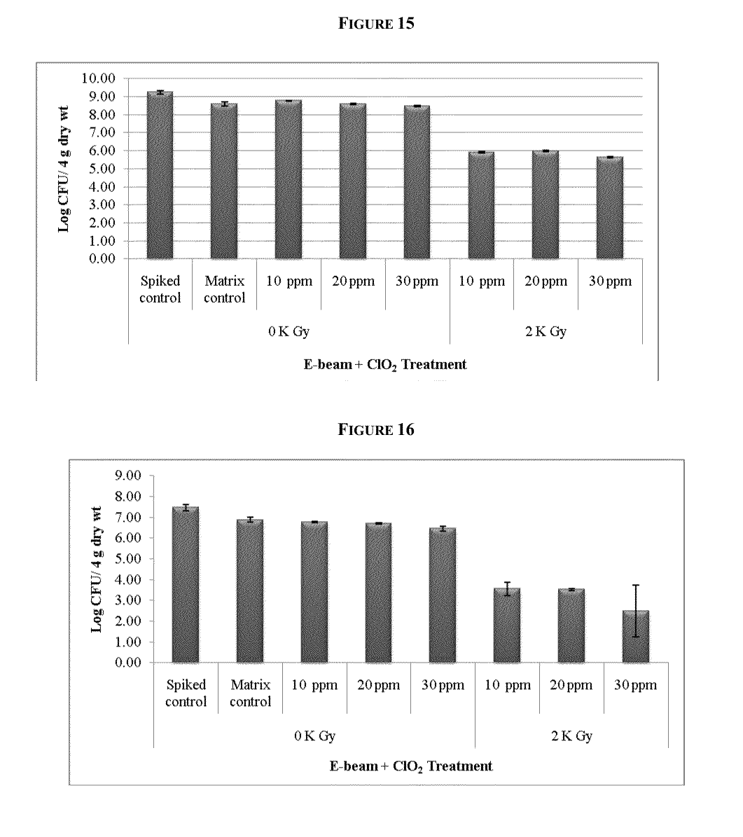

The disinfection efficiencies of chlorine dioxide and the combination of E-beam plus chlorine dioxide were studied by dividing the spiked sludge samples into groups. The susceptible group was comprised of Salmonella Typhimurium, E. coli and poliovirus, whereas the resistant group included somatic coliphages, male specific coliphages, aerobic, and anaerobic spores. FIGS. 15 and 16 illustrate Salmonella Typhimurium inactivation as a result of chlorine dioxide treatment in aerobic and anaerobic biosolids. Table 6 provides a summary of the statistical analyses.

TABLE 6

| | | | |
|---|---|---|---|
| | Paired | | |
| Treatment comparison | t-test value | df | p-value |

Salmonella Typhimurium - aerobically digested sludge

| | | | |
|---|---|---|---|
| 10 ppm ClO₂ Vs 10 ppm ClO₂ + | 54.466 | 2 | .000** |
| 2 kGy E-beam | | | |
| 20 ppm ClO₂ Vs 20 ppm ClO₂ + | 37.017 | 2 | .001** |
| 2 kGy E-beam | | | |
| 30 ppm ClO₂ Vs 30 ppm ClO₂ + | 37.705 | 2 | .001** |
| 2 kGy E-beam | | | |

Salmonella Typhimurium - anaerobically digested sludge

| | | | |
|---|---|---|---|
| 10 ppm ClO₂ Vs 10 ppm ClO₂ + | 9.794 | 2 | .010* |
| 2 kGy E-beam | | | |
| 20 ppm ClO₂ Vs 20 ppm ClO₂ + | 45.654 | 2 | .000** |
| 2 kGy E-beam | | | |
| 30 ppm ClO₂ Vs 30 ppm ClO₂ + | 3.462 | 2 | .074 |
| 2 kGy E-beam | | | |

df = degrees of freedom
p-value = statistical measure indicating statistical significance
*significance level 0.05;
**significance level 0.01

Salmonella Typhimurium did not show any significant reduction with chlorine dioxide treatment up to 30 ppm upon a pair-wise comparison with 10 ppm of ClO₂ (p=0.036). With a combination of 10 ppm chlorine dioxide and 2 kGy of E-beam irradiation, a significant 3-log reduction was observed for both aerobically and anaerobically treated sludge (p-value 0.00 and 0.010 respectively).

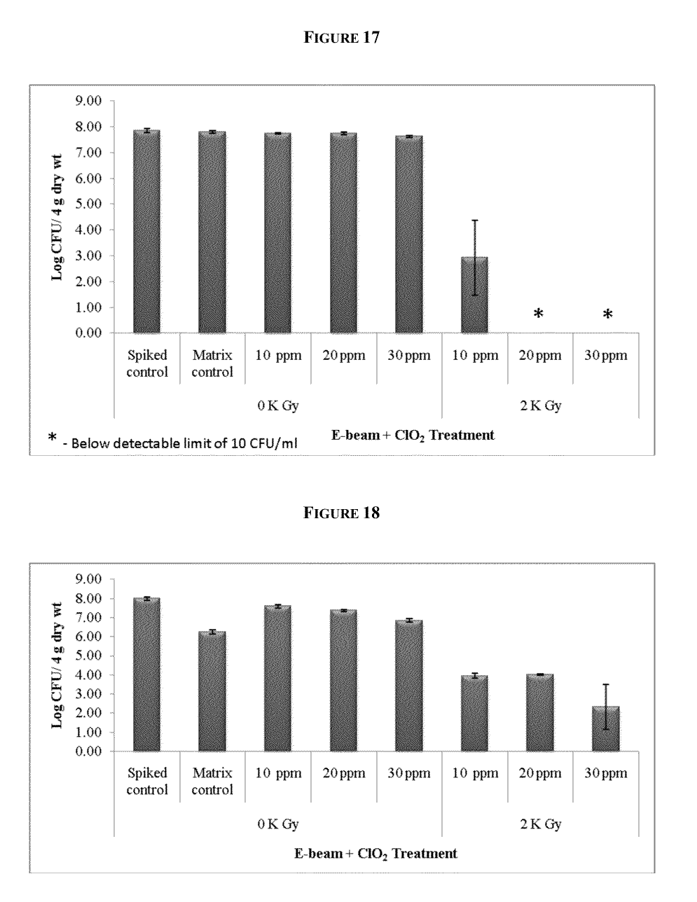

E. coli did not exhibit any reduction in the presence of chlorine dioxide alone, as shown in FIG. 17. However, E. coli was found to be most susceptible to chlorine dioxide when combined with E-beam. In aerobically digested biosolid samples, the synergistic effect of combining E-beam with chlorine dioxide is clearly evident, as shown in FIG. 17. Aerobically treated sludge samples showed complete reduction of E. coli (approximately 8 log) with the synergistic effect of chlorine dioxide (30 ppm) and 2 kGy E-beam, whereas only a 4 to 5 log reduction was observed for anaerobically treated samples, as shown in FIG. 18. Table 7 is the summary of the pair-wise statistical comparisons of inactivation in the presence of chlorine dioxide either singly or in combination with 2 kGy E-beam treatment in the aerobic and anaerobically digested samples.

TABLE 7

| | | | |
|---|---|---|---|
| | Paired | | |
| Treatment comparison | t-test value | df | p-value |

E. coli- aerobically digested sludge

| | | | |
|---|---|---|---|
| 10 ppm ClO₂ Vs 10 ppm ClO₂ + | 3.347 | 2 | .079 |
| 2 kGy E-beam | | | |
| 20 ppm ClO₂ Vs 20 ppm ClO₂ + | 148.063 | 2 | .000** |
| 2 kGy E-beam | | | |
| 30 ppm ClO₂ Vs 30 ppm ClO₂ + | 203.027 | 2 | .000** |
| 2 kGy E-beam | | | |

E. coli- anaerobically digested sludge

| | | | |
|---|---|---|---|
| 10 ppm ClO₂ Vs 10 ppm ClO₂ + | 20.579 | 2 | .002** |
| 2 kGy E-beam | | | |
| 20 ppm ClO₂ Vs 20 ppm ClO₂ + | 33.206 | 2 | .001** |
| 2 kGy E-beam | | | |
| 30 ppm ClO₂ Vs 30 ppm ClO₂ + | 3.600 | 2 | .069 |
| 2 kGy E-beam | | | |

df = degrees of freedom
p-value = statistical measure indicating statistical significance
*significance level 0.05;
**significance level 0.01

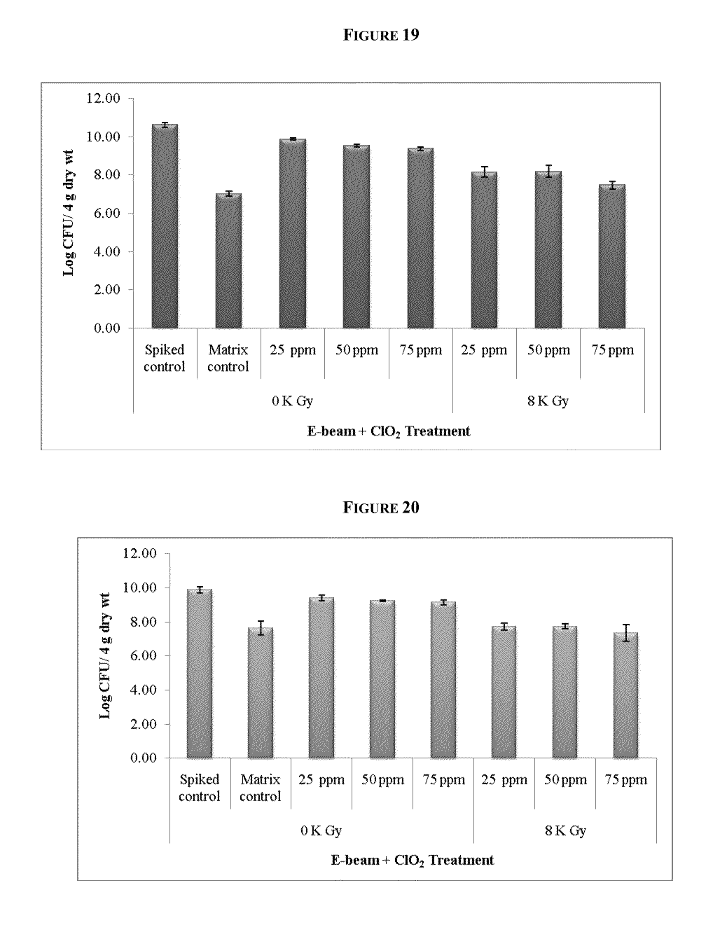

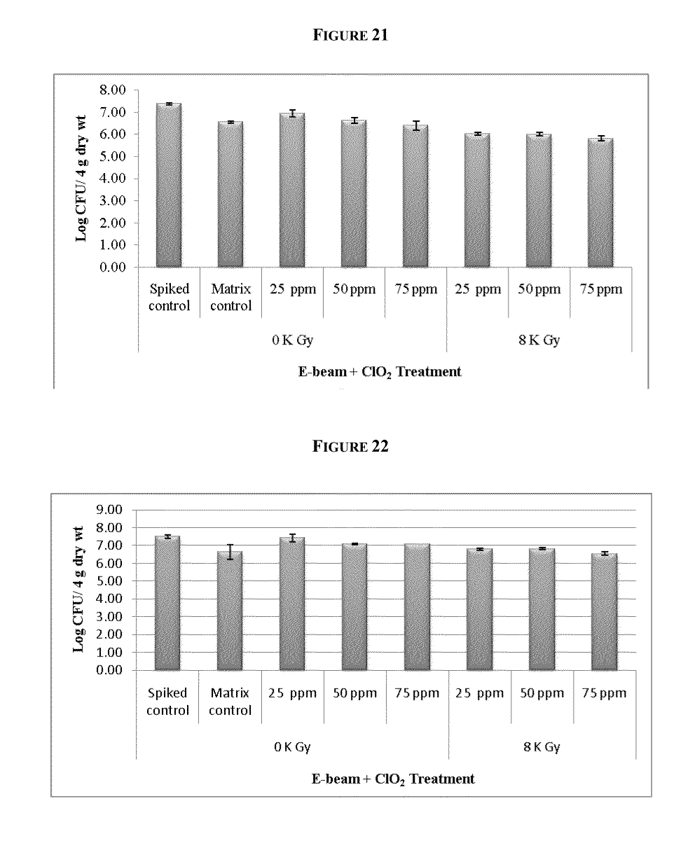

Aerobic and anaerobic spores were subjected to higher doses compared to bacteria—25, 50, and 75 ppm of ClO₂ and 8 kGy of E-beam irradiation, as shown in FIGS. 19-22. Both aerobic and anaerobic spores were generally resistant to the ClO₂ with no more than approximately a one log reduction even at 75 ppm and with an E-beam dose of 8 kGy. Approximately a 2 log reduction was observed in the case of aerobic spores, as shown in FIG. 19. Reduction in the aerobic spore population could be observed with an increase in ClO₂ concentration to 75 ppm in aerobically digested sludge (p=0.013). But the difference is not significant in case of anaerobically treated sludge (p>0.05).

Table 8 depicts the pair-wise comparison of ClO₂ and the corresponding combination treatment with E-beam. Significant differences could be observed in both aerobically and anaerobically treated sludge samples with p<0.05. An increase in the concentration of ClO₂ alone did not make any significant difference in the anaerobic spore populations, given by p>0.05 in both aerobically and anaerobically treated sludge samples.

TABLE 8

| | | | |
|---|---|---|---|
| | Paired | | |
| Treatment comparison | t-test value | df | p-value |

Aerobic spores- aerobically digested sludge

| | | | |
|---|---|---|---|
| 25 ppm ClO₂ Vs 25 ppm ClO₂ + | 5.583 | 2 | .031* |
| 8 kGy E-beam | | | |
| 50 ppm ClO₂ Vs 50 ppm ClO₂ + | 5.979 | 2 | .027* |
| 8 kGy E-beam | | | |
| 75 ppm ClO₂ Vs 75 ppm ClO₂ + | 10.842 | 2 | .008** |
| 8 kGy E-beam | | | |

Aerobic spores- anaerobically digested sludge

| | | | |
|---|---|---|---|
| 25 ppm ClO₂ Vs 25 ppm ClO₂ + | 11.040 | 2 | .008** |
| 8 kGy E-beam | | | |
| 50 ppm ClO₂ Vs 50 ppm ClO₂ + | 8.533 | 2 | .013* |
| 8 kGy E-beam | | | |
| 75 ppm ClO₂ Vs 75 ppm ClO₂ + | 3.084 | 2 | .091 |
| 8 kGy E-beam | | | |

df = degrees of freedom
p-value = statistical measure indicating statistical significance
*significance level 0.05;
**significance level 0.01

Even the combination treatment could not bring about any significant reductions in the anaerobic spores in both the aerobic and anaerobic sludge, as shown in Table 9. This clearly shows that there may be an inherent resistance of anaerobic spores towards ClO₂ as well as the combined disinfection of 8 kGy E-beam plus 75 ppm chlorine dioxide.

TABLE 9

| | | | |
|---|---|---|---|
| | Paired | | |
| Treatment comparison | t-test value | df | p-value |

Anaerobic spores- aerobically digested sludge

| | | | |
|---|---|---|---|
| 25 ppm ClO₂ Vs 25 ppm ClO₂ + | 3.869 | 2 | .061 |
| 8 kGy E-beam | | | |
| 50 ppm ClO₂ Vs 50 ppm ClO₂ + | 6.773 | 2 | .021* |
| 8 kGy E-beam | | | |
| 75 ppm ClO₂ Vs 75 ppm ClO₂ + | 4.198 | 2 | .052 |
| 8 kGy E-beam | | | |

Anaerobic spores- anaerobically digested sludge

| | | | |
|---|---|---|---|
| 25 ppm ClO₂ Vs 25 ppm ClO₂ + | 2.550 | 2 | .125 |
| 8 kGy E-beam | | | |
| 50 ppm ClO₂ Vs 50 ppm ClO₂ + | 4.303 | 2 | .050 |
| 8 kGy E-beam | | | |
| 75 ppm ClO₂ Vs 75 ppm ClO₂ + | 5.596 | 2 | .030* |
| 8 kGy E-beam | | | |

df = degrees of freedom
p-value = statistical measure indicating statistical significance
*significance level 0.05;
**significance level 0.01

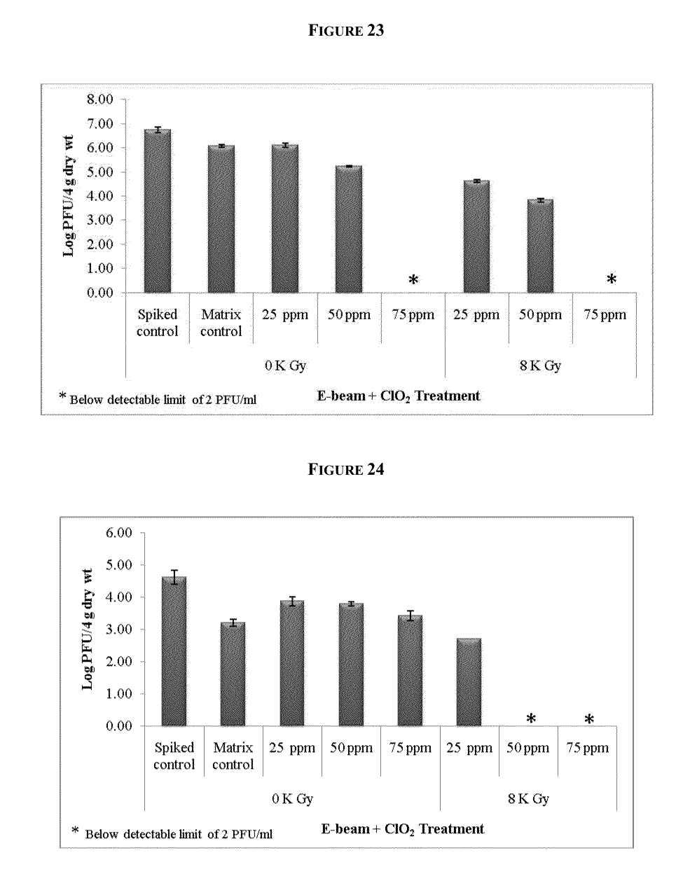

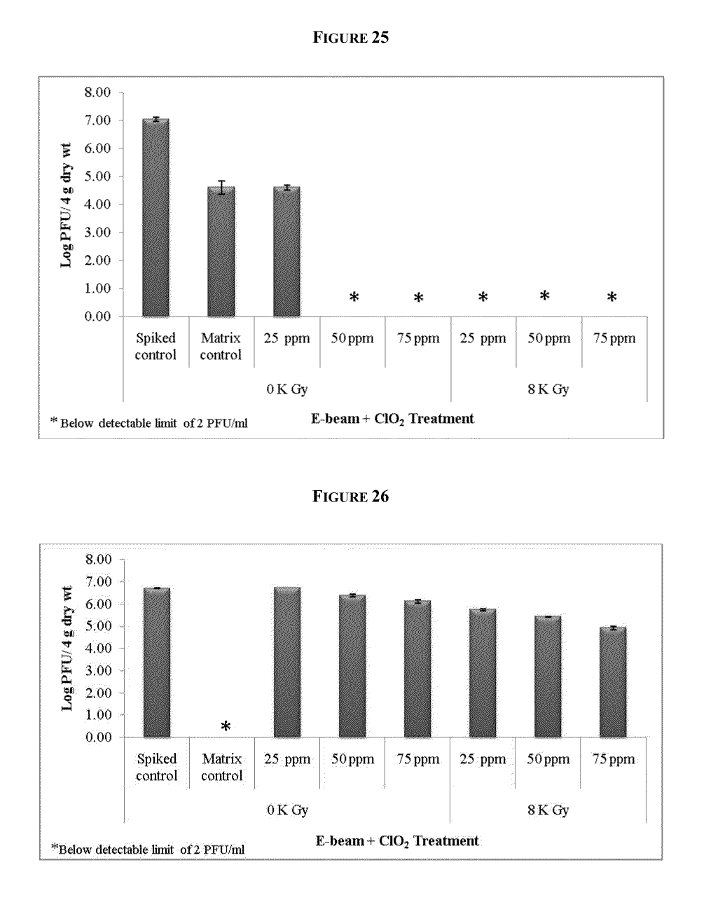

Somatic coliphages (approx 10⁷/4 g dry weight) were effectively eliminated by the ClO₂ alone at 75 ppm in aerobically treated biosolids, as shown in FIG. 23. The combination of chlorine dioxide and 8 kGy E-beam did result in a significant reduction in somatic coliphage numbers in the aerobic sludge, as shown below in Table 10 and in FIG. 23. In the anaerobically digested biosolids, the chlorine dioxide in combination with E-beam resulted in significant reductions of somatic coliphages even at doses as low as 50 ppm, as shown in FIG. 24.

TABLE 10

| | | | |
|---|---|---|---|
| | Paired | | |
| Treatment comparison | t-test value | df | p-value |

Somatic coliphages- aerobically digested sludge

| | | | |
|---|---|---|---|
| 25 ppm ClO₂ Vs 25 ppm ClO₂ + | 8.210 | 2 | .015* |
| 8 kGy E-beam | | | |
| 50 ppm ClO₂ Vs 50 ppm ClO₂ + | 64.074 | 2 | .000** |
| 8 kGy E-beam | | | |
| 75 ppm ClO₂ Vs 75 ppm ClO₂ + | 22.716 | 2 | .002** |
| 8 kGy E-beam | | | |

Somatic coliphages- anaerobically digested sludge

| | | | |
|---|---|---|---|
| 25 ppm ClO₂ Vs 25 ppm ClO₂ + | 8.210 | 2 | .015* |
| 8 kGy E-beam | | | |
| 50 ppm ClO₂ Vs 50 ppm ClO₂ + | 64.074 | 2 | .000** |
| 8 kGy E-beam | | | |
| 75 ppm ClO₂ Vs 75 ppm ClO₂ + | 22.716 | 2 | .002** |
| 8 kGy E-beam | | | |

df = degrees of freedom
p-value = statistical measure indicating statistical significance
*significance level 0.05;
**significance level 0.01

With the combination of a 8 kGy E-beam dose, an approximately 7 log reduction of male-specific coliphages was observed in aerobically treated biosolid samples, as shown in Table 11. In contrast to this, male-specific coliphages in anaerobically treated biosolids showed only a 2 log reduction with the combination treatment, as shown in FIG. 26. Nevertheless, the combination of E-beam with chlorine dioxide caused significant reduction in the number of male-specific coliphages in both the aerobic and anaerobic sludge samples.

TABLE 11

| | | | |
|---|---|---|---|
| | Paired | | |
| Treatment comparison | t-test value | df | p-value |

Male specific coliphage- aerobically digested sludge

| | | | |
|---|---|---|---|
| 25 ppm ClO₂ Vs 25 ppm ClO₂ + | — | 2 | 0.00** |
| 8 kGy E-beam | | | |
| 50 ppm ClO₂ Vs 50 ppm ClO₂ + | — | 2 | 0.00** |
| 8 kGy E-beam | | | |
| 75 ppm ClO₂ Vs 75 ppm ClO₂ + | — | 2 | 0.00** |
| 8 kGy E-beam | | | |

Male specific coliphage- anaerobically digested sludge

| | | | |
|---|---|---|---|
| 25 ppm ClO₂ Vs 25 ppm ClO₂ + | 18.448 | 2 | .003** |
| 8 kGy E-beam | | | |
| 50 ppm ClO₂ Vs 50 ppm ClO₂ + | 19.000 | 2 | .003** |
| 8 kGy E-beam | | | |
| 75 ppm ClO₂ Vs 75 ppm ClO₂ + | 27.373 | 2 | .001** |
| 8 kGy E-beam | | | |

df = degrees of freedom
p-value = statistical measure indicating statistical significance
*significance level 0.05;
**significance level 0.01

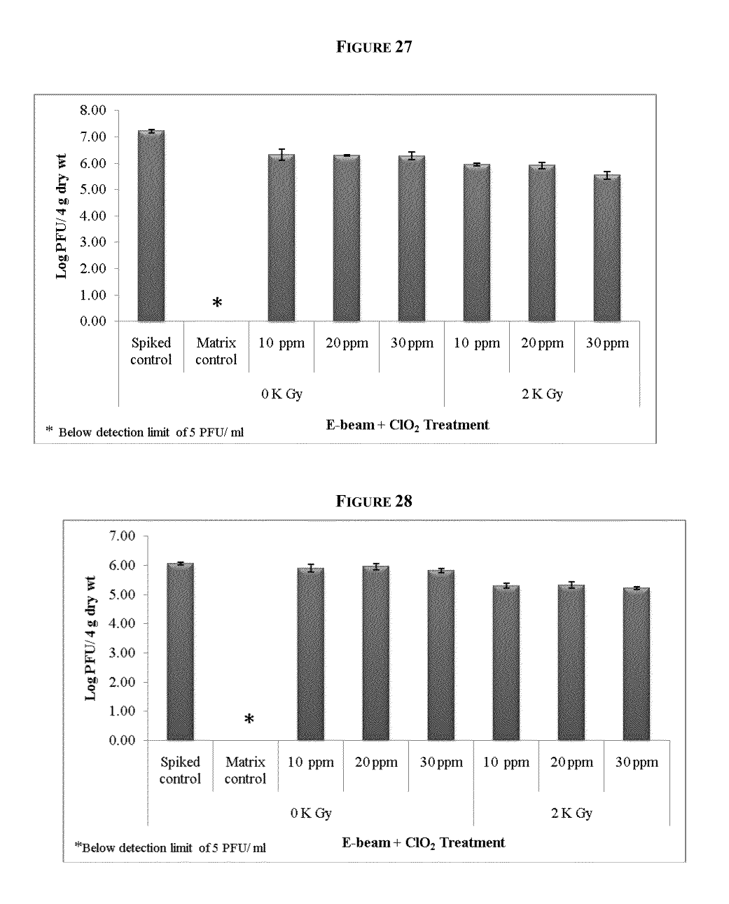

A 30 ppm chlorine dioxide concentration in combination with a 2 kGy E-beam dose resulted in the largest reduction of poliovirus, approximately 2 log, in aerobically treated biosolids, as shown in FIG. 27. There was no significant difference between chlorine dioxide treatments or combination treatments in aerobically treated biosolids (p-values>0.05), as shown in Table 12. Chlorine dioxide by itself or in combination with E-beam was even less successful in anaerobically treated biosolids. Here, the largest reduction of poliovirus was approximately 1 log, as shown in FIG. 28. Again, there was no significant difference between chlorine dioxide treatments or combination treatments in anaerobically treated biosolids, as shown in Table 12. Overall, chlorine dioxide by itself or in combination with a 2 kGy E-beam dose was not very successful at reducing poliovirus neither in aerobically nor anaerobically treated biosolids.

TABLE 12

| | | | |
|---|---|---|---|
| | Paired | | |
| Treatment comparison | t-test value | df | p-value |

Poliovirus- aerobically digested sludge

| | | | |
|---|---|---|---|
| 10 ppm ClO₂ Vs 10 ppm ClO₂ + | 1.462 | 2 | .281 |
| 2 kGy E-beam | | | |
| 20 ppm ClO₂ Vs 20 ppm ClO₂ + | 4.078 | 2 | .055 |
| 2 kGy E-beam | | | |
| 30 ppm ClO₂ Vs 30 ppm ClO₂ + | 4.933 | 2 | .039 |
| 2 kGy E-beam | | | |

Poliovirus- anaerobically digested sludge

| | | | |
|---|---|---|---|
| 10 ppm ClO₂ Vs 10 ppm ClO₂ + | 5.437 | 2 | .032 |
| 2 kGy E-beam | | | |
| 20 ppm ClO₂ Vs 20 ppm ClO₂ + | 3.017 | 2 | .095 |
| 2 kGy E-beam | | | |
| 30 ppm ClO₂ Vs 30 ppm ClO₂ + | 6.480 | 2 | .023 |
| 2 kGy E-beam | | | |

df = degrees of freedom
p-value = statistical measure indicating statistical significance

In the current example, a significant reduction in bacteria, aerobic and anaerobic spores due to ClO₂ alone was not seen, as shown in FIGS. 15-22. The presence of suspended particles in the sludge may have protected the bacteria as well as viral particles from being destroyed by the chlorine dioxide treatment. E-beam irradiation could be solubilizing sludge particles and causing a reduction in the floc size, thereby exposing the microbes to the ClO₂. The enhanced reduction of target microorganisms observed during the combined disinfection of E-beam irradiation and chlorine dioxide could be the result of such a synergistic activity. The amount of suspended particles varied between the two biosolid types in this example. In this example, the aerobic sludge samples had comparatively lesser total solid content (1.3%) as compared to that of the anaerobic sludge samples (3.12%). The inactivation of bacteria, phages, spores as well as enteric viruses showed that E-beam+ClO₂ treatment was more effective for aerobically treated sludge, as shown in Table 13, compared to anaerobically treated sludge samples, as shown in Table 14.

TABLE 13

| | Aerobic Sludge | | | | | | | |
|---|---|---|---|---|---|---|---|---|
| Target | Chlorine Dioxide | | | | | Chlorine Dioxide + E-beam | | |
| Organism- | | | | | | 25 | 50 | 75 |
| Resistant | 25 | | 50 | | 75 | ppm + | ppm + | ppm + |
| group | ppm | | ppm | | ppm | 8 kGy | 8 kGy | 8 kGy |
| Aerobic | 0.5 | log | 0.5 | log | 1 log | 2 log | 2 log | 2 log |
| spores | | | | | | | | |
| Anaerobic | 0.5 | log | 0.5 | log | 1 log | 1 log | 1 log | 1 log |
| spores | | | | | | | | |
| Somatic | 1 | log | 2 | log | 7 log | 2 log | 3 log | 7 log |
| coliphage | | | | | | | | |
| Male- | 3 | log | 7 | log | 7 log | 7 log | 7 log | 7 log |
| specific | | | | | | | | |
| coliphage | | | | | | | | |

TABLE 14

| | Anaerobic Sludge | | | | | | | | | | |
|---|---|---|---|---|---|---|---|---|---|---|---|
| Target | Chlorine Dioxide | | | | | | Chlorine Dioxide + E-beam | | | | |
| Organism- | | | | | | | 25 | | 50 | | 75 |
| Resistant | 25 | | 50 | | 75 | | ppm + | | ppm + | | ppm + |
| group | ppm | | ppm | | ppm | | 8 kGy | | 8 kGy | | 8 kGy |
| Aerobic | 0.5 | log | 0.5 | log | 1 | log | 2 | log | 2 | log | 2 log |
| spores | | | | | | | | | | | |
| Anaerobic | 0 | log | 0.5 | log | 0.5 | log | 0.5 | log | 0.5 | log | 1 log |
| spores | | | | | | | | | | | |
| Somatic | 1 | log | 1 | log | 2 | log | 2 | log | 5 | log | 5 log |
| coliphage | | | | | | | | | | | |
| Male- | 0 | log | 0.5 | log | 1 | log | 1 | log | 2 | log | 2 log |
| specific | | | | | | | | | | | |

coliphage

The incorporation of a 8 kGy E-beam dose to the chlorine dioxide treatment accelerated the inactivation of phages in the sludge samples. Poliovirus was subjected to only low dose of ClO₂ and E-beam, but it was found that there was a considerable degree of protection to the viral capsid as well as genome by the suspended particles. It has previously been shown that chlorine dioxide may take 2.7 times longer to inactivate clumped poliovirus I aggregates compared to that of single state viruses, which clearly supports the results obtained from the current example. Due to the minimal reduction of Poliovirus I in this example, it is believed that the viruses may have been clumped and hence were better protected against disinfection treatment.

The disinfection properties of chlorine dioxide may depend upon the effective penetration of the compound into the floc particles and also upon the innate resistance of various microorganisms to the treatment. Hence supplementing the ClO₂ treatment with E-beam irradiation could be an option to enhance microbial inactivation in biosolids. Incorporation of E-beam irradiation also prevents the requirement of adding excess chlorine dioxide that may in turn result in the formation of toxic by-products.

### Example 3

### Synergistic Disinfection of Municipal Biosolids When E-Beam is Combined with Ferrate

The objective of this example was to understand whether E-beam in combination with a chemical oxidant such as ferrate would lead to enhanced disinfection of municipal biosolids.

Sludge samples were collected from the aerobic treatment plant and the anaerobic treatment plant in College Station, Tex. The samples were collected in sterile polypropylene bottles (Nalgene, Rochester, N.Y.) and transported to the laboratory in a cooler and were maintained at 4° C. until analysis. The dry weights of the samples were recorded to determine the percentage of total solids and dry weight equivalent of the sludge.

The samples were spiked with high titers of laboratory grown strains of different organisms, which included bacteria—Salmonella Typhimurium (accession #87-26254, obtained from the National Veterinary Service Laboratory, Ames, Iowa), Escherichia coli (ATCC #25922), coliphages phi X 174 (ATCC #13706-B1) (somatic) and MS-2 (ATCC #15597-B1) (Male-specific), enteric virus—Poliovirus-1 (VR-1562), aerobic spore former—Bacillus subtilis (ATCC #6633) and anaerobic spore former—Clostridium perfringens (ATCC #13124).

The spiked samples were mixed evenly and subjected to different concentrations of ferrate. The Ferrator™ equipment was obtained from Ferrate Treatment Technologies, LLC. Both College Station and TAMU sludge samples were treated with 50 ppm, 100 ppm and 200 ppm of ferrate. After the addition of ferrate, the samples were mixed gently to allow for sufficient contact with the sludge matrix. Spiked controls were maintained without ferrate treatment to enumerate the amount of spiked microorganisms present in each of the samples.

The ferrate treated samples were subjected to an E-beam dose of 8 kGy at the National Center for Electron Beam Research, Texas A&M University using a 10 MeV LINAC source. The irradiation experiments were performed on purpose at 8 kGy so that the reduction of target organisms would be observable. If the experiments would have been performed at 15 kGy, all microbial counts would have been zero and hence would not have been amenable for data analysis. The absorbed dose was measured using L-α-alanine dosimeter tablets and an electron spin paramagnetic resonance spectrometer (Bruker BioSpin Corp., Billerica, Mass.). Irradiated samples were stored at 4° C. until they were subjected to microbiological analysis. Another set of ferrate treated samples was maintained without E-beam irradiation to study the effect of the oxidant alone in terms of microbial inactivation. Those samples were packaged similarly as for E-beam irradiation but were not subjected to irradiation and were labeled as 0 kGy. FIG. 29 provides a schematic representation of the ferrate and E-beam+ferrate treatments given to aerobically and anaerobically treated sludge samples. From preliminary studies conducted using PBS, it was found that the spiked organisms were inactivated by applying very low doses of ferrate such as 2 ppm or 4 ppm in combination with the E-beam (6 kGy, 8 kGy and 12 kGy). Such low doses of ferrate may not have been sufficient to bring about effective microbial reduction in the case of biosolid samples containing much higher levels of suspended particles. Hence, it was decided to treat the biosolid samples with comparatively higher ferrate concentrations ranging from 50 ppm to 200 ppm and with an 8 kGy E-beam dose.

Microbiological analyses were performed as described Example 2.

The values obtained from the resulting inactivation data were converted to log₁₀ and plotted against the respective ferrate concentration and E-beam+ferrate concentration. The disinfection efficiencies of ferrate and the combination treatment of ferrate plus E-beam were determined by analyzing the log₁₀ reduction in the microbial population subjected to different treatments as compared to that of the spiked control, which did not receive any disinfection treatment. In order to compare the pathogen reduction between the different treatments, and within treatments, paired-t-tests were carried out using the statistical software package SPSS(SPSS Inc., Chicago, Ill.).

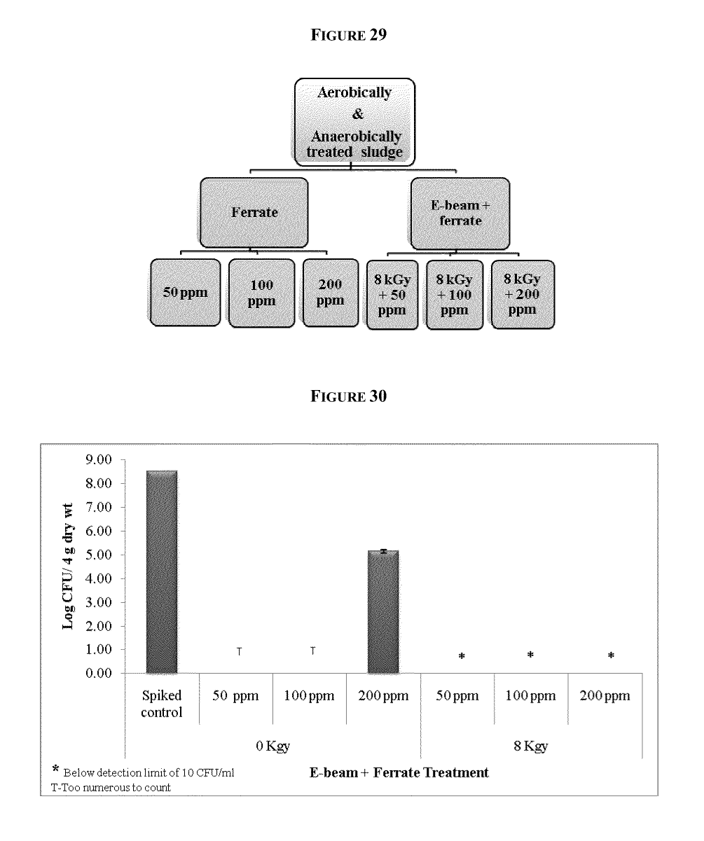

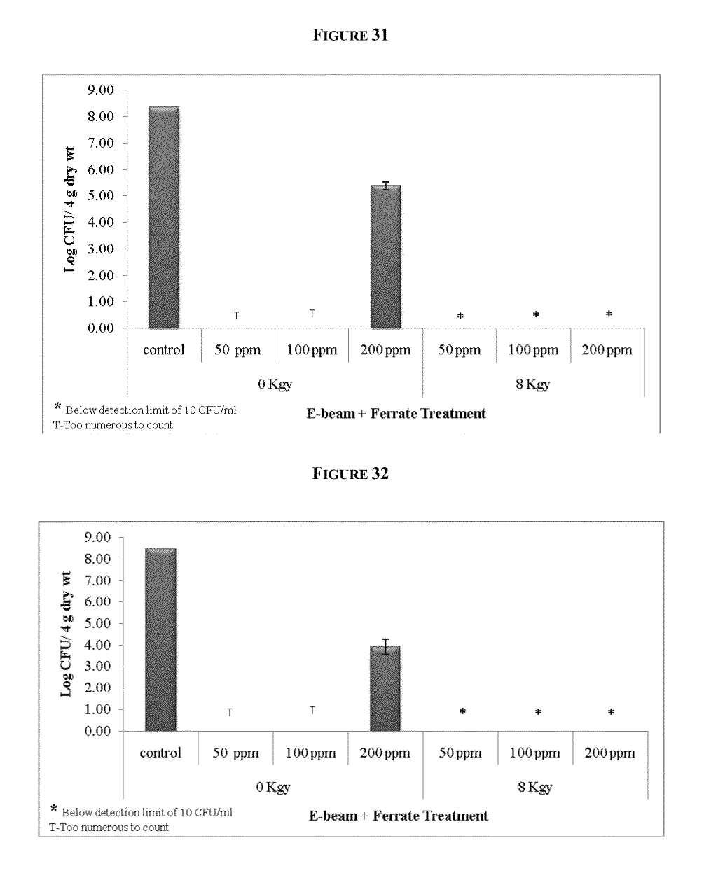

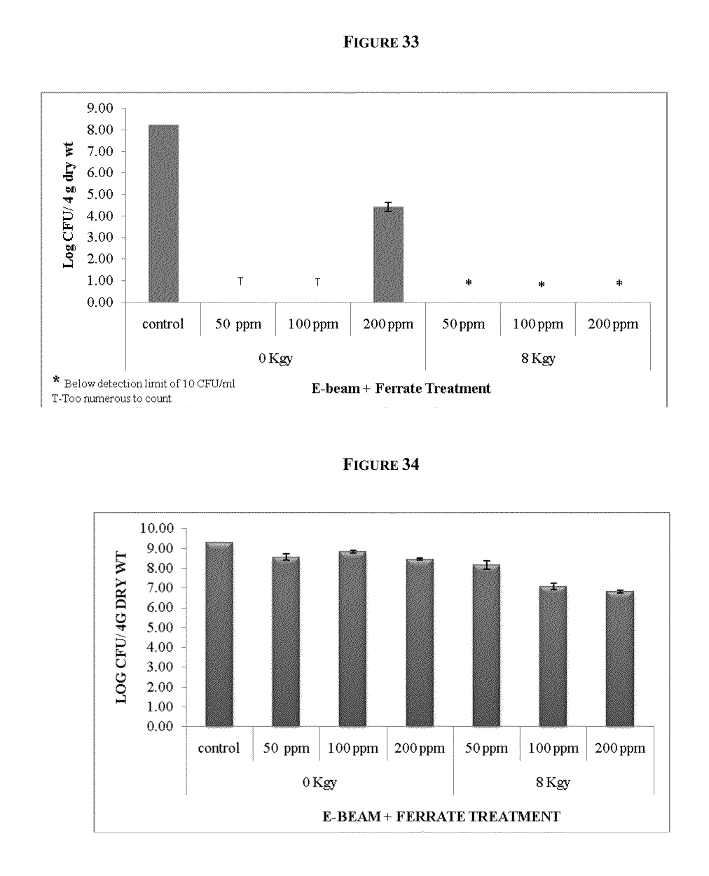

The effect of ferrate on Salmonella and E. coli in aerobically and anaerobically treated sludge is represented in FIGS. 30 through 33. The inactivation of the bacterial populations showed almost a similar trend following ferrate and E-beam+ferrate treatment. There is a gradual reduction in the bacterial population with respect to an increase in ferrate concentration, but a significant difference was observed with the introduction of the E-beam component which resulted in a complete reduction of the bacterial population. At 50 ppm and 100 ppm, the colonies obtained were “too numerous to count” which made it difficult to arrive at an actual number for the surviving microbial population. Based on the dilutions that were made, the reduction was approximated to be around three logs in the case of S. Typhimurium in both aerobically and anaerobically treated sludge. E. coli on the other hand, was found to be more susceptible to ferrate with approximately a four log reduction in the sludge samples. Bacterial colonies were totally absent or were below the detection limit of 10 CFU/ml when ferrate was combined with E-beam. This clearly indicates that the synergistic effect of the combination treatment brought about an eight log reduction of the Salmonella and E. coli populations in sludge.

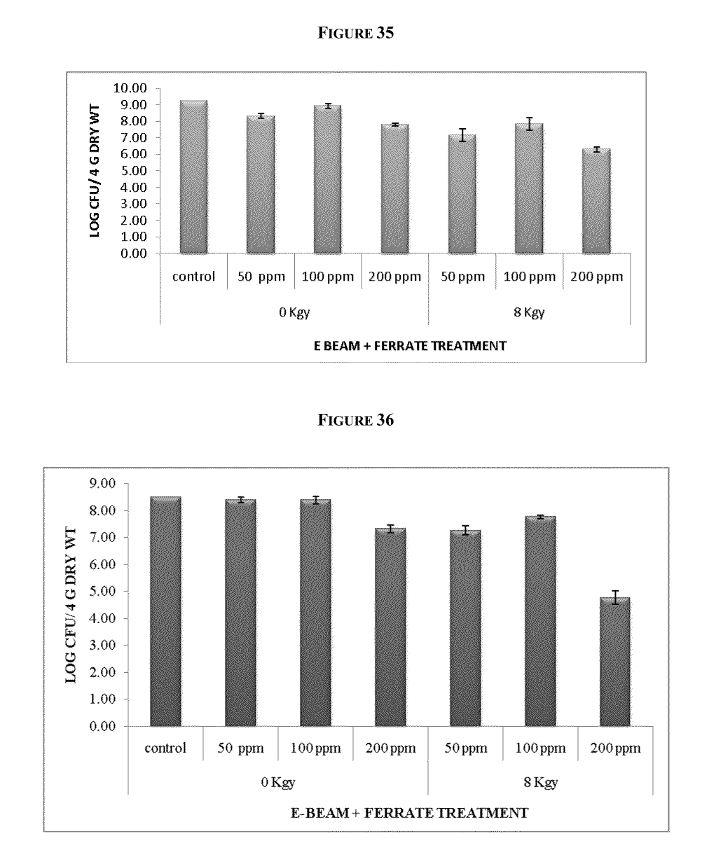

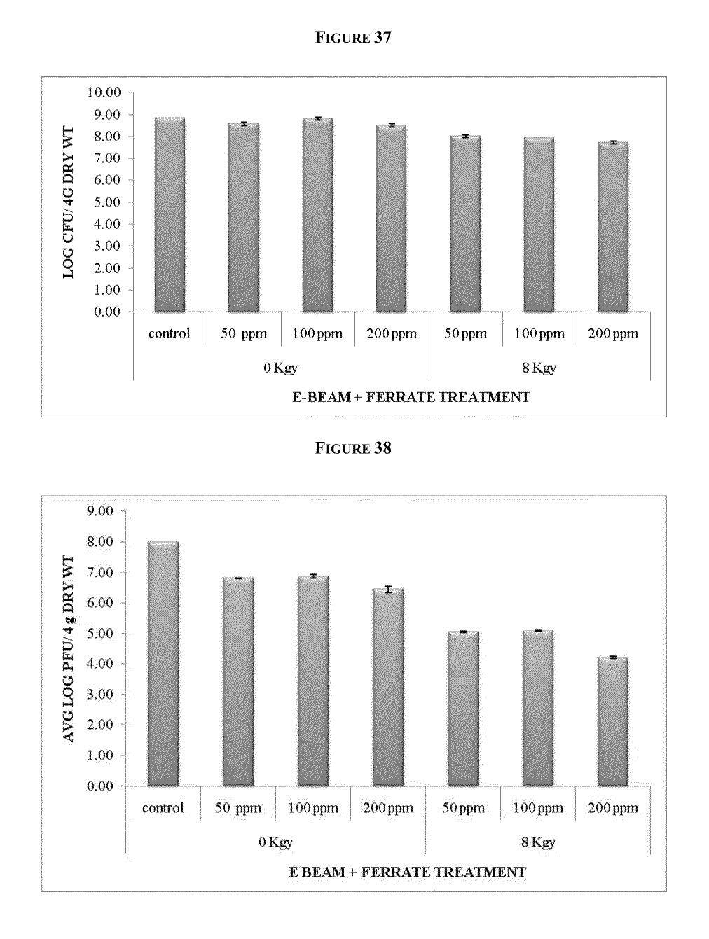

Aerobic and anaerobic spores were comparatively more resistant to ferrate and E-beam treatment compared to the non-spore forming bacterial populations, as shown in FIGS. 34-37. When the concentration of ferrate was increased from 100 ppm to 200 ppm, a significant reduction was observed in case of aerobic spores in aerobically and anaerobically digested sludge with a p-value of 0.018 and 0.034 respectively. The spore population did show a 1-2 log reduction upon the increase in ferrate concentrations from 0 to 200 ppm. A 1-2 log reduction was observed when treated with 8 kGy E-beam in case of the aerobically treated sludge. The anaerobically treated sludge showed almost a similar pattern, but a three log reduction was observed with the combination treatment of ferrate and E-beam. The combination of E-beam and ferrate treatment was compared statistically with the ferrate treatment alone using paired t-tests and the results suggested statistically significant reduction as illustrated in Table 15. In both aerobically and anaerobically digested sludge samples, significant differences were observed upon combining the ferrate with the E-beam (p<0.05 and p<0.01).

TABLE 15

| | | |
|---|---|---|
| Treatment comparison | Df | p-value |

Aerobic spores- aerobically digested sludge

| | | | |
|---|---|---|---|
| 50 ppm ferrate Vs 50 ppm | 1.107 | 2 | 0.384 |
| ferrate + 8 kGy E-beam | | | |
| 100 ppm ferrate Vs 100 ppm | 7.885 | 2 | 0.016* |
| ferrate + 8 kGy E-beam | | | |
| 200 ppm ferrate Vs 200 ppm | 17.846 | 2 | 0.003** |
| ferrate + 8 kGy E-beam | | | |

Aerobic spores- anaerobically digested sludge

| | | | |
|---|---|---|---|
| 50 ppm ferrate Vs 50 ppm | 2.273 | 2 | 0.151 |
| ferrate + 8 kGy E-beam | | | |
| 100 ppm ferrate Vs 100 ppm | 4.637 | 2 | 0.043* |
| ferrate + 8 kGy E-beam | | | |
| 200 ppm ferrate Vs 200 ppm | 6.569 | 2 | 0.022* |
| ferrate + 8 kGy E-beam | | | |

Anaerobic spores- aerobically digested sludge

| | | | |
|---|---|---|---|
| 50 ppm ferrate Vs 50 ppm | 22.215 | 2 | 0.002** |
| ferrate + 8 kGy E-beam | | | |
| 100 ppm ferrate Vs 100 ppm | 3.639 | 2 | 0.068 |
| ferrate + 8 kGy E-beam | | | |
| 200 ppm ferrate Vs 200 ppm | 11.261 | 2 | 0.008** |
| ferrate + 8 kGy E-beam | | | |

Anaerobic spores- anaerobically digested sludge

| | | | |
|---|---|---|---|
| 50 ppm ferrate Vs 50 ppm | 4.516 | 2 | 0.046* |
| ferrate + 8 kGy E-beam | | | |
| 100 ppm ferrate Vs 100 ppm | 14.401 | 2 | 0.005** |
| ferrate + 8 kGy E-beam | | | |
| 200 ppm ferrate Vs 200 ppm | 6.862 | 2 | 0.021* |
| ferrate + 8 kGy E-beam | | | |

df = degrees of freedom
p-value = statistical measure indicating statistical significance
*significance level 0.05;
**significance level 0.01

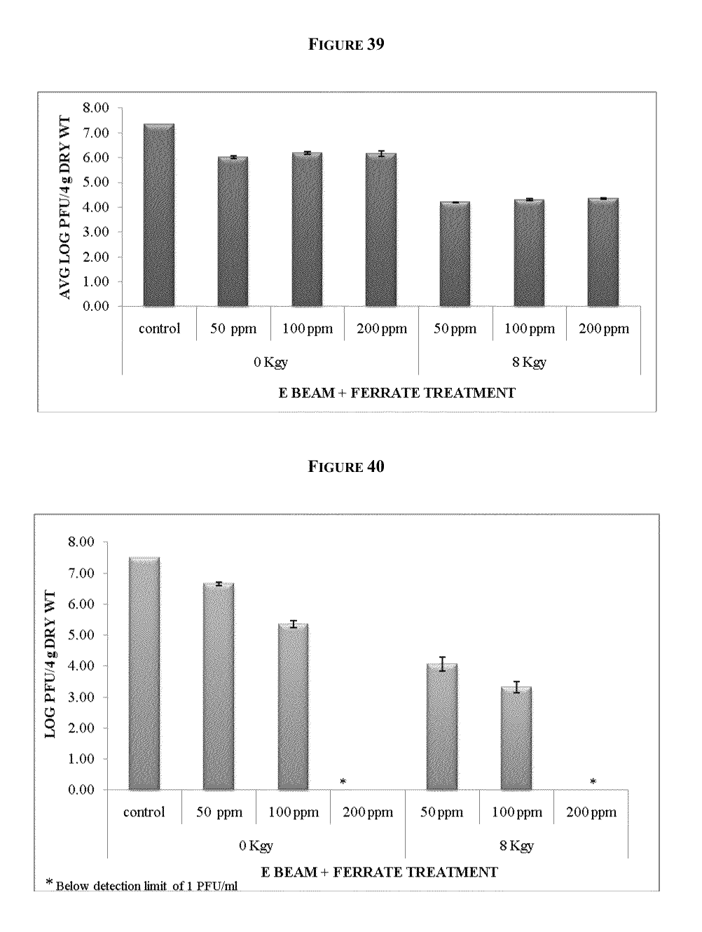

Inactivation of somatic phages in both aerobically and anaerobically treated sludge is represented in FIGS. 38 and 39. Aerobically digested sludge samples were more favorable to φ X 174 inactivation using ferrate and E-beam. About a two log reduction was observed with 200 ppm of ferrate (p=0.029) and a progressive reduction of four log with 200 ppm of ferrate and an 8 kGy E-beam dose. A three log reduction of the somatic phage population was observed with the combination treatment in anaerobically treated samples. Table 16 statistically compares the significant differences attained by the ferrate and E-beam+ferrate combination treatments on somatic coliphage inactivation.

TABLE 16

| | | | |
|---|---|---|---|
| | Paired | | |
| Treatment comparison | t-test value | df | p-value |

Somatic coliphages- aerobically digested sludge

| | | | |
|---|---|---|---|
| 50 ppm ferrate Vs 50 ppm | 54.751 | 2 | .000** |
| ferrate + 8 kGy E-beam | | | |
| 100 ppm ferrate Vs 100 ppm | 42.777 | 2 | .001** |
| ferrate + 8 kGy E-beam | | | |
| 200 ppm ferrate Vs 200 ppm | 32.424 | 2 | .001** |
| ferrate + 8 kGy E-beam | | | |

Somatic coliphages- anaerobically digested sludge

| | | | |
|---|---|---|---|
| 50 ppm ferrate Vs 50 ppm | 30.137 | 2 | .001** |
| ferrate + 8 kGy E-beam | | | |
| 100 ppm ferrate Vs 100 ppm | 18.113 | 2 | .003** |
| ferrate + 8 kGy E-beam | | | |
| 200 ppm ferrate Vs 200 ppm | 13.379 | 2 | .006** |
| ferrate + 8 kGy E-beam | | | |

Male specific coliphages- aerobically digested sludge

| | | | |
|---|---|---|---|
| 50 ppm ferrate Vs 50 ppm | 9.197 | 2 | .012* |
| ferrate + 8 kGy E-beam | | | |
| 100 ppm ferrate Vs 100 ppm | 10.698 | 2 | .009** |
| ferrate + 8 kGy E-beam | | | |
| 200 ppm ferrate Vs 200 ppm | — | 2 | .000** |
| ferrate + 8 kGy E-beam | | | |

Male specific coliphages- anaerobically digested sludge

| | | | |
|---|---|---|---|
| 50 ppm ferrate Vs 50 ppm | 3.569 | 2 | .070 |
| ferrate + 8 kGy E-beam | | | |
| 100 ppm ferrate Vs 100 ppm | 3.871 | 2 | .061 |
| ferrate + 8 kGy E-beam | | | |
| 200 ppm ferrate Vs 200 ppm | 3.019 | 2 | .094 |
| ferrate + 8 kGy E-beam | | | |

df = degrees of freedom
p-value = statistical measure indicating statistical significance
*significance level 0.05;
**significance level 0.01

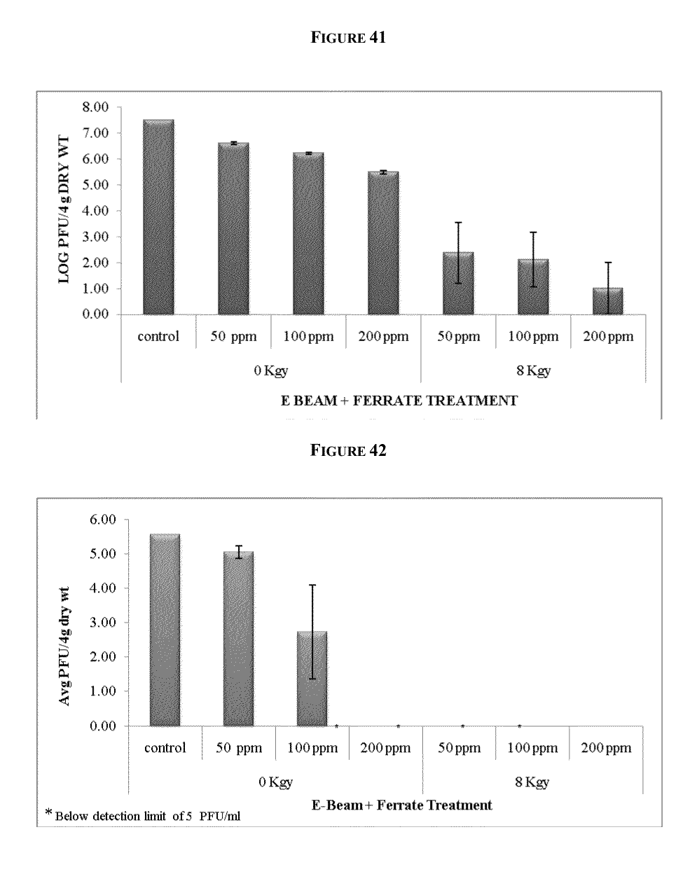

The results of male-specific coliphages exposed to ferrate and E-beam are illustrated in FIGS. 40 and 41. Complete inactivation of male-specific coliphages was observed with 200 ppm of ferrate in the aerobically treated sludge samples (p=0.00). The combination of E-beam with 50 ppm of ferrate resulted in a three log reduction whereas 100 ppm and 200 ppm resulted in approximately a four and seven log reduction of the male-specific coliphage population indicating that male-specific coliphages are susceptible to ferrate, as shown in Table 16. Anaerobically treated sludge samples also showed about a six log reduction with ferrate and E-beam treatment.

When the paired t test comparison analysis was performed to assess the significant difference between the ferrate and combination treatment, the anaerobically treated sludge did not show a statistically significant difference for male-specific coliphage inactivation. On the other hand, aerobically treated sludge showed a significant difference between the ferrate and combination treatment, as shown in Table 16.

Ferrate may be highly effective against enteric viruses, as shown by FIGS. 42 and 43. Poliovirus Type 1 when spiked in aerobically treated sludge samples and treated with 100 ppm of ferrate showed slightly over a three log reduction, as shown in FIG. 42. This virus was particularly sensitive in anaerobically digested samples where it exhibited approximately a six log reduction with 100 ppm of ferrate, as shown in FIG. 43. Both aerobically and anaerobically digested samples favored the complete elimination of Poliovirus Type 1 with the combination of ferrate and E-beam.

The current example showed that approximately a 200 ppm ferrate concentration may be required to achieve a slight reduction of spore formers in the biosolid matrices. However, with the combination of ferrate and E-beam the reduction was approximately two to three log. The spore population was only reduced by the combination of these two stressors. In general, it appeared that aerobic and anaerobic spore formers were more resistant to inactivation by ferrate compared to bacteria and enteric viruses. Under such circumstances, the combination of ferrate and E-beam may be a beneficial option for sludge disinfection. The significant reduction in the phage population that was observed may be due to the synergistic effect of ferrate and E-beam. There was a difference in the response of male-specific coliphages, depending upon the sludge matrix, suggesting that the sludge matrix does play a significant role in microbial inactivation during ferrate disinfection. Compared to the somatic coliphages, male-specific coliphage had a low D-10 value, as shown in Example 1. It is believed that the innate susceptibility of male-specific coliphages to irradiation from radical attack is also responsible for the reduced D-10 value. The difference in the resistance to ferrate that was observed in these studies could be due to this difference in their innate susceptibility to ionizing radiation and radical attack. The D-10 value of Poliovirus was on par with that of the male-specific coliphages, as shown in Example 1, which could possibly explain the similar response of both organisms to the ferrate and E-beam combination treatment.

All organisms targeted in this example showed a significant reduction with a combination of ferrate and E-beam compared to that of ferrate alone. Tables 17 and 18 highlight the synergistic disinfection that is achieved when E-beam is coupled with ferrate as the chemical oxidant.

TABLE 17

| | Aerobic sludge | | | | | | | | |
|---|---|---|---|---|---|---|---|---|---|
| | Ferrate | | | | | Ferrate + E-Beam | | | |
| | | | | | | 50 | 100 | | 200 |
| Target | 50 | | 100 | | 200 | ppm + | ppm + | | ppm + |
| Organism | ppm | | ppm | | ppm | 8 kGy | 8 kGy | | 8 kGy |
| Salmonella | NA | | NA | | 3 log | 8 log | 8 | log | 8 log |
| E. coli | NA | | NA | | 4 log | 8 log | 8 | log | 8 log |
| Aerobic | 0.5 | log | 0.5 | log | 1 log | 1 log | 2 | log | 2 log |
| spores | | | | | | | | | |
| Anaerobic | 0 | log | 0 | log | 1 log | 1 log | 0.5 | log | 3 log |
| spores | | | | | | | | | |
| Somatic | 1 | log | 1 | log | 2 log | 3 log | 3 | log | 4 log |
| coliphages | | | | | | | | | |
| Male- | 1 | log | 2 | log | 7 log | 3 log | 4 | log | 7 log |
| specific | | | | | | | | | |
| coliphage | | | | | | | | | |
| Poliovirus | 0.5 | log | 3 | log | 6 log | 6 log | 6 | log | 6 log |

TABLE 18

| | Anaerobic Sludge | | | | | | | |
|---|---|---|---|---|---|---|---|---|
| | Ferrate | | | | | Ferrate + E-Beam | | |
| | | | | | | 50 | 100 | 200 |
| Target | 50 | | 100 | 200 | | ppm + | ppm + | ppm + |
| Organism | ppm | | ppm | ppm | | 8 kGy | 8 kGy | 8 kGy |
| Salmonella | NA | | NA | 3 | log | 8 log | 8 log | 8 log |
| E. coli | NA | | NA | 4 | log | 8 log | 8 log | 8 log |
| Aerobic | 0.5 | log | 0 log | 1 | log | 2 log | 1 log | 3 log |
| spores | | | | | | | | |
| Anaerobic | 0 | log | 0 log | 0.5 | log | 1 log | 1 log | 1 log |
| spores | | | | | | | | |
| Somatic | 1 | log | 1 log | 1 | log | 3 log | 3 log | 3 log |
| coliphages | | | | | | | | |
| Male- | 1 | log | 1 log | 2 | log | 5 log | 5 log | 6 log |
| specific | | | | | | | | |
| coliphages | | | | | | | | |
| Poliovirus | 1 | log | 6 log | 6 | log | 6 log | 6 log | 6 log |

It is believed that irradiation may cause sludge disintegration and cell rupture which hastens the disinfection process by ferrate. Ferrate complements the E-beam treatment by the production of highly reactive species of iron such as +6 and +5. The +5 oxidation state of iron may enable better inactivation of biological species as well as toxins and other pollutants which cannot be achieved by +6 oxidation state alone. Pretreatment with ferrate may also have the advantage of removing humic acids and may help in coagulation of the sludge which may help in better conditioning of biosolids. When combined with E-beam, ferrate appears to provide better sludge disintegration, reduced floc size, and increased microbial cell break down, oxidation of organic matter that enhances microbial inactivation and possible stability of the treated sludge material.

### Example 4

### Evaluating the Potential for Re-Growth of Fecal Coliforms and Salmonella after E-Beam Disinfection Alone and in Combination with Chemical Oxidation of Biosolids

The objective of this example was to evaluate whether the E-beam treated and E-beam plus chemical oxidant treated biosolids will exhibit any re-growth of fecal coliforms and Salmonella spp., during extended incubation at microbial growth promoting conditions.

Biosolid samples were collected from the aerobic digester and the anaerobic digester. Four hundred milliliters of each biosolid sample were spiked with 1 ml of 10⁶ E. coli and Salmonella Typhimurium strains. For the E-Beam treatment, 20 ml of aliquots were placed in Whirl-Pack bags, heat sealed and placed in a double layer of ziploc bags. Three triplicate bags were used for each sampling time-point. The bags containing the samples were irradiated at a dose of 2.7 kGy. This dose was determined based on previous experiments which showed that the D-10 value of S. Typhimurium in the aerobic and anaerobic digesters ranged between 0.18 kGy and 0.35 kGy.

The irradiated and non-irradiated samples were incubated at room temperature for a maximum of 12 weeks (3 months). The samples were analyzed every other week to observe any potential E. coli or Salmonella re-growth. The samples were analyzed using the U.S. EPA method 1680 for fecal coliforms and the U.S. EPA method 1682 for Salmonella sp. Both of these methods have an overnight enrichment step to increase the chances of recovering any viable organisms. The E. coli method that was used in the D-10 value estimations was based on direct plating and did not have an enrichment step.

The results from the re-growth experiments with spiked Salmonella in aerobically and anaerobically digested biosolids and treated with either the E-beam alone or in combination with the chlorine dioxide are shown in Tables 19-26.

TABLE 19

| | | Volume of | | | | | | | MPN/4 g | |
|---|---|---|---|---|---|---|---|---|---|---|
| | | homogenized | | | | | | | (dry | |
| | | sample used to | | | MPN/ | | | % total | weight) | |
| | | inoculate TSB | | | ml | | | solid | based on | MPN/4 g |
| | Sampling | 20.0 | 10.0 | 1.0 | (wet | 95% Con. Limits | | (dry | 2 ml, 1 ml, | (dry |
| Sample # | date | ml | ml | ml | weight) | Lower | Upper | weight) | 0.1 ml | weight) |
| Non- | Apr. 22, 2009 | (5/5) | (5/5) | (3/5) | 0.9178 | 0.267 | 2.201 | 0.163 | 2.3E+01 | 2.3E+02 |
| irradiated | May 4, 2009 | (5/5) | (5/5) | (1/5) | 0.3477 | 0.117 | 1.016 | 0.163 | 8.5E+00 | 8.5E+01 |
| | May 19, 2009 | (5/5) | (1/5) | (0/5) | 0.0678 | 0.023 | 0.134 | 0.163 | 1.7E+00 | 1.7E+01 |
| | Jun. 4, 2009 | (4/5) | (1/5) | (0/5) | 0.0484 | 0.014 | 0.098 | 0.163 | 1.2E+00 | 1.2E+01 |
| | Jun. 10, 2009 | (2/5) | (5/0) | (0/5) | 0.0155 | 0.001 | 0.040 | 0.163 | 3.8E-01 | 3.8E+00 |
| Irradiated | Apr. 22, 2009 | (4/5) | (2/5) | (0/5) | 0.0626 | 0.021 | 0.124 | 0.163 | 1.5E+00 | 1.5E+01 |
| | May 4, 2009 | (4/5) | (0/5) | (0/5) | 0.0381 | 0.009 | 0.081 | 0.163 | 9.3E−01 | 9.3E+00 |
| | May 19, 2009 | (3/5) | (0/5) | (0/5) | 0.0255 | 0.003 | 0.059 | 0.163 | 6.3E−01 | 6.3E+00 |
| | Jun. 4, 2009 | (3/5) | (0/5) | (0/5) | 0.0255 | 0.003 | 0.059 | 0.163 | 6.3E−01 | 6.3E+00 |
| | Jun. 10, 2009 | (0/5) | (0/5) | (0/5) | <0.0065 | n/a | n/a | 0.163 | <0.00647 | <0.0065 |

TABLE 20

| | | Volume of | | | | | | | MPN/4 g | |
|---|---|---|---|---|---|---|---|---|---|---|
| | | homogenized | | | | | | | (dry | |
| | | sample used to | | | MPN/ | | | % total | weight) | |
| | | inoculate TSB | | | ml | | | solid | based on | MPN/4 g |
| | Sampling | 20.0 | 10.0 | 1.0 | (wet | 95% Con. Limits | | (dry | 2 ml, 1 ml, | (dry |
| Sample # | date | ml | ml | ml | weight) | Lower | Upper | weight) | 0.1 ml | weight) |
| Non- | Apr. 22, 2009 | (5/5) | (5/5) | (4/5) | 1.6096 | 0.384 | 4.103 | 0.297 | 2.2E+01 | 2.2E+02 |
| irradiated | May 4, 2009 | (5/5) | (5/5) | (3/5) | 0.9178 | 0.267 | 2.201 | 0.297 | 1.2E+01 | 1.2E+02 |
| | May 19, 2009 | (5/5) | (3/5) | (1/5) | 0.1368 | 0.058 | 0.305 | 0.297 | 1.8E+00 | 1.8E+01 |
| | Jun. 4, 2009 | (5/5) | (3/5) | (0/5) | 0.1151 | 0.047 | 0.239 | 0.297 | 1.6E+00 | 1.6E+01 |
| | Jun. 10, 2009 | (3/5) | (1/5) | (0/5) | 0.0344 | 0.007 | 0.073 | 0.297 | 4.6E−01 | 4.6E+00 |
| Irradiated | Apr. 22, 2009 | (4/5) | (1/5) | (0/5) | 0.0484 | 0.014 | 0.098 | 0.297 | 6.5E−01 | 6.5E+00 |
| | May 4, 2009 | (4/5) | (3/5) | (0/5) | 0.0797 | 0.030 | 0.158 | 0.297 | 1.1E+00 | 1.1E+01 |
| | May 19, 2009 | (4/5) | (0/5) | (0/5) | 0.0381 | 0.008 | 0.081 | 0.297 | 5.1E−01 | 5.1E+00 |
| | Jun. 4, 2009 | (2/5) | (0/5) | (0/5) | 0.0155 | 0.001 | 0.040 | 0.297 | 2.1E−01 | 2.1E+00 |
| | Jun. 10, 2009 | (0/5) | (0/5) | (0/5) | <0.0065 | n/a | n/a | 0.297 | <0.0065 | <0.0065 |

Control Strains Used:
Positive Control for TSB, MSRV, and XLD: Salmonella Typhimurium
Negative Control for TSB, MSRV, and XLD: Pseudomonas (ATCC #10145)

TABLE 21

| Sam- | Sampling | MPN/g | 95% Con. Interval | | MPN/4 g |
|---|---|---|---|---|---|
| ple # | date | dry wt | Lower | Upper | dry wt |
| Non- | Apr. 22, 2009 | 1.0E+04 | 1.7E−03 | 2.8E+04 | 4.1E+04 |
| Irra- | May 4, 2009 | 4.9E+03 | 1.9E−02 | 1.2E+04 | 1.9E+04 |
| diated | May 19, 2009 | 1.0E+03 | 1.7E−02 | 2.7E+03 | 4.1E+03 |
| Aero- | Jun. 4, 2009 | 1.3E+02 | 1.9E−01 | 4.1E+02 | 5.3E+02 |
| bic | Jun. 10, 2009 | 4.8E+01 | 7.8E−02 | 1.2E+02 | 1.9E+02 |
| Sludge | | | | | |
| E-Beam | Apr. 22, 2009 | 1.0E+03 | 1.7E−02 | 2.8E+03 | 4.1E+03 |
| Treated | May 4, 2009 | 3.0E+02 | 2.1E−01 | 7.8E+02 | 1.2E+03 |
| Aero- | May 19, 2009 | 8.0E+01 | 1.5E−01 | 1.9E+02 | 3.2E+02 |
| bic | Jun. 4, 2009 | 1.2E+01 | 9.2E−02 | 4.2E+01 | 4.9E+01 |
| Sludge | Jun. 10, 2009 | n/a | n/a | n/a | n/a |

TABLE 22

| Sam- | Sampling | MPN/g | 95% Con. Interval | | MPN/4 g |
|---|---|---|---|---|---|
| ple # | date | dry wt | Lower | Upper | dry wt |
| Non- | Apr. 22, 2009 | 2.7E+04 | 8.3E+03 | 6.4E+04 | 1.1E+05 |
| irra- | May 4, 2009 | 2.7E+03 | 8.3E+02 | 6.4E+03 | 1.1E+04 |
| diated | May 19, 2009 | 1.7E+03 | 1.1E−02 | 4.3E+03 | 6.6E+03 |
| Anaero- | Jun. 4, 2009 | 9.1E+01 | 1.1E−01 | 2.7E+02 | 3.6E+02 |
| bic | Jun. 10, 2009 | 3.6E+01 | 6.9E−02 | 8.4E+01 | 1.4E+02 |
| Sludge | | | | | |
| E-Beam | Apr. 22, 2009 | 7.3E+02 | 1.0E−02 | 2.2E+03 | 2.9E+03 |
| Treated | May 4, 2009 | 2.7E+02 | 1.1E−01 | 6.4E+02 | 1.1E+03 |
| Anaero- | May 19, 2009 | 1.1E+02 | 1.1E−01 | 3.2E+02 | 4.4E+02 |
| bic | Jun. 4, 2009 | 1.5E+01 | 2.2E−02 | 4.0E+01 | 6.1E+01 |
| Sludge | Jun. 10, 2009 | n/a | n/a | n/a | n/a |

TABLE 23

| | | | | | | | | | MPN/4 g | |
|---|---|---|---|---|---|---|---|---|---|---|
| | | Volume of | | | | | | | (dry | |
| | | homogenized sample | | | MPN/ | | | % total | weight) | |
| | | used to inoculate TSB | | | ml | 95% Con. | | solid | based on | MPN/4 g |
| | Sampling | 20.0 | 10.0 | 1.0 | (wet | Limits | | (dry | 2 ml, 1 ml, | (dry |
| Sample # | date | ml | ml | ml | weight) | Lower | Upper | weight) | 0.1 ml | weight) |
| ClO₂ | Sep. 11, 2009 | Plate count | | | | | | | | 2.98E+08 |
| | Sep. 18, 2009 | (5/5) | (5/5) | (4/5) | 1.6090 | 0.3837 | 4.1030 | 0.0131 | 4.9E+02 | 4.91E+03 |
| | Sep. 25, 2009 | (5/5) | (3/5) | (0/5) | 0.1151 | 0.0474 | 0.2394 | 0.0131 | 3.5E+01 | 3.51E+02 |
| | Oct. 5, 2009 | (3/5) | (0/5) | (0/5) | 0.0255 | 0.0028 | 0.0585 | 0.0131 | 7.8E+00 | 7.79E+01 |
| ClO₂ + | Sep. 11, 2009 | Plate count | | | | | | | | 4.43E+05 |
| Irradiated | Sep. 18, 2009 | (4/5) | (2/5) | (0/5) | 0.0626 | 0.0207 | 0.1244 | 0.0131 | 1.9E+01 | 1.91E+02 |
| | Sep. 25, 2009 | (2/5) | (1/5) | (0/5) | 0.0234 | 0.0022 | 0.0540 | 0.0131 | 7.1E+00 | 7.15E+01 |
| | Oct. 5, 2009 | (1/5) | (0/5) | (0/5) | 0.0072 | 0.0012 | 0.0241 | 0.0131 | 2.2E+00 | 2.20E+01 |

TABLE 24

MPN/4 g

| | | Volume of | | | | | | | (dry | |
|---|---|---|---|---|---|---|---|---|---|---|
| | | homogenized sample | | | MPN/ | | | % total | weight) | |
| | | used to inoculate TSB | | | ml | 95% Con. | | solid | based on | MPN/4 g |
| | Sampling | 20.0 | 10.0 | 1.0 | (wet | Limits | | (dry | 2 ml, 1 ml, | (dry |
| Sample # | date | ml | ml | ml | weight) | Lower | Upper | weight) | 0.1 ml | weight) |
| ClO₂ | Sep. 11, 2009 | Plate count | | | | | | 0.0312 | | 3.03E+06 |
| | Sep. 18, 2009 | (5/5) | (5/5) | (4/5) | 1.6090 | 0.3837 | 4.1030 | 0.0312 | 2.1E+02 | 2.06E+03 |
| | Sep. 25, 2009 | (5/5) | (4/5) | (4/5) | 0.3475 | 0.1417 | 1.0160 | 0.0312 | 4.5E+01 | 4.46E+02 |
| | Oct. 5, 2009 | (4/5) | (2/5) | (0/5) | 0.0626 | 0.0207 | 0.1244 | 0.0312 | 8.0E+00 | 8.03E+01 |
| ClO₂ + | Sep. 11, 2009 | Plate count | | | | | | | | 3.85E+03 |
| Irradiated | Sep. 18, 2009 | (5/5) | (5/5) | (2/5) | 0.5422 | 0.1791 | 1.4190 | 0.0312 | 7.0E+01 | 6.95E+02 |
| | Sep. 25, 2009 | (4/5) | (2/5) | (0/5) | 0.0626 | 0.0207 | 0.1244 | 0.0312 | 8.0E+00 | 8.03E+01 |
| | Oct. 5, 2009 | (3/5) | (1/5) | (0/5) | 0.0344 | 0.0069 | 0.0734 | 0.0312 | 4.4E+00 | 4.41E+01 |

TABLE 25

| Sam- | Sampling | MPN/g | 95% Con. Interval | | MPN/4 g |
|---|---|---|---|---|---|
| ple # | date | dry wt | Lower | Upper | dry wt |
| ClO₂ | Sep. 11, | Plate count | | | 4.27E+07 |
| | 2009 | | | | |
| | Sep. 18, | 2.12E+05 | 2.42E−01 | 6.56E+05 | 8.49E+05 |
| | 2009 | | | | |
| | Sep. 25, | 1.62E+03 | 2.38E+00 | 4.93E+03 | 6.47E+03 |
| | 2009 | | | | |
| | Oct. 5, 2009 | 3.44E+02 | 5.09E−01 | 9.08E+02 | 1.37E+03 |
| ClO₂ + | Sep. 11, | Plate count | | | 0.00E+00 |
| Irra- | 2009 | | | | |
| diated | Sep. 18, | <0.1803 | <0.1803 | <0.1803 | <0.1803 |
| | 2009 | | | | |
| | Sep. 25, | <0.1803 | <0.1803 | <0.1803 | <0.1803 |
| | 2009 | | | | |
| | Oct. 5, 2009 | <0.1803 | <0.1803 | <0.1803 | <0.1803 |

TABLE 26

| Sam- | Sampling | MPN/g | 95% Con. Interval | | MPN/4 g |
|---|---|---|---|---|---|
| ple # | date | dry wt | Lower | Upper | dry wt |
| ClO₂ | Sep. 11, 2009 | Plate count | | | 7.26E+06 |
| | Sep. 18, 2009 | 2.54E+04 | 7.92E+03 | 6.04E+04 | 1.02E+05 |
| | Sep. 25, 2009 | 4.17E+02 | 7.64E−01 | 9.97E+02 | 1.67E+03 |
| | Oct. 5, 2009 | <0.1803 | <0.1803 | <0.1803 | <0.1803 |
| ClO₂ + | Sep. 11, 2009 | Plate count | | | 2.14E+03 |
| Irra- | Sep. 18, 2009 | 2.53E+02 | 4.06E−01 | 6.03E+02 | 1.01E+03 |
| diated | Sep. 25, 2009 | <0.1803 | <0.1803 | <0.1803 | <0.1803 |
| | Oct. 5, 2009 | <0.1803 | <0.1803 | <0.1803 | <0.1803 |

These results provide strong evidence that neither the spiked E. coli (fecal coliform) nor Salmonella sp. showed any evidence of re-growth in the aerobically or anaerobically digested municipal biosolids. There was no re-growth even when the treated samples were placed in an incubator to enhance microbial growth. Even samples that were treated with only chlorine dioxide showed no re-growth of fecal coliforms or Salmonella spp.

### Example 5

### Destruction of Estrogenic Compounds by E-Beam Alone and in Combination with Chlorine Dioxide or Ferrate

The underlying hypothesis for the following example was that E-Beam and/or chemical oxidants (chlorine dioxide and ferrate) were capable of destroying the estrogenic activity associated with 17-β-estradiol (E2) in aerobically and anaerobically treated biosolids. This reduction in estrogenic activity could then be assessed using both the breast cancer cell line ZR-75 and the YES strain. Using more than just one in vitro bioassay when assessing estrogenic activity may be beneficial since every bioassay comes with its own set of issues.

The breast cancer cell line ZR-75 was obtained from the American Type Culture Collection (ATCC, Manassas, Va.). The ZR-75 cells were maintained in Dulbecco's Modified Eagle medium (DMEM) (Sigma-Aldrich, St. Louis, Mo.) with phenol red and supplemented with 10% fetal bovine serum and 2.2 g/L sodium bicarbonate in an air:carbon dioxide (95:5) atmosphere at 37° C. Twenty-four hours before transfection, the cells were seeded in 12 well-plates in Dulbecco's Modified Eagle medium/Ham's Nutrient Mixture F-12 (DME/F12) (Sigma-Aldrich) supplemented with 2.5% charcoal-stripped fetal bovine serum at 50% confluence. Lipofectamine 2000 reagent (Invitrogen, Carlsbad, Calif.) was used to transfect 0.5 μg of 3× estrogen response element (ERE)-Luc reporter construct, 0.25 μg human estrogen receptor (ER) α expression vector, and 0.02 μg β-Galactosidase expression vector to each well according to manufacturer's recommendation.

After 6 hours, the transfection mix was replaced with fresh medium and appropriate solvent controls dimethyl sulfoxide (DMSO), E2 standards or treatments were applied. After 24 hours, the cells were harvested by manual scraping in reporter lysis buffer (Promega, Madison, Wis.). The harvested cells were frozen in liquid nitrogen and thawed in a cold water bath, vortexed for 30 seconds, and centrifuged at 12,000×g for 1 minute. The supernatants were assayed for luciferase activity using luciferase assay reagent (Promega). The activity of β-Galactosidase was measured using the Tropix Galacto-Light Plus assay system (Tropix, Bedford, Mass.) in a Lumicount microwell plate reader (Packard Instrument, Downers Grove, Ill.). The relative light units were used as an index of estrogenic activity.

The recombinant yeast strain (Saccharomyces cereviciae) used for the YES assay was obtained from Dr. Nancy Love at the University of Michigan. This recombinant yeast strain contains the human estrogen receptor as well as an estrogen response element coupled with the luciferase gene. In contrast, the ZR-75 breast cancer cells have to be transfected with a plasmid containing the estrogen response element as well as the luciferase gene. When estrogenic compounds bind to the cell, it is believed that this pathway is activated and the enzyme β-galactosidase is secreted into the media where it changes the color of a chromogenic substrate (chlorophenol red-β-galactopyranoside—CPRG). The substrate may change color from yellow to red when it interacts with the enzyme β-galactosidase. This color change may be measured using a spectrofluorometer.

The yeast cells were grown overnight in a special medium containing a variety of amino acids and vitamins. It was found that the yeast cells grew best when incubated at 32° C. and shaking at 200 rpm. After approximately 24 hours, or when turbid, a portion of the cells was transferred into new media, the chromogenic substrate was added and the subsequent mixture was aliquoted into a 96-well plate. Samples and appropriate controls (E2 standards and negative controls) were added into the wells and the plate was incubated at 32° C. for 24-36 hours. The ending time point was determined when the negative control (DMSO) caused a color change of the substrate. The absorbance at 620 nm (for cell turbidity) and 550 nm (chromogenic substrate) was measured using a spectrofluorometer and the data was subsequently analyzed.

The objectives of this example were to (1) determine whether the 10 MeV E-Beam is capable of destroying the estrogenic activity of a model estrogen (17-β-estradiol) in effluent, (2) determine whether the 10 MeV E-Beam at varying doses is capable of destroying the estrogenic activity of a model estrogen (17-(3-estradiol) in drinking water and wastewater effluent, (3) determine the destruction of estrogenic activity in aerobically digested biosolids when exposed to E-Beam irradiation at varying doses and measured using both the YES assay and the cancer cell line (ZR-75) assay, (4) determine the destruction of estrogenic activity in anaerobically digested biosolids when exposed to E-Beam irradiation at varying doses and measured using both the YES assay and the cancer cell line (ZR-75) assay, (5) determine the destruction of estrogenic activity in aerobically and anaerobically digested biosolids when exposed to varying concentrations of chlorine dioxide, (6) determine the destruction of estrogenic activity in aerobically and anaerobically digested biosolids when exposed to varying concentrations of chlorine dioxide and an 8 kGy E-Beam dose, (7) determine the destruction of estrogenic activity in aerobically and anaerobically digested biosolids when exposed to varying concentrations of ferrate, and (8) determine the destruction of estrogenic activity in aerobically and anaerobically digested biosolids when exposed to varying concentrations of ferrate and an 8 kGy E-Beam dose.

Water-soluble 17-β-estradiol (E2) was obtained from Sigma. All glassware used in these experiments was properly cleaned to remove any residual estrogenic compounds on the glass. Briefly, glassware was soaked in a 1% Alconox bath for at least four hours and then in a 1% Contrad bath for at least four hours. Lastly, the glassware was put in an oven at 150° C. for at least four hours. In between each step, glassware was rinsed first with tap water and then with DI water.

Three different matrices were used in these experiments namely, drinking water, tertiary (chlorine treated) effluent, and aerobically and anaerobically digested biosolids. The samples (20 mL) were spiked with a 1 μM (10⁻⁶ mol/L) concentration of E2. Every experiment was conducted in triplicate. The triplicate samples were subjected to varying doses of 10 MeV E-beam (2-12 kGy) and or varying concentrations of chemical oxidants depending on the experimental objective. The treated samples and the untreated controls (E2 spiked and unspiked) were extracted using dichloromethane (2:1) and a reparatory funnel. The solvent fraction (bottom) was collected in a glass tube and allowed to evaporate completely in a fume hood. The aqueous fraction (top) was discarded. The dried extract was re-suspended in 100 μl of DMSO (universal solvent) and analyzed using the breast cancer cell line ZR-75 cell culture assay and or the YES assay. Water samples were included in some of the experiments to prove that ‘estrogenic activity’ was not being introduced into the samples, i.e., estrogenic compounds were not being leached into the experimental samples from plasticware and glassware used in the experiments.

The chlorine treated effluent samples were collected from the College Station wastewater treatment plant, which used autothermal thermophilic aerobic digestion. After the effluent samples were spiked with 1 μM E2 they were incubated overnight at 4° C. The samples were subsequently irradiated at 8 kGy. The sample was then extracted as described above. The extracts from the E-beam treated effluent samples as well as the controls (E2 spiked and unspiked) were diluted 50% and 1/8. Thus undiluted, 50% diluted and 1/8 diluted samples were analyzed using the ZR-75 cell culture assay.

All of the biosolid samples were collected, spiked with E2 and treated with either E-beam and or chemical oxidants the same day. Samples were separated into liquid and solid portions by centrifugation. Liquid portions were acidified to stop any microbial activity and stored at 4° C. until estrogen extraction. Estrogen extractions were completed within two weeks of every experiment and extracts were resuspended in DMSO and stored at 4° C. Solid portions were stored at −20° C. until solid phase extraction.

Whether the 10 MeV E-Beam is Capable of Destroying the Estrogenic Activity of a Model Estrogen (17-β-Estradiol) in Effluent.

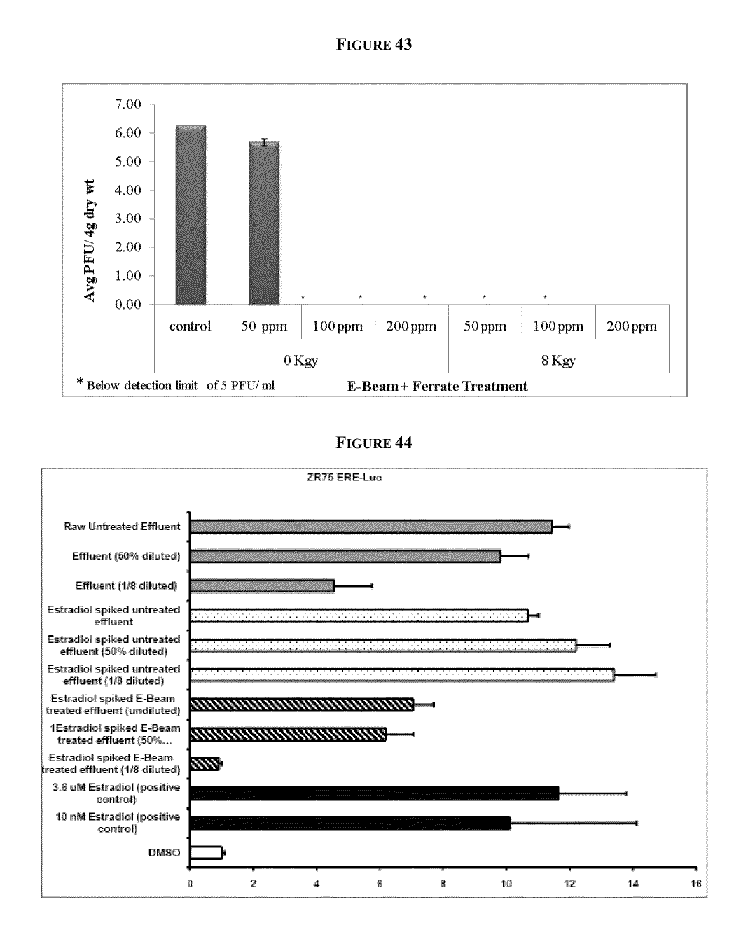

As can be seen in FIG. 44, the effluent from the wastewater treatment plant contained significant levels of estrogenic activity. The level of activity is as high as that of the 3.6 μM E2 positive control. The samples were diluted 50% and 1/8 since it has been previously noted that when analyzing unknown environmental samples, dilution is recommended to avoid any artificial sample inhibition issues. The influence of dilution on the estrogenic activity was evident when the results from the E2 spiked untreated effluent samples were analyzed. The undiluted E2 spiked effluent sample showed lesser activity (88%) than the 50% diluted sample and 80% of the activity of the 1/8 diluted sample. This suggested that the undiluted sample was as expected inhibiting the estrogenic activity assay. The E-beam treated (dose: 8 kGy) samples showed significantly reduced estrogenic activity compared to the untreated samples. The E-beam treated (undiluted) sample showed less than 53% activity as compared to the 1/8 diluted untreated sample. The 1/8 diluted treated sample showed less than 7% of the estrogenic activity when compared to the 1/8 diluted untreated sample.

These results suggested that E-beam irradiation at 8 kGy was capable of destroying estrogenic activity originating from water-soluble E2 in the effluent samples. It is important to note that the above studies were performed in wastewater effluent and not biosolids.

Whether 10 MeV E-Beam at Varying Doses is Capable of Destroying The Estrogenic Activity of a Model Estrogen (17-β-Estradiol) in Drinking Water and Wastewater Effluent.

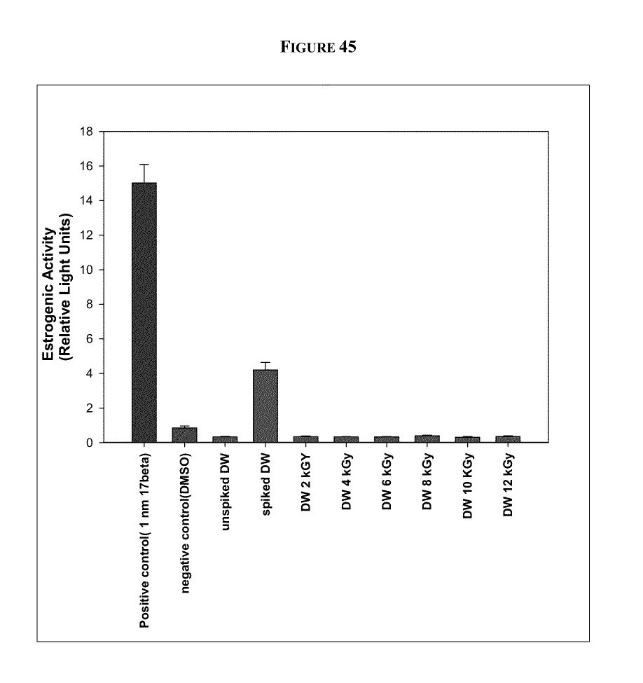

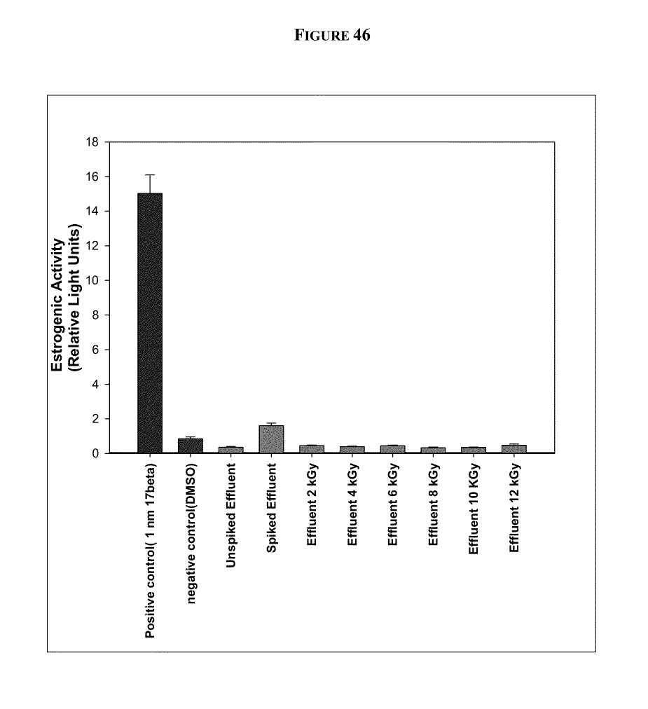

FIGS. 45-47 show the results of whether 10 MeV E-Beam at varying doses is capable of destroying the estrogenic activity of a model estrogen (17-β-estradiol) in drinking water and wastewater effluent.

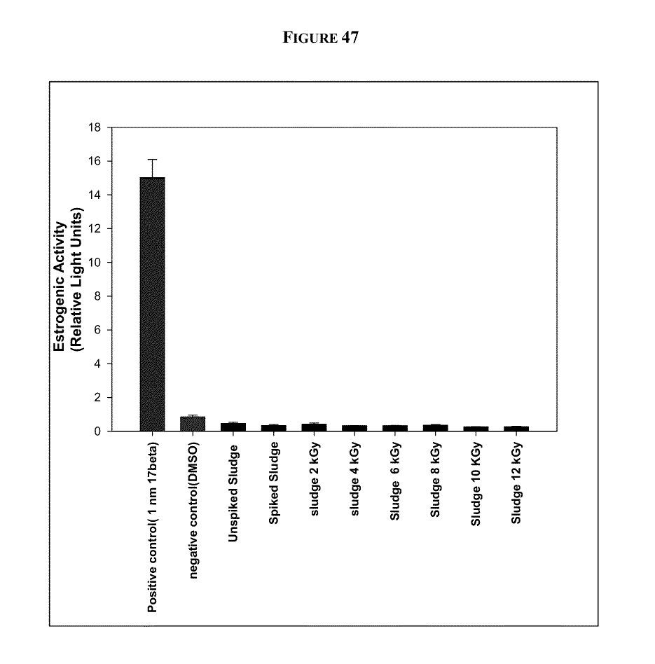

The experimental protocol that was used to determine estrogenic activity in biosolids may not have been sufficient to detect the estrogenic activity. This was based on the results observed in the E2 spiked (untreated) sample of the biosolids experiment, as shown in FIG. 47. The E2 spiked (untreated) sample should have shown higher activity than the unspiked (untreated) sample. If the experimental protocol was capable of extracting the estrogens from the E2 spiked biosolid sample, this sample should have shown higher activity than the unspiked sample. It was determined that E2 was primarily in the water phase at low concentrations and hence it partitioned out of the solid phase whenever the biosolid sample was in the presence of water. Thus, to determine the E-beam based destruction of estrogens in biosolid samples, it was necessary to treat the biosolids and then extract the liquid portion of the biosolid sample by centrifugation and then extract and measure the levels of estrogenic activity in the liquid and solid fraction separately.

The reduction of estrogenic activity in the aqueous samples (drinking water and tertiary effluent) nevertheless supported the underlying hypothesis and earlier results that 10 MeV E-beam was capable of destroying estrogenic activity. The % reduction of estrogenic activity (as measured in relative light units) in the drinking water and effluent is shown below in Table 27.

TABLE 27

| | % Reduction in Estrogenic Activity | |
|---|---|---|
| Radiation Dose | Drinking Water (n = 3) | Sewage Effluent (n = 3) |
| 2 kGy | 92% | 72% |
| 4 kGy | 92% | 76% |
| 6 kGy | 92% | 72% |
| 8 kGy | 91% | 79% |
| 10 kGy | 93% | 78% |
| 12 kGy | 92% | 71% |

*% reduction calculated as a function of estrogenic activity in respective spiked sample

Based on these results it is evident that the 10 MeV E-beam is capable of destroying the estrogenic activity in drinking water and effluent samples even at doses as low as 2 kGy. Since 8 kGy can achieve a significant microbial inactivation, these results suggest that the use of 8 kGy can achieve both microbial and estrogenic activity reductions. A 71-79% reduction of estrogenic activity in wastewater effluent is significant when compared to conventional treatment methods. Current wastewater treatment consists of preliminary treatment, primary sedimentation, and secondary treatment. Research has shown that the first two steps may be inefficient at removing estrogenic compounds from the wastewater. Secondary treatment processes such as activated sludge may be the key process for removing estrogenic compounds. Data suggest activated sludge is able to reduce these compounds by 80-85%. It is believed that estrogenic compound removal is enhanced through longer solid retention times. However, increased solid retention times are coupled with a cost increase and may not yield a much greater reduction of estrogenic compounds. On the other hand, E-beam is a very quick process (seconds to minutes) which is able to achieve similar results in terms of reduction of estrogenic activity. Furthermore, while the E-beam is destroying estrogenic compounds, it is simultaneously reducing the pathogen load as well.

For subsequent experiments both the ZR-75 breast cancer cell assay and the YES strain were available. In order to quantitatively determine the destruction of estrogenic activity in the biosolid samples using the YES assay, a standard curve of known E2 concentrations was prepared. For this reason, standard curves were run for every YES assay experiment so that the absorbance values of the YES assay resulting from known concentrations of E2 could be compared to the absorbance values of the E2 spiked into the biosolid samples.

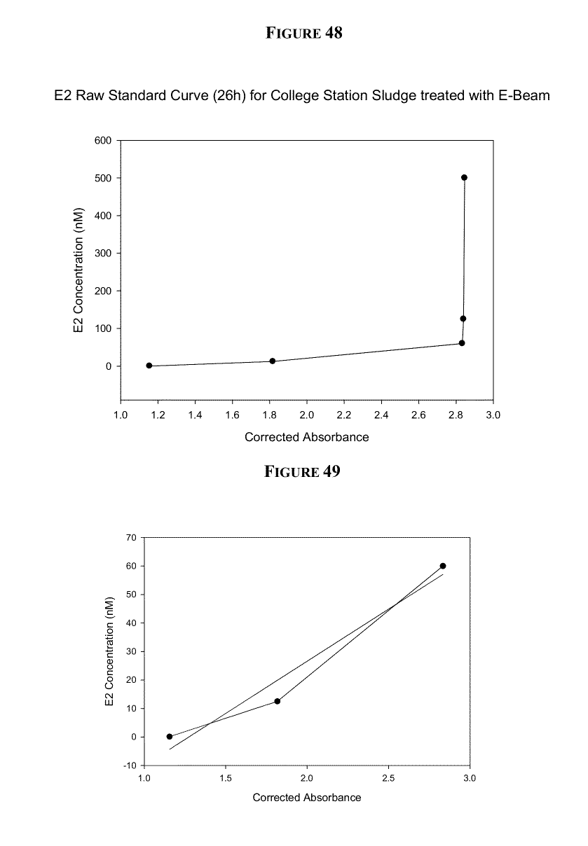

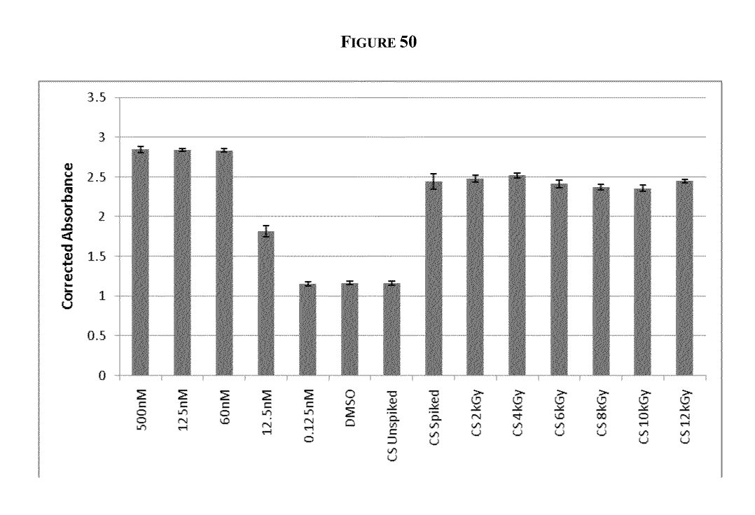

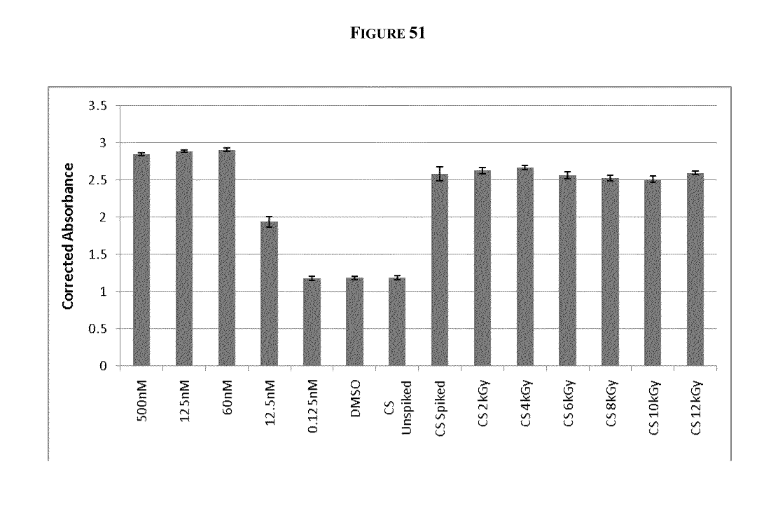

For the YES assay, five different concentrations of E2 (0.125 nM, 12.5 nM, 60 nM, 125 nM, and 500 nM) were included on every 96-well plate. A stock solution of E2 (1 mM) in DMSO was prepared and appropriate dilutions were made. DMSO was used as the solvent because the extracted estrogens from the biosolid samples had been resuspended in DMSO as well. These five different E2 standards were included on every 96-well plate and used to construct a standard curve for each 96-well plate. This was done to account for cell variability since the yeast cells respond slightly differently to E2 from experiment to experiment. A standard curve allowed us to compare estrogenic activity results across different 96-well plates and hence experiments. The liquid portions of the biosolid samples were analyzed for estrogenic activity using the YES assay. The solid portion was shipped to Tulane for extraction and estrogenic activity measurements. FIG. 48 shows an example of the relationship between the different E2 concentrations (dissolved in DMSO) and the absorbance readings as determined using the YES assay. One such standard curve was constructed for each experiment.

As can be seen from the FIG. 48, the absorbance resulting from the 60 nM, 125 nM, and 500 nM were similar suggesting that above 60 nM there was saturation of the YES assay. Thus, for preparing the standard curve, the absorbance from only the 0.125 nM, 12.5 nM, 60 nM samples were utilized. The linear portion of the curve was used to create the regression equation between E2 concentration (estrogenic activity) and absorbance as measured in the YES assay. FIG. 49 shows this relationship.

FIG. 49 suggests that there is a linear relationship between the amount of E2 and the absorbance values measured in the YES assay. However, the results indicate that there is a dynamic range between which the YES assay would be useful. The upper limit as per these experimental conditions was 60 nM of E2. This means that when an environmental sample has an E2 concentration above 60 nM, the sample may have to be diluted to accurately determine the E2 concentration. A similar saturation effect may also be seen with the ZR-75 breast cancer cells. When E2 concentrations surrounding the cells are too high, the cells may become over stimulated and shut down.

The Destruction of Estrogenic Activity in Aerobically Digested Biosolids when Exposed to E-Beam Irradiation at Varying Doses and Measured Using Both the Yes Assay and the Cancer Cell Line (ZR-75) Assay.

The aerobically digested samples (in triplicate) were also spiked with 1 μM of E2. The samples were exposed to varying E-beam doses and the treated samples were measured for residual estrogenic activity using the YES assay. While the yeast cells were incubating, they were routinely inspected for a visible color change. Once the E2 standards began to produce a slight color change (faint orange) of the chromogenic substrate, absorbance readings were taken on an hourly basis. Once the negative control (DMSO) began to produce a slight color change (faint orange) of the chromogenic substrate, the incubation was stopped and the experiment ended. The time-point immediately preceding the negative control changing color was used for analysis. In most cases, these time-points were around 24-27 hours. In the case of the aerobically treated biosolid samples treated with E-beam, the 26 and 27 hour time points were analyzed to determine whether there would be significant differences in the absorbance readings. FIGS. 50 and 51 show these results.

This data shows that there was no significant difference in the YES assay results when interpreted after 26 and 27 hours. The absorbance readings for the E-beam treated samples were just below 2.5 for the 26 hour time-point and just barely above 2.5 for the 27 hour time-point. More importantly, however, was the observation that there appeared to be no reduction of estrogenic activity even at 12 kGy of E-beam treatment by the YES assay. There was no difference in the level of estrogenic activity in the aerobically digested sludge samples spiked with E2 (CS spiked) and the E-beam treated samples. These results were contradictory to previous results in distilled water and sewage effluent samples (using the breast cancer cell line). As expected, the unspiked sample did show lower estrogenic activity as compared to the spiked sample. However, the unspiked sample did not appear to be significantly different when compared to the DMSO control suggesting that the unspiked aerobically treated samples had negligible estrogenic activity. Neither was there any significant difference between the unspiked samples and the standard E2 sample of 0.125 nM. The lack of reduction of the estrogenic activity even after exposure to 12 kGy was surprising. This result contradicted previously obtained results with distilled water and treated sewage effluent. It is believed that this difference may be attributable to a) the partitioning of E2 between the solids fraction and the aqueous fraction, and b) the solids content in the biosolids sample as compared to the distilled water and wastewater effluent.

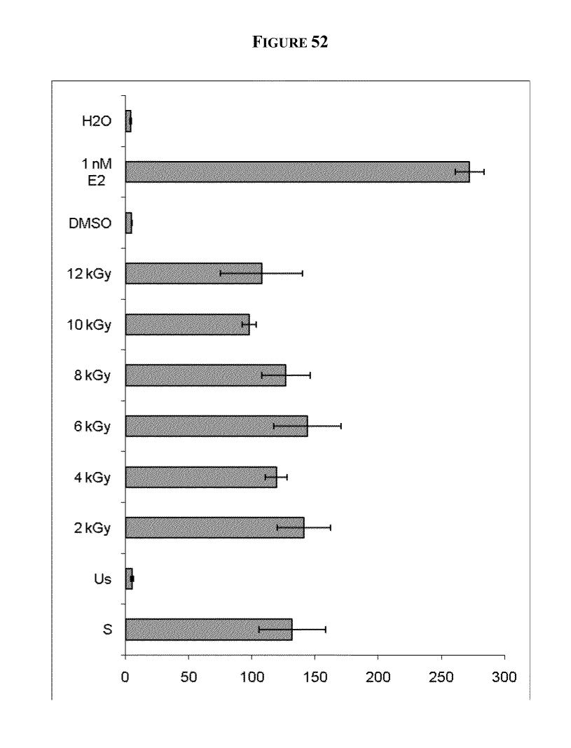

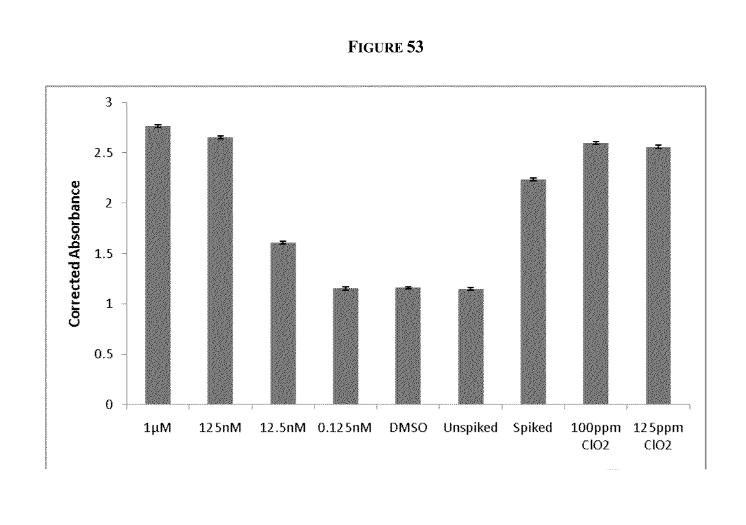

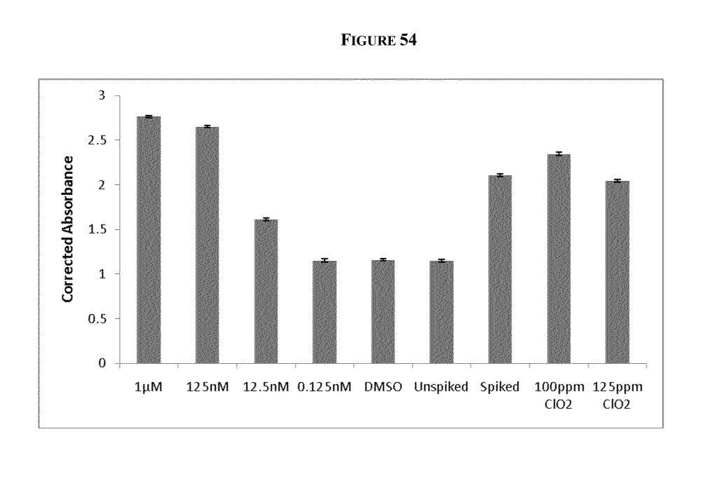

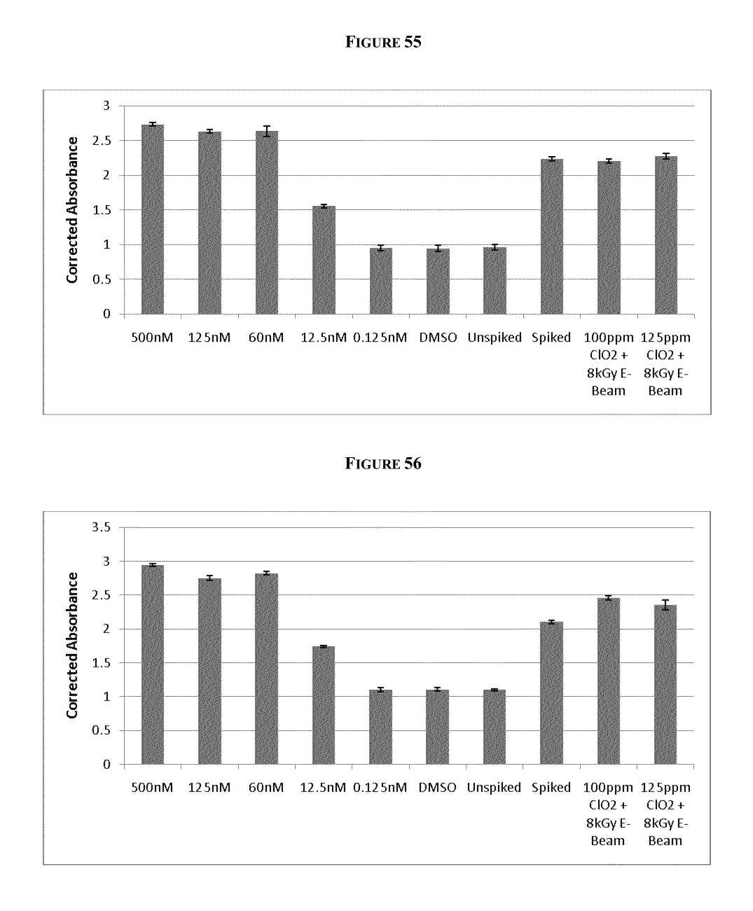

The same biosolid samples that were collected and extracted for the YES assay were used for the ZR-75 breast cancer cell assay. The rationale for performing this experiment was that the cancer cell line assay is supposedly more specific at detecting estrogenic activity as compared to the YES assay. It has been shown that antiestrogens, such as hydroxytamoxifen, are able to produce a partial agonistic (estrogenic) response. Thus, this experiment was performed to verify the results obtained using the YES assay. The results from this experiment are shown in FIG. 52.

Based on a t-test there was no statistical difference (P=0.072) between the estrogenic activity (measured as relative light units) in the E2 spiked (untreated samples) and the 12 kGy E-beam treated samples. The H₂O samples were included to prove that ‘estrogenic activity’ was not being introduced into the samples, i.e. estrogenic compounds were not being leached into the experimental samples from plasticware and glassware used in the experiments. This experiment confirmed the results obtained with the YES assay, namely that E-beam at the doses tested is unable to reduce estrogenic activity in the liquid portion of the aerobically treated biosolid samples.

The Destruction of Estrogenic Activity in Anaerobically Digested Biosolids when Exposed to E-Beam Irradiation at Varying Doses and Measured Using Both the Yes Assay and the Cancer Cell Line (ZR-75) Assay.

An E-beam experiment using anaerobically treated biosolids was also performed. Unfortunately, for this experiment the unspiked control sample showed a higher estrogenic activity than the E2 spiked sample. This was contradictory since more estrogenic activity was expected in the E2 spiked sample. It is believed that for some reason not all of the E2 in the spiked sample was recovered. Hence, the E-Beam experiment with anaerobically treated biosolids had to be repeated. Even though the results of this experiment cannot be used due to the E2 spiked control sample, the experiment did show that there was also no reduction of estrogenic activity by E-beam. Due to technical difficulties at the National Center for Electron Beam Research, this objective could not be completed. However, it is believed that if the experiment had been repeated there would have been no reduction of estrogenic activity by E-beam as was seen for the aerobically treated biosolids.

These results again would contradict previously obtained results with distilled water and treated sewage effluent. It is believed that this difference may be attributable to a) the partitioning of E2 between the solids fraction and the aqueous fractions, and b) the solids content in the biosolids sample as compared to the distilled water and wastewater effluent.

It is believed that the particulate organic matter in the biosolid samples may have a protective effect. In other words, when chemical compounds are suspended in water (i.e. effluent) and subjected to E-beam irradiation, the high energy electrons mainly collide with the chemical compounds and water molecules. The water molecules may be split and may create reactive oxygen species (ROS), which in turn may help break down the chemical compounds. However, once solid particles are introduced into the matrix, even at low concentrations (2-5% solids is normal for biosolids), the high energy electrons have many more targets that they can now collide with. Also fewer ROS are produced because fewer water molecules are split by the high energy electrons. In addition, the high energy electrons and ROS may also partially oxidize the organics, which appears to increase the hormonally active metabolites in the biosolid samples.

It is believed that higher E-Beam doses (above 12 kGy) are needed to reduce chemical compounds such as E2 in biosolids.

The Destruction of Estrogenic Activity in Aerobically and Anaerobically Digested Biosolids when Exposed to Varying Concentrations of Chlorine Dioxide.

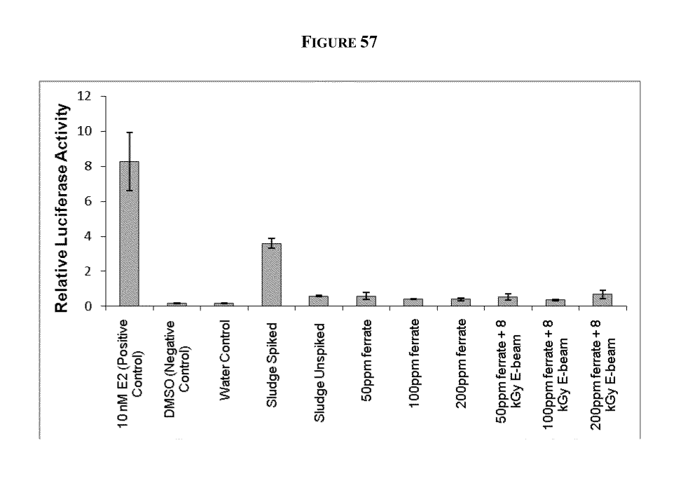

Chlorine dioxide concentrations of 100 ppm and 125 ppm were chosen because preliminary pathogen reduction experiments had shown good reductions at these concentrations. Results are shown in FIGS. 53 and 54.

As can be seen by FIGS. 53 and 54, chlorine dioxide at 100 ppm and 125 ppm does not reduce the estrogenic activity in the liquid portion of the biosolid samples. In fact, there appears to be a slight increase in estrogenic activity. The 1 μM, 125 nM, 12.5 nM and 0.125 nM E2 standards were included in the experiment for the preparation of the standard curve that was discussed earlier. The DMSO control and the unspiked control samples showed similar estrogenic activity implying that the biosolid sample used in this experiment had negligible estrogenic activity.

As with the E-beam treatment, chlorine dioxide could be acting on the organic matter contained in the biosolid sample, hence increasing the active metabolites and subsequently the estrogenic activity of the sample. Higher chlorine dioxide concentrations may be able to reduce the estrogenic activity in the biosolid samples.

The Destruction of Estrogenic Activity in Aerobically and Anaerobically Digested Biosolids when Exposed to Varying Concentrations of Chlorine Dioxide and An 8 kGy E-Beam Dose.

Because preliminary pathogen reduction experiments had shown good reductions at chlorine dioxide concentrations of 100 ppm and 125 ppm, these ranges were chosen to see if these same concentrations were also effective at reducing the estrogenic activity of biosolids. An 8 kGy E-beam dose was chosen because pathogen reduction experiments had shown that an 8 kGy dose can achieve a significant microbial inactivation. Results are shown in FIGS. 55 and 56.

There was no significant difference in the levels of estrogenic activity in the E2 spiked (untreated) samples and the treated (chlorine dioxide+E-beam treated) samples. The 500, 125, 60, 12.5 and 0.125 nM E2 standards were included in the experiment for the preparation of the standard curve that was discussed earlier. The DMSO control and the unspiked control samples showed similar estrogenic activity implying that the biosolid sample used in this experiment had negligible estrogenic activity.

Overall, these experiments indicate that unlike the results obtained for the drinking water and effluent samples, there was no reduction of estrogenic activity in the liquid portions of the biosolid samples by either chlorine dioxide or chlorine dioxide combined with 8 kGy E-beam irradiation.

The Destruction of Estrogenic Activity in Aerobically and Anaerobically Digested Biosolids when Exposed to Varying Concentrations of Ferrate or to Varying Concentrations of Ferrate and an 8 kGy E-Beam Dose.

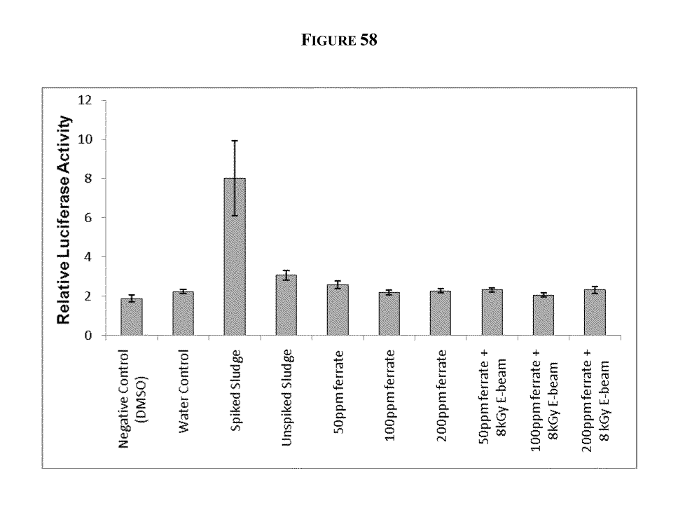

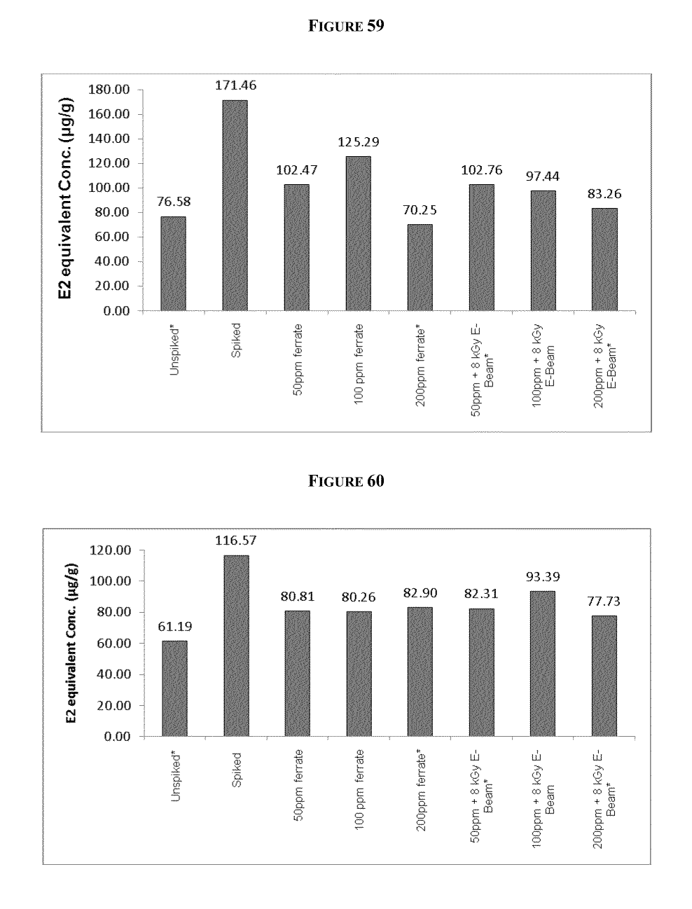

One experiment was conducted for both objectives. Ferrate concentrations of 50 ppm, 100 ppm and 200 ppm were chosen based on research on water reuse projects at Tulane University which demonstrated that with a TOC level of approximately 25 mg/L, 30 ppm of ferrate was effective. Since biosolids have significantly higher TOC concentrations, higher ferrate concentrations were used. An 8 kGy E-beam dose was chosen because pathogen reduction experiments had shown that an 8 kGy dose can achieve a significant microbial inactivation. Results are shown in FIGS. 57-60.

As can be seen by the figures, there was a reduction in estrogenic activity due to ferrate. Furthermore, the results for the liquid portion and the solid portion showed the same trend, namely a reduction of estrogenic activity as shown in Tables 28 and 29.

TABLE 28

| | % Reduction in Estrogenic Activity | |
|---|---|---|
| Treatment | Liquid Portion (n = 3)* | Solid Portion (n = 3) |
| 50 ppm Ferrate | 84% | 40% |
| 100 ppm Ferrate | 88% | 27% |
| 200 ppm Ferrate | 89% | 59% |
| 50 ppm + E-Beam | 85% | 40% |
| 100 ppm + E-Beam | 90% | 43% |
| 200 ppm + E-Beam | 81% | 51% |

*% reduction calculated as a function of estrogenic activity in respective spiked sample

TABLE 29

| | % Reduction in Estrogenic Activity | |
|---|---|---|
| Treatment | Liquid Portion (n = 3)* | Solid Portion (n = 3) |
| 50 ppm Ferrate | 68% | 30% |
| 100 ppm Ferrate | 73% | 31% |
| 200 ppm Ferrate | 72% | 29% |
| 50 ppm + E-Beam | 71% | 29% |
| 100 ppm + E-Beam | 74% | 20% |
| 200 ppm + E-Beam | 71% | 30% |

*% reduction calculated as a function of estrogenic activity in respective spiked sample

It appears that estrogenic reduction is mainly due to ferrate alone. There seems to be no difference in estrogenic reduction with the addition of the E-beam. This is not surprising since it has already been shown that the E-beam is unable to reduce estrogenic activity at the doses tested, ranging from 2-12 kGy. It seems that ferrate is able to reduce estrogenic activity in aerobically treated biosolids to a larger extent than in anaerobically treated biosolids.

Since the liquid and the solid portion for the ferrate experiments showed the same trend, it is believed that the solid portions of the other experiments (E-beam and chlorine dioxide) would have behaved in the same manner.

Overall, the results indicate that E-beam is effective at reducing estrogenic activity in drinking water and wastewater effluent with doses as low as 2 kGy, but not in biosolids with doses as high as 12 kGy. It is believed that this inability to reduce estrogenic activity in biosolids may be attributable to a) the partitioning of E2 between the solids fraction and the aqueous fractions, and b) the solids content in the biosolids sample as compared to the distilled water and wastewater effluent. It is believed that the particulate organic matter in the biosolid samples may have a protective effect. When solid particles are in the matrix, even at low concentrations (2-5% solids is normal for biosolids), the high energy electrons have many more targets that they can collide with and fewer ROS are produced because fewer water molecules are split by the high energy electrons. In addition, the high energy electrons and ROS may also partially oxidize the organics, which appears to increase the hormonally active metabolites in the biosolid samples.

Ferrate on the other hand was able to reduce estrogenic activity in both the liquid and solid portion of the biosolids. It was able to reduce estrogenic activity to a greater extent in the liquids portion than in the solids portion. Based on these results, the E-beam may be effective for the treatment of drinking water and wastewater effluent and ferrate may be effective for the treatment of biosolids.

### Example 6

### Stabilization of Municipal Biosolids Using E-Beam Irradiation and Chemical Oxidants

The focus of this example was to evaluate the extent of biosolid stabilization that could be achieved when aerobically and anaerobically digested biosolids were treated with the E-beam combined with the chemical oxidant, ferrate.

The stabilization studies were performed with ferrate at 100 mg/L. The E-beam dose that was used was 8 kGy. This ferrate concentration and E-beam dose were based on earlier results which identified an optimal ferrate and E-beam dose for microbial inactivation.

The ferrate and ferrate+E-beam treated biosolid samples were sent to a commercial laboratory in College Station, Tex. for the measurement of the following parameters: Biochemical Oxygen Demand (BOD), Total Suspended Solids (TSS), Total Volatile Suspended Solids (TVSS), and Specific Oxygen Uptake Rate (SOUR).

The BOD, TSS, TVSS and SOUR test results from the ferrate studies are shown in Table 30. All these results are based on one sample each.

TABLE 30

| Sample | Treatment | BOD | TSS | TVSS | SOUR |
|---|---|---|---|---|---|
| Aerobic Sludge | No Treatment | 4510 | 15700 | 12000 | 5.86 |
| Aerobic sludge | 100 ppm ferrate + | 3840 | 14200 | 10100 | 1.91 |
| | E-Beam | | | | |
| Aerobic sludge | 100 ppm ferrate | 3990 | 5600 | 4160 | 4.06 |
| Anaerobic sludge | No treatment | 996 | 29000 | 16900 | 2.64 |
| Anaerobic sludge | 100 ppm ferrate | Data not available | | | |
| Anaerobic sludge | 100 ppm ferrate + | 2190 | 17100 | 9640 | 2.48 |
| | E = Beam | | | | |

One set of samples could not be analyzed due to mislabeling.

When the aerobically digested sludge was exposed to 100 ppm ferrate, the BOD, TSS, VSS and SOUR test values all decreased, as shown in Table 30. The BOD values decreased by 11.5% as compared to the VSS values, which decreased by 66%, as shown in Table 31. This 66% reduction in volatile suspended solids reduction (Vector Attraction Reduction) indicates that the biosolid sample has undergone significant stabilization. The combined treatment of E-beam and ferrate brought the SOUR test value (1.91) close to the standard U.S. EPA value of 1.5 mg O₂/hr/g for the aerobically treated samples. 1.91 mg O₂/hr/g is very close to the standard 1.5 mg O₂/hr/g and hence indicates that the aerobically digested biosolids treated with ferrate and E-beam are very close to stabilization. The E-beam produces free radicals which may oxidize organics in turn which may lower the oxygen uptake, which may lead to less degradation and more stable biosolids. It is surprising, however, that when the aerobically digested biosolid samples were treated with ferrate and E-beam the VSS reduction decreased from 66 to 15%.

The data, however, do indicate a significant increase in BOD in the anaerobic samples suggesting that the ferrate treatment coupled with E-beam is causing a possible conversion of the non-biodegradable refractory organics to a degradable form. Since anaerobically digested biosolids inherently contain more organics than aerobically treated ones, it is not surprising that the VSS reduction is greater for anaerobically treated biosolids compared to aerobically treated ones. It must be emphasized that these studies were performed on samples that had already undergone a substantial amount of stabilization within the aerobic and anaerobic digesters. Additionally, it needs to be emphasized that the E-beam dose that was used in this study was 8 kGy as compared to 15 kGy which had previously been identified to be optimal for a commercial wastewater treatment process.

The experiments were first carried out at 8 kGy E-beam to be comparable to the microbial inactivation experiments, which were also done at 8 kGy. It is believed that a commercial process should target a dose of 15 kGy to ensure a large enough safety margin for significant reductions in microbial populations and degradation of recalcitrant organic pollutants.

### Example 7

### Developing a Commercial E-Beam Process for Treating Municipal Biosolids

The problem that was addressed in this example was how to develop an E-beam irradiation design that can be used effectively to irradiate municipal wastewater effluent and municipal biosolids to destroy microorganisms. The irradiation process should inactivate pathogens and destroy chemical contaminants commonly found in wastewater materials to prescribed levels. The approach used was novel for at least the reason it utilized Monte Carlo simulations to evaluate the dose distribution throughout the entire volume of municipal biosolids subject to the E-beam at any given time.

The problem model included a rectangular parallelepiped of municipal biosolids material directly beneath the E-beam exit window. Although the municipal biosolids model included delivery on a continuous conveyor or flow through an open trough, only the volume of municipal biosolids directly below the exit window is of interest in the dosimetric model. The key quantity of interest in this model may be the volume rate of municipal biosolids processing. Since the end result of this project was to propose an economically feasible method for using ionizing radiation to process biosolids, this processing rate value was the basis for establishing a suitable model.

Electrons traveling through matter lose their energy by exciting and ionizing atoms within the material. The average linear rate of energy loss of these electrons in a particular medium is referred to as “stopping power” and generally has units of MeV per cm. This quantity is also often referred to as the linear energy transfer (LET) of the particle with units generally expressed as keV per μm. Stopping power and LET are closely related to the dose imparted to the material by the electrons traveling through that material.

The distance that a charged particle travels before coming to rest is known as the “range” of the particle. The ranges of electrons in municipal biosolids and effluent water were of particular interest when designing the parameters for this study. Previously a one-dimensional ITS TIGER Monte Carlo has been used code to calculate electron range values in water. The results were compared with the electron energy versus range equation given in the ICRU Report 35. This energy versus range equation is given in (0.1) below.

Eₚ=0.22+1.98Rₚ+0.0025(Rₚ)₂, (0.1)

where, EP=electron energy in MeV, and RP=practical range in g/cm².

It was calculated the range of 10 MeV electrons in water to be 4.922 cm, which corresponded to an electron energy of 10.025 from the ICRU equation. This resulted in a less than 1% difference between the two methods. Therefore, the range for 10 MeV electrons in water was taken as approximately 5 cm for the purposes of this study.

Absorbed Dose: Absorbed dose is the primary quantity used in the field of dosimetry. It is defined as the energy absorbed per unit mass from any kind of ionizing radiation in any target. The SI unit of absorbed dose is the gray (Gy). One Gy represents one joule of energy deposited per kilogram of material.

Models of the dose deposition in the biosolids and effluent water materials were developed using the MCNP5 radiation transport code. For the models, only the portion of material directly under the E-beam exit window at any given time was taken into consideration. Therefore, the geometry was defined as a rectangular parallelepiped (rpp) of municipal biosolids or wastewater effluent surrounded on three sides by 2 cm stainless steel, representing the delivery trough. The E-beam was modeled as a rectangular surface source with the dimensions of the beam exit window.

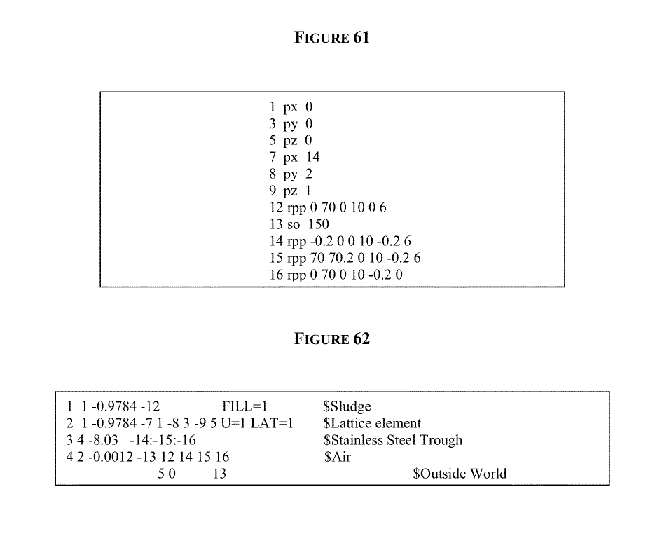

Eleven surfaces were used to define the geometry of this problem. Six plane surfaces were used to delineate the sides of the voxels used in the lattice specification. A macrobody surface was defined in the problem to represent the rpp of municipal biosolids/effluent material. Three more rpp macrobody surfaces were defined to represent the three sides of the stainless steel delivery trough. The last surface needed to complete the geometry specification of this problem was a sphere at the origin (so) used to define the scope of the radiation transport. The surface cards used to fully specify the geometry of this model are shown in FIG. 61.

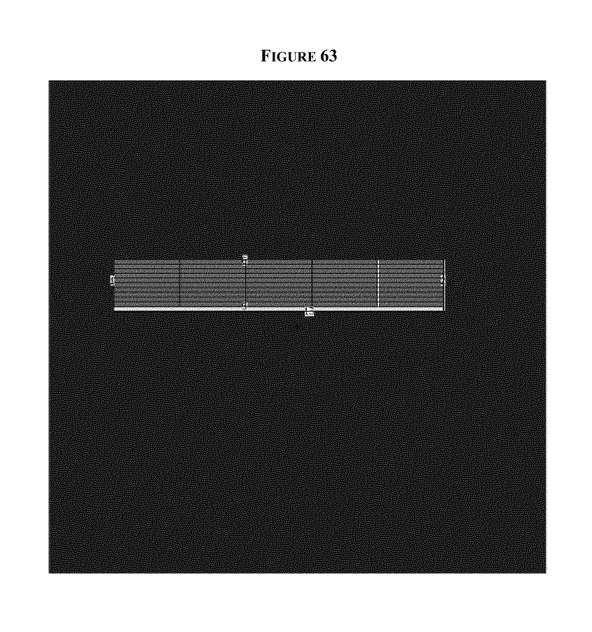

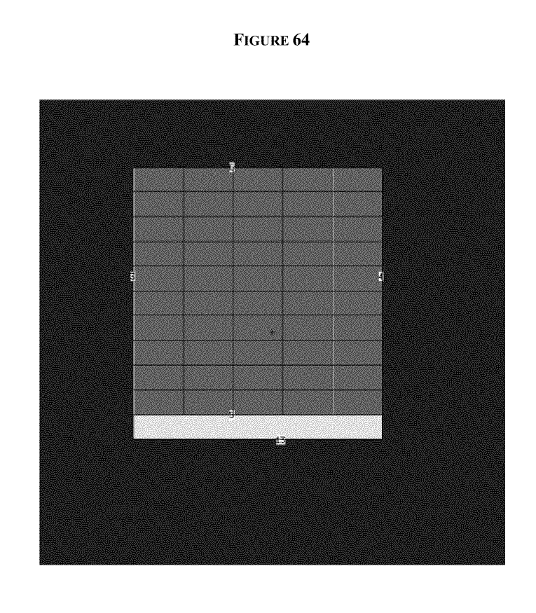

Five cell cards were used to define the cell card portion for the MCNP5 simulation model. The municipal biosolids rectangular parallelepiped was defined to be inside the rpp macrobody surface created for that purpose. For this model, the FILL card was used on the definition of cell 1, indicating that this cell was filled with a lattice composed of the cell in universe 1. Cell 2 in the MCNP5 input was used to define the lattice in the problem. The stainless steel trough was defined in cell 3 as the union between the volumes contained in cells 14, 15, and 16. The surrounding air in the problem was defined in cell 4. The outside world was defined in cell 5. This portion of the geometry specification allowed a point of reference for the termination of particle tracks in the problem. The cell cards used to specify the geometry in this model are shown in FIG. 62. Slices of the voxelized problem geometry taken from the MCNP5 geometry plotter are shown in FIGS. 63 and 64.

The lattice geometry specification for the problem at hand not only formed the foundation for the analysis of dose-deposition values in the simulation but also reinforced the value of this type of approach over conventional dosimetry methods. Because the lattice specification was an integral part of this study, it may be useful to describe the technique as it pertains to the MCNP5 coding of this problem.

Creation of a lattice in an MCNP5 input deck establishes a regular grid within the problem geometry. Each grid location may be referred to as an individual “voxel” and typically may be a single, homogenized material. Specifying “LAT=1” on the cell card means that the lattice is made of hexahedra, or solids with six faces. “LAT=2” specifies a lattice composed of hexagonal prisms, solids with 8 faces. After designing the lattice, the (0,0,0) element must be defined as well as the directions in which the three lattice indices will increase. Constraints for these choices are explained on page 3-29 of the MCNP5 manual. The bounding surfaces of the (0,0,0) element should then be entered on the cell card with the “LAT” keyword in the right order. For a hexahedral lattice cell, such as the one used for the applications in this study, the surfaces should be listed such that the (1,0,0) element is beyond the first surface listed, the (−1,0,0) element is beyond the second surface listed, then the (0,1,0), (0,−1,0), (0,0,1), and (0,0,−1) lattice elements in that order, for a total of six surfaces. The listing of these surfaces fully defines the lattice arrangement to MCNP5.

The “FILL” card may be the most useful portion of the lattice specification for the simulations created for this research. Non-zero entries on the “FILL” card indicate the numbers of the universes that fill the corresponding cell. When the filled cell is a lattice, the “FILL” specification can be a single entry or an array. With an array specification, the portion of the lattice covered by the “FILL” array is explicitly defined, and the rest of the lattice does not exist. For the single entry case on the “FILL” card, every element in the lattice is filled by the same universe. The single-entry definition has been used to define the municipal biosolids or effluent material that is segmented by a lattice grid. More options for filling array elements can be found on page 3-30 of the MCNP manual.

Once the lattice has been created and all voxels in the problem have been categorized according to universe, tallying over particular materials or individual voxels becomes a straightforward process. This method becomes very useful for using the MCNP5 code to calculate the dose deposited in small grid elements of the material under study.

Materials:

For the purposes of these simulations, effluent material has been modeled as pure water. For the municipal biosolids material, samples were taken from the Texas A&M University water treatment plant and from the College Station water treatment plant. The Texas A&M sample consisted of an anaerobically-digested municipal biosolids. The College Station sample consisted of autothermal thermophilic aerobically-digested municipal biosolids. The material compositions for the municipal biosolids samples can be defined using weight fraction compositions including the same sets of elements. The weight fractions were measured by the Texas A&M Soil Testing Laboratory. The material compositions for the aerobically digested and anaerobically digested municipal biosolids are shown in Tables 32 and 33, respectively. The “ZAID” column in Table 32 is used to write the MCNP5 material card. The digits preceding the period in the ZAID definition represent the atomic number followed by the atomic weight of the isotope. For the values in Tables 32 and 33, the atomic weights were set to “000” to indicate that the naturally-occurring combination of isotopes is used for each element. This is often referred to as the “elemental description”. When selecting electron transport tables within MCNP5, nuclides may be given as elemental descriptions. The portion of the ZAID definition that follows the period represents the MCNP5 data library identifier followed by the class of data. The class of data is “electrons” represented by “e”. The “03” data library is the most recent electron transport library packaged with MCNP5. Therefore, this cross-section library was used in the Monte Carlo simulation. A stainless steel trough and the air in the room were included in the model as well.

TABLE 32
ATAD Sludge 4.3% solids

| ZAID | Element | Weight Fraction |
|---|---|---|
| 7000.03e | Nitrogen | 0.191 |
| 15000.03e | Phosphorus | 0.0751 |
| 19000.03e | Potassium | 0.0227 |
| 20000.03e | Calcium | 0.0852 |
| 12000.03e | Magnesium | 0.0059 |
| 11000.03e | Sodium | 0.0386 |
| 30000.03e | Zinc | 0.002159 |
| 26000.03e | Iron | 0.00751 |
| 29000.03e | Copper | 0.00141 |
| 25000.03e | Manganese | 0.003562 |
| 6000.03e | Carbon | 3.8669 |
| 1000.03e | Hydrogen | 10.708 |
| 8000.03e | Oxygen | 84.992 |

TABLE 33
TAMU Sludge 2.6% solids

| ZAID | Element | Weight Fraction |
|---|---|---|
| 7000.03e | Nitrogen | 0.1681 |
| 15000.03e | Phosphorus | 0.0383 |
| 19000.03e | Potassium | 0.0108 |
| 20000.03e | Calcium | 0.0526 |
| 12000.03e | Magnesium | 0.0046 |
| 11000.03e | Sodium | 0.0339 |
| 30000.03e | Zinc | 0.002385 |
| 26000.03e | Iron | 0.00862 |
| 29000.03e | Copper | 0.003477 |
| 25000.03e | Manganese | 0.001907 |
| 6000.03e | Carbon | 2.2753 |
| 1000.03e | Hydrogen | 10.898 |
| 8000.03e | Oxygen | 86.502 |

Source Definition:

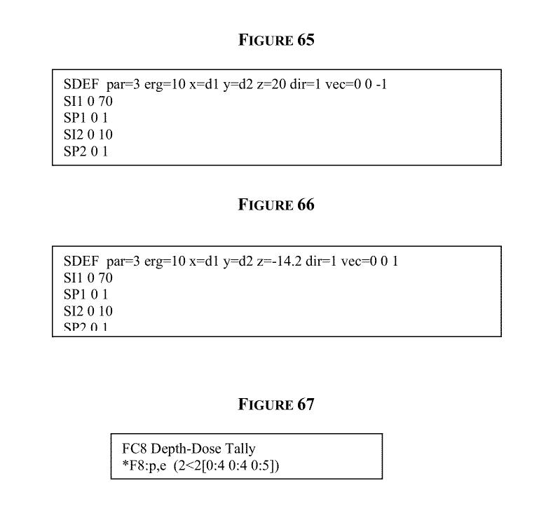

The E-beam exit window was modeled as the radiation source for this problem. The source particles were defined as 10 MeV electrons emitted from a planar source in one direction. Two E-beam exit windows were modeled to represent a dual-beam configuration, one E-beam above the material and one E-beam below the material. For the MCNP5 simulation, separate input files were created for each of the E-beam sources. The final results were then convolved to represent the combined presence of both E-beams. The top beam was placed 14 cm from the top surface of the material. The bottom beam was placed 14 cm from the bottom surface of the stainless steel trough. The general source definition (SDEF) cards used to define the top and bottom E-beam windows are shown in FIGS. 65 and 66, respectively.

Tallies:

Energy deposition per source particle was tallied in each problem for this study. For each material (aerobically digested municipal biosolids, anaerobically digested municipal biosolids, and effluent water), a comprehensive dose profile was created using *F8 lattice tallies. The *F8 tally is a pulse height tally with modified units of MeV per source particle. The pulse height tally records the energy deposited in a particular cell by each source particle and all secondary particles. For the pulse height tally in particular, microscopic events must be modeled much more realistically than for other tallies.

The lattice tally format allows for simplified syntax to specify a tally for particular voxels in a lattice geometry. As specified in the geometry, each lattice element, or voxel, in this problem measures 14 cm×2 cm×1 cm. The problem employs 5 voxels in the length (X) dimension, 5 voxels in the width (Y) dimension, and 6 voxels in the depth (Z) dimension for a total of 150 voxels. The tally cards used to specify this lattice tally over 150 total voxels are shown in FIG. 67. The FC card shown in the figure is a comment card used to describe the tally in the problem output file.

After obtaining the *F8 tallies from the MCNP5 input file, a conversion equation may be necessary to translate the MCNP5 results into calculations for dose rate in the material. The derivation for this conversion is shown in equations (0.2) and (0.3).

$$\begin{matrix}\frac{M ( \frac{MeV}{e} ) • I ( \frac{C}{s} ) • \frac{1 e}{1.602 e - 19 C} • \frac{1.602 e - 13 J}{MeV}}{m ( kg )} • \frac{1 kGy}{1000 Gy} = D ( \frac{kGy}{s} ) , & ( 0.2 ) \\ D ( \frac{kGy}{s} ) = 1000 • \frac{MI}{m} , & ( 0.3 )\end{matrix}$$

where,
M=*F8 tally result,
I=beam operating current, and
m=voxel mass.

Other Data Cards:

The mode for this problem was set to “e p,” instructing the MCNP code to track all electrons and secondary photons. A “random number generation” (RAND) card was used to increase the number of random numbers between source particles, or the “stride,” to 1 million. Each calculation in this study simulated 150,000 to 10,000,000 particle histories to minimize statistical error to less than 5% for each tally. For the large lattice tallies, the “tally no print” (TALNP) card was used to prevent the tallies from printing in the output file, and the “print and dump cycle” (PRDMP) card was used to create a separate file containing the tally values, known as a MCTAL file. Writing to a MCTAL file often may allow for easier post-processing of the data.

Density/Solids Model:

MCNP5 was also used to study the effect of solids content on the dose distribution in the material. To study these effects, it may have been first necessary to find the density of the dewatered municipal biosolids. First, the density of the municipal biosolids samples (watered) was measured using conventional methods. To find the density of the solids, a simple formula was derived using the definition of density:

$$\begin{matrix}ρ = \frac{m}{V} = \frac{{m}_{a} + {m}_{b}}{V} = \frac{{ρ}_{a} {V}_{a} + {ρ}_{b} {V}_{b}}{V} = \frac{{ρ}_{a} {V}_{a}}{V} + \frac{{ρ}_{b} {V}_{b}}{V} & ( 0.4 ) \\ ρ = {ρ}_{a} {ω}_{a} + {ρ}_{b} {ω}_{b} & ( 0.5 )\end{matrix}$$

In equations (0.4) and (0.5), the subscripts “a” and “b” represent two species in a mixture. For the purposes of this model, subscript “a” represented water, and subscript “b” represented the soil solids. In equation (0.5), “w” represents the solids volume fraction in each sample. This fraction was measured by centrifuging both municipal biosolids samples at a high speed (8000 rpm) and measuring the volume of the settled solids. The anaerobically digested municipal biosolids sample was found to contain 25.5% solids by volume, and the aerobically digested municipal biosolids sample was found to contain 37% solids by volume. Using the measured sample densities, the densities for the anaerobically and aerobically digested municipal biosolids solids were calculated to be 0.9153 g/cm³ and 0.9108 g/cm³, respectively. By increasing the theoretical solids volume concentrations, linear interpolation was used to calculate the corresponding mass concentrations.

These calculations were performed for solids volume concentrations of 50%, 60%, 70%, 80%, and 90%. In order to quote the results in the form of percent solids by mass, a linear interpolation was performed using the sample volume and mass concentrations as the known values as represented by equation (0.6) below.

$$\frac{{m}_{s}}{{v}_{s}} = \frac{{m}_{p}}{{v}_{p}} , \qquad ( 0.6 )$$

where,
mₛ=mass concentration of solids in municipal biosolids sample,
vₛ=volume concentration of solids in municipal biosolids sample,
mₚ=mass concentration of solids for perturbation (unknown), and
vₚ=volume concentration of solids for perturbation.

Evaluating the effect of moisture content on the dose deposition in the municipal biosolids material was deemed valuable for several reasons. First, the moisture content of municipal biosolids may vary depending upon the wastewater processing plant. Evaluating the moisture and corresponding density effects may serve to gauge the adaptability of the chosen methods for this study. In addition, particular treatment plants may choose to water or dewater the municipal biosolids to aid in transportability to or from the plant and/or to facilitate transport through the treatment process itself. For example, the municipal biosolids material may need to be dewatered in order to transport it via a conveyor system or watered in order to transport it via a gravity- or pump-fed trough system. Again, evaluation of these effects helps to determine whether changing the moisture content for logistical considerations will greatly affect the efficiency of the treatment process. Lastly, results from some studies have suggested that lowering the moisture content in municipal biosolids material can prevent re-growth of organisms when long-term storage is part of the treatment process. It has previously been found that re-growth may be prevented at moisture levels of less than 20% at an optimal temperature of 37° C. Given this assertion, it may have been extremely important to also evaluate changes in the dose distribution at lower moisture levels in case a dewatering method is used to help prevent organism re-growth.

To add validity to the use of the MCNP5 radiation transport code for the dose models in this study, a verification study was performed. For the verification study, 20-mL municipal biosolids and water samples were placed into 2″×3″ (5.08 cm×7.62 cm) zippered storage bags using a 10-mL pipette. Alanine dosimeters were placed at the top left-hand corner, middle interior, and bottom right-hand corner of each bag. Five samples were prepared for each of the material samples, resulting in 15 bags and 45 dosimeters in all. Since alanine is easily damaged by moisture, each dosimeter was heat-sealed into a polyethylene bag. After the bags were loaded with dosimeters, they were taped to a ⅛″-thick (0.3175 cm) polyethylene board. Another polyethylene board was placed on top of the bags. This board was weighted down with bricks to keep the experimental configuration in place while in motion on the E-beam conveyor. After irradiation, the dosimeter packets were unloaded from the material packets, and the alanine dosimeters were removed from their heat-sealed packaging. Each dosimeter was numbered, and the absorbed dose was read using an electron spin paramagnetic resonance spectrometer (Bruker BioSpin Corp., Billerica, Mass.).

The prepared samples were irradiated at the National Center for Electron Beam Research located at Texas A&M University. One 10 MeV E-beam located approximately 8.5″ (21.6 cm) below the sample box was used for the irradiation. For this benchmark, the approximate target dose was set by the facility staff at 2.5 kGy. This predicted target dose called for a conveyor speed of approximately 37 ft/min (18.8 cm/s). During the irradiation, the beam current was 1695 μA.

For the benchmark verification study, two MCNP5 models were analyzed—a simplified version and a detailed version. For the simplified version, the dosimeter-loaded material packets were modeled along with the lower 10 MeV E-beam. For all models, the E-beam exit window was modeled with dimensions of 29″×4″ (73.66 cm×10.16 cm). The dosimeter packets themselves were not modeled; only the material (aerobically digested municipal biosolids, anaerobically digested municipal biosolids or water) and the alanine dosimeters were included.

Dose-deposition analyses were performed for the municipal biosolids and wastewater effluent irradiation configurations proposed. The data for these analyses were obtained using the MCNP5 radiation transport code. The flexibility of MCNP5 input file construction served as an asset to this study. A single code could, therefore, be modified to accommodate differing materials, material densities, material thicknesses, and voxel sizes.

The MCNP5 code was first used to study the dose deposition in the municipal biosolids samples and in effluent water. Dose deposition was calculated in three-dimensional voxels across six X-Y slices and in 25 depth slices. The voxel dimensions were defined as 14 cm×5 cm×1 cm. Dose rates were calculated in each of the 150 problem voxels using *F8 lattice tallies in MCNP5. The MCNP5 code employs *F8 tallies to calculate the energy deposition per source particle in specified problem cells. All *F8 tally results were converted to dose rate using Eq. (0.3).

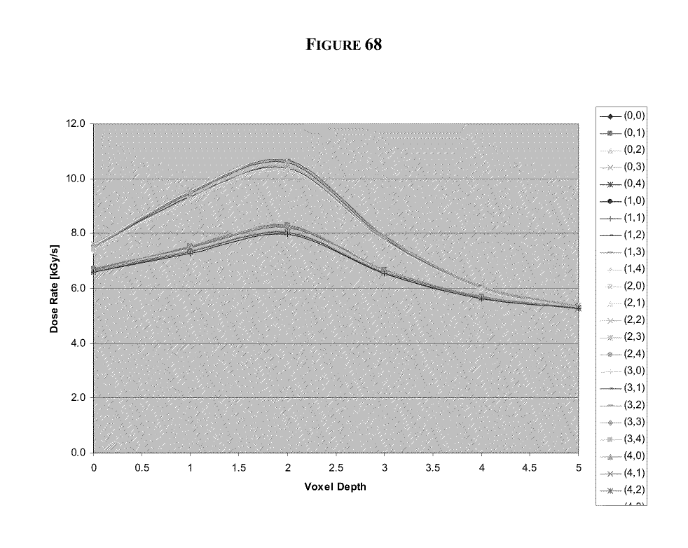

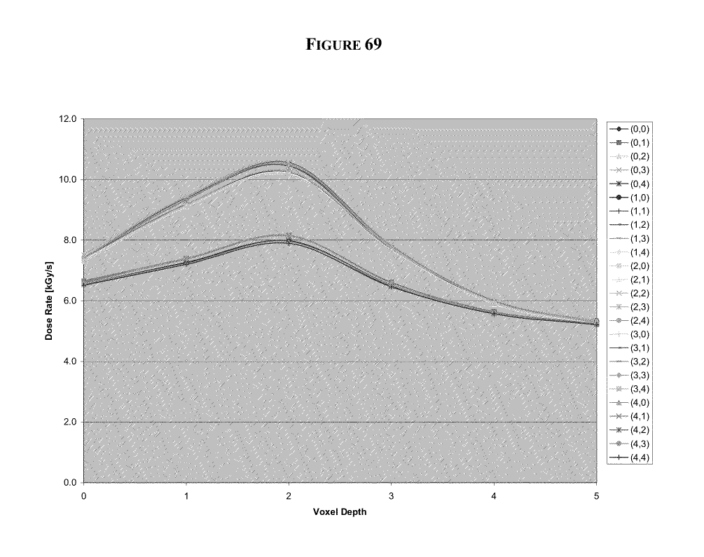

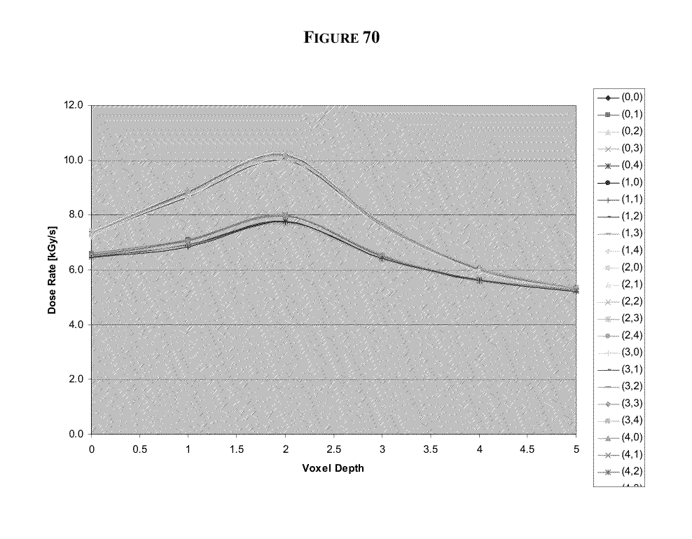

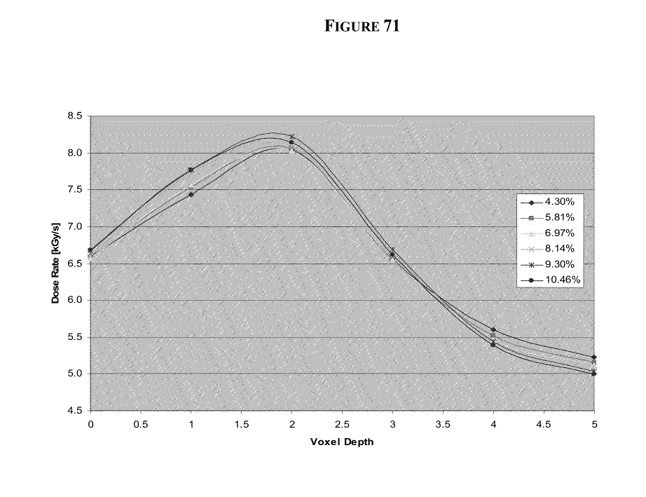

Depth-dose curves were created for the aerobically digested municipal biosolids, the anaerobically digested municipal biosolids, and wastewater effluent models. Curves at each (x,y) location for each material are shown in FIGS. 68-70.

The trends in the depth-dose curves for the three materials studied were quite similar. The three materials all show clustering around two average curves. The placement of the curves depends upon the location of the (x,y) pair in the material. The bottom set of curves consists of the points on the two x-dimension borders, i.e. points (0,y) and (4,y). These points were surrounded by less bordering material and thus may receive less in-scatter of particles. The points on the two y-dimension borders are not included on this lower curve most likely because the voxels are much shorter in the y-dimension than in the x-dimension. Because of the concentration of curves on any given plot, error bars were not added to the figures. In this case, relative error represents the statistical perturbations in the Monte Carlo simulations. The simulations have been constructed such that all relative errors are less than 5%.

For all curves, the maximum dose rate occurs at the z=2 voxel which extends from 2 to 3 cm from the top of the material rectangular parallelepiped. The minimum dose rate value occurs at the z=5 voxel which extends from 5 to 6 cm from the top of the material rectangular parallelepiped. The bottom of the material receives a smaller dose than the top of the material because some of the electrons scatter and lose energy in the stainless steel of the trough before entering the waste material. The lowest and highest maximum/minimum ratios are shown in Table 34.

TABLE 34

| Material | Lowest Ratio | Highest Ratio |
|---|---|---|
| TAMU | 1.46 | 1.93 |
| ATAD | 1.52 | 1.99 |
| Water | 1.47 | 1.93 |

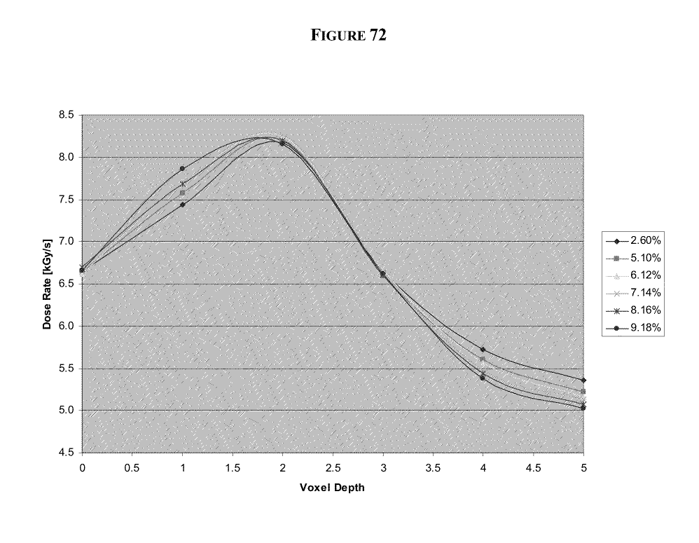

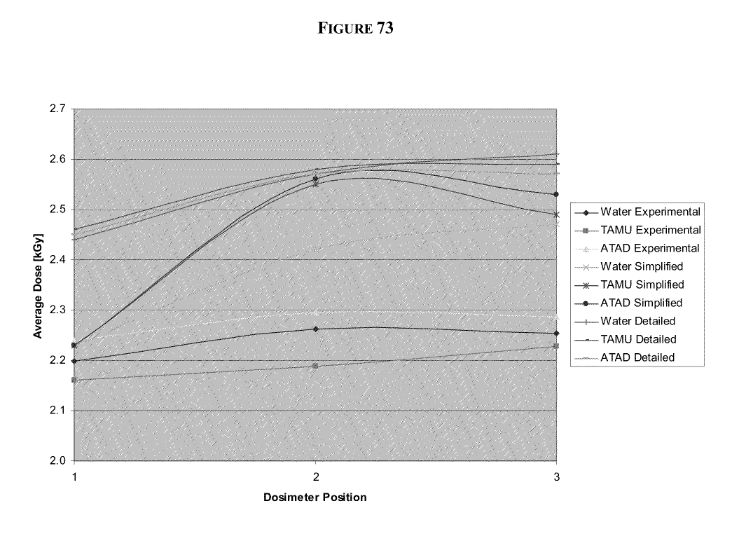

To analyze the adaptability of this study for applications with other material compositions, a density perturbation study was performed for the aerobically digested and anaerobically digested municipal biosolids samples used for this project. The depth-dose curves for mass concentrations of 4.30%, 5.81%, 6.97%, 8.14%, 9.30%, and 10.46% in aerobically digested municipal biosolids are shown in FIG. 71. The depth-dose curves for mass concentrations of 2.60%, 5.10%, 6.12%, 7.14%, 8.16%, and 9.18% in anaerobically digested municipal biosolids are shown in FIG. 72.

The depth-dose curve variations in FIGS. 71 and 72 show the same trend. As mass concentration increases, the dose rate values increase in the area before the pivot point and decrease in the area after the pivot point. These examples show that the types of atoms in a material have more bearing on the dose rate result than the concentration of those atoms. Since the dry municipal biosolids material may have a specific gravity less than 1, an increase in solids concentration may lower the overall density of the mixture. However, increased electron scatter in the municipal biosolids material raises the depth-dose curve as the solids concentration increases.

A benchmark study was performed to validate the use of MCNP5 software for studying municipal biosolids and wastewater effluent irradiation. Two MCNP5 models were constructed for the study. The first model (simplified) included only the material and dosimeters in the packets placed above the E-beam window. The second model (detailed) included the material packets, E-beam exit window, polycarbonate plates, and the bottom of the cardboard box. For the purpose of the models, the material packets were modeled individually, and the experimental values were averaged for each set of material packets.

As in the previous MCNP5 models, *F8 tallies were employed in the problem to record the simulated energy deposition in units of MeV/source particle. To convert these values to overall dose deposited in each dosimeter, Eq. (0.3) was used to first calculate the dose rate in each dosimeter. This dose rate was multiplied by the time it took for the sample to pass over the E-beam exit window, 0.54 seconds in this case.

FIG. 73 shows the top-to-bottom depth-dose curves for the dosimeter placements in the experiment, simplified model, and detailed model. Table 35 shows the dose deposition values and the fractional difference between the models and the experimental values. Since the goal of this exercise was to benchmark the Monte Carlo code, the experimental values were taken as the “true” values for the fractional difference calculation.

TABLE 35

| | | Experimental | Simplified Monte Carlo | | | Detailed Monte Carlo | | |
|---|---|---|---|---|---|---|---|---|
| Material | Position | Dose [kGy] | Dose [kGy] | RE | Difference | Dose [kGy] | RE | Difference |
| Water | 3 | 2.25 | 2.47 | 0.0222 | 0.096 | 2.61 | 0.0215 | 0.158 |
| Water | 2 | 2.26 | 2.42 | 0.0227 | 0.070 | 2.57 | 0.0214 | 0.136 |
| Water | 1 | 2.20 | 2.23 | 0.0234 | 0.015 | 2.44 | 0.0228 | 0.110 |
| TAMU | 3 | 2.23 | 2.49 | 0.0219 | 0.118 | 2.59 | 0.0214 | 0.162 |
| TAMU | 2 | 2.19 | 2.55 | 0.0220 | 0.165 | 2.58 | 0.0219 | 0.179 |
| TAMU | 1 | 2.16 | 2.23 | 0.0234 | 0.032 | 2.46 | 0.0228 | 0.139 |
| ATAD | 3 | 2.29 | 2.53 | 0.0218 | 0.107 | 2.57 | 0.0215 | 0.124 |
| ATAD | 2 | 2.30 | 2.56 | 0.0219 | 0.115 | 2.57 | 0.0219 | 0.120 |
| ATAD | 1 | 2.24 | 2.23 | 0.0234 | 0.004 | 2.45 | 0.0228 | 0.094 |

In FIG. 73, the result curves cluster according to type (experimental, simplified, or detailed) rather than by material. This is to be expected since the material compositions differ less than the actual result methodologies. Table 35 shows that difference between the simplified Monte Carlo values and the experimental values varies from 0.4% to 16.5%. The difference between the detailed Monte Carlo values and the experimental values varies from 9.4% to 17.9%. These difference values do not take into account the statistical relative errors that are also given in Table 35. It is believed that these difference values indicate excellent correlation between the experimental measurements and the modeled dose deposition calculations. In turn, these values may show convincing evidence that Monte Carlo simulation is a useful tool for analyzing dose deposition in the wastewater materials considered for this study.

### Example 8

### Preliminary Cost-Benefit Analysis of Adopting E-Beam Treatment of Municipal Biosolids

The objective of this example was to perform a preliminary cost-benefit analysis of adopting E-beam treatment for municipal biosolid treatment. Performing a detailed cost-benefit analysis (economic analysis) may be a very defined and detailed undertaking. An attempt was made to obtain an economic analysis of E-beam irradiation of biosolids. To accomplish this task, telephone consultations were carried out with E-beam equipment manufacturers in the United States and Canada.

Economic viability of a wastewater treatment plant may most easily be analyzed by first determining the throughput rate of the treatment process. The lowest dose rate across all materials for all voxel units in the study was 5.2 kGy/s. By using the lowest dose-rate values for each material and a target dose of 15 kGy, it was determined that each voxel of material should be exposed to the E-beam for 2.88 seconds. It must be highlighted here that 15 kGy is an upper estimate of the dose required for pathogen destruction. All of the pathogen reduction experiments in this study were carried out at 8 kGy to allow for observable reduction. If the experiments would have been carried out at 15 kGy, microbial counts would have been zero and hence not suitable for analysis. A recommended dose of 15 kGy may give a large enough safety margin to ensure sufficient reduction of pathogens. It also must be emphasized that the costing assumptions made in this section are best estimates based on College Station, Tex. costs. Land prices, salaries, etc., may vary significantly across the country and the globe.

Throughput rates have been calculated for an E-beam configuration similar to that of the National Center for Electron Beam Research at Texas A&M University. The Texas A&M facility utilizes two 18 kW accelerators operating at approximately 2 mA current. Using the samples from the College Station (ATAD) and Texas A&M University (anaerobic) wastewater treatment plants as examples, i.e. mass concentrations of 2.6% for TAMU and 4.3% for ATAD, the mass flow rate of material under the beam window may be 1.5 kg of dry ATAD municipal biosolids in 2.88 seconds and 1.05 kg of dry TAMU municipal biosolids in 2.88 seconds. These values may result in throughput rates of 11,250 dry tons of ATAD municipal biosolids per year and 7,875 dry tons of TAMU municipal biosolids per year. These calculations assume 20 hours of operation per day for 300 days per year at 2 mA current. This plant can also process 3.15×107 L/y of effluent water.

Throughput rates have also been computed for an accelerator system similar to the IMPELA specifications of 50 kW power and 100 mA operating current. Eq. (0.3) stipulates that the dose rate imparted by the electron beam system is directly scaled by the operating current. Therefore, the throughput values may be directly scaled as well. The throughput capacities for the 2 mA and 100 mA accelerator cases are shown in Table 36 in units of dry tons/year and m³/day.

TABLE 36

| | Capacity (dry tons/year) | | Capacity (m³/day) | |
|---|---|---|---|---|
| | TAMU | ATAD | TAMU | ATAD |
| I = 2 mA, P = 18 kW | 7,875 | 11,250 | 28.63 | 38.78 |
| I = 100 mA, P = 50 kW | 393,750 | 562,600 | 1332 | 1927 |

To calculate the capital cost per dry ton, it was assumed that a dual-beam facility would cost on the order of $15 million. The amortization of this value over 10 years at 7% interest with a 20% ($3 million) down payment would result in monthly payments of $139,330. With the throughput rates calculated above, the capital cost for ATAD municipal biosolids processing may be $258 per dry ton with the NCEBFR electron beam specifications and $5.16 per dry ton with the IMPELA electron beam specifications. The capital cost for TAMU municipal biosolids processing may be $369 per dry ton with the NCEBRF specifications and $7.37 with the IMPELA specifications. The capital cost for processing the effluent water may be $0.092/L with the NCEBRF specifications and $0.00184 with the IMPELA specifications.

To evaluate the operating cost per dry ton, factors of electricity, labor, administration, and miscellaneous items were considered. Two 18 kW accelerators operating 6000 hours per year may consume 216,000 kW-h of electricity. At $0.10/kW-h, yearly electricity costs for the beam configuration may be $21,600. Electricity for the facility was expected to cost approximately $30,000 per year. For maintenance of the facility, $200,000 per year was budgeted. An average salary of $50,000 per year per employee for 20 employees will cost $1 million per year. In addition, $150,000 has been budgeted for administrative costs and $100,000 has been budgeted for miscellaneous expenses. These expenses result in a total yearly operating cost of $1.502 million. The given throughput rates result in operating costs of $232/dry ton for ATAD municipal biosolids, $331/dry ton for TAMU municipal biosolids, and $0.083/L of effluent water. The breakdown for the facility operating costs is shown in Table 37.

TABLE 37

| Item | Cost per Year |
|---|---|
| Electricity | $51,600 |
| Maintenance | $200,000 |
| Labor | $1,000,000 |
| Administration | $150,000 |
| Miscellaneous | $100,000 |
| Total Operating Costs | $1,501,600 |

Operating costs were determined for the NCEBFR and IMPELA accelerator specifications. Since the IMPELA operates at 50 kW with a current of 100 mA, the increased current increases the dose rate in the material by 50 times, allowing 50 times the material processing capacity provided by the 2 mA accelerators. However, the electricity operating cost for the accelerators increases by 2.8 times as a result of the increased power. Therefore, the operating costs in this case will total $1.54 million as opposed to $1.50 million for the 2 mA case. The operating cost per dry ton per year for the ATAD and TAMU municipal biosolids processed under NCEBFR conditions will equal $232 and $378, respectively. These operating costs are drastically reduced when the IMPELA specifications are considered. The operating cost per dry ton per year under IMPELA specifications for the ATAD and TAMU municipal biosolids processing will equal $4.75 and $6.79, respectively. These figures assume that the accelerator exit window can be fabricated with the same dimensions for both the 2 mA and 100 mA cases. These values compare favorably with the IMPELA concept. The IMPELA study calculated the capital cost for an $8 million facility at $444 per dry ton and the operating cost at $378/dry ton. Given that these values represent an imparted dose of 800 kGy, the IMPELA system can be expected to cost approximately $8.33 in capital costs per dry ton and $7.08 in operating costs per dry ton to achieve a 15 kGy target dose. The operating and capital costs for processing TAMU and ATAD municipal biosolids with the 2 mA and 100 mA accelerators as designed for this research are given in Table 38.

TABLE 38

| | Operating Cost | | Capital Cost | |
|---|---|---|---|---|
| | ($/dry ton) | | ($/dry ton) | |
| | TAMU | ATAD | TAMU | ATAD |
| I = 2 mA, P = 18 kW | 378 | 232 | 369 | 258 |
| I = 100 mA, P = 50 kW | 6.79 | 4.75 | 7.37 | 5.16 |

An economic viability study for this irradiation design would be incomplete without a comparison with other traditional wastewater treatment methodologies. Table 39 gives the cost per dry ton for incineration, thermophilic aerobic digestion, co-composting, thermophilic anaerobic digestion, thermophilic alkaline treatment, and heat drying. While the cost estimates for processing with the 2 mA accelerator system are not competitive with these methods directly, it is important to remember that the methods in Table 39 are often used in tandem. However, the 100 mA irradiation scenario is much less expensive than any conventional method taken individually. A previous study showed that 100 mA accelerators can be effectively employed for this purpose, supporting a claim that electron beam irradiation is far more cost effective than conventional wastewater treatment methods. It is not necessary to take into account the cost of anaerobic and aerobic pre-treatment of the ATAD and TAMU municipal biosolids, respectively, since the 15-kGy target dose is expected to function as an independent treatment step with no additional pretreatment needed.

TABLE 39

| Method | Cost ($/dry ton) |
|---|---|
| Incineration | 250 |
| Thermophilic Aerobic Digestion | 180 |
| Co-composting | 150 |
| Thermophilic Anaerobic Digestion | 110 |
| Thermophilic Alkaline Treatment | 85 |
| Heat Drying | 85 |

This study indicates that the addition of E-beam technology to chemical oxidants such as ferrate can result in enhanced disinfection and stabilization of municipal biosolids. The addition of a chemical oxidant such as ferrate can lead to a reduction in the E-beam dose that needs to be applied to achieve the desired level of disinfection. A reduction of E-beam dose may lead to reduced process time thereby reduced cost. By combining E-beam technology and ferrate technology it is possible for the wastewater industry to exploit the unique advantages of these two technologies.

It must be emphasized that in this study the experiments were all performed using digester samples. Given the strong disinfection efficiency of E-beam, it could be envisioned that this technology be placed closer to the front of the wastewater treatment plant so as to significantly reduce microbial pathogens in the initial stages and allow the plant engineers to exploit the technology to solubilize the organic matter. Previous studies have shown that even at doses well below 15 kGy, significant reductions of organic pollutants can be achieved, as shown in Table 40. The increased solubilization of organic matter due to E-beam irradiation would be beneficial in the subsequent steps in the treatment process to enhance the treatment efficiency. Increased solubilization leads to improved activated sludge systems and better BOD reductions downstream.

TABLE 40

| Parameter | % Removal | Dose | | Reference |
|---|---|---|---|---|
| Chloroform | 99 | 6 | kGy | Kurucz et al., 1995 |
| Bromoform | >99 | 0.8 | kGy | Kurucz et al., 1995 |
| Carbon tetrachloride | >99 | 0.8 | kGy | Kurucz et al., 1995 |
| Trichloroethylene (TCE) | >99 | 5 | kGy | Kurucz et al., 1995 |
| Tetrachlorethylene (PCE) | >99 | 5 | kGy | Kurucz et al., 1995 |
| 1,1 dichloroethene | >99 | 8 | kGy | Kurucz et al., 1995 |
| 1,2 dichloroethene | 60 | 8 | kGy | Kurucz et al., 1995 |
| 1,1,1 trichlooethane | 89 | 6.5 | kGy | Kurucz et al., 1995 |
| Toluene | 97 | 6.5 | kGy | Kurucz et al., 1995 |
| Cholorbenzene | 97 | 6.5 | kGy | Kurucz et al., 1995 |
| Ethylbenzene | 92 | 6.5 | kGy | Kurucz et al., 1995 |
| Dieldrin | >99 | 8 | kGy | Kurucz et al., 1995 |
| Cryptosporidium parvum | 100 | 2 | kGy | Collins et al., 2005 |
| infectivity | | | | |

Based on these results it appears worthwhile to evaluate from an engineering and cost-basis the ideal location for an E-beam source. The ability to irradiate incoming wastewater at 15 kGy may offer significant disinfection capability, significant organic matter solubilization, and possibly estrogenic compound destruction. It must be pointed out that current E-beam engineering designs permit the opportunity to irradiate multiple streams within a single plant. Thus, it is theoretically possible to irradiate not only the incoming waste stream but also irradiate the wastewater effluent thereby guaranteeing pathogen-free and estrogenic compound free effluent discharges. There is synergism between the usage of chlorine dioxide or ferrate in disinfection, but ferrate is effective in reducing the estrogenic compounds and assists in stabilization. The cost of using ferrate may be in the range of $100 per dry ton making the E-Beam/ferrate process a potentially viable Class A disinfection process. It may be much lower than the Cambi Process™ and processes that are aiming to pre-treat municipal sludge before mesophilic anaerobic digestion.

### Example 9

### Example Process

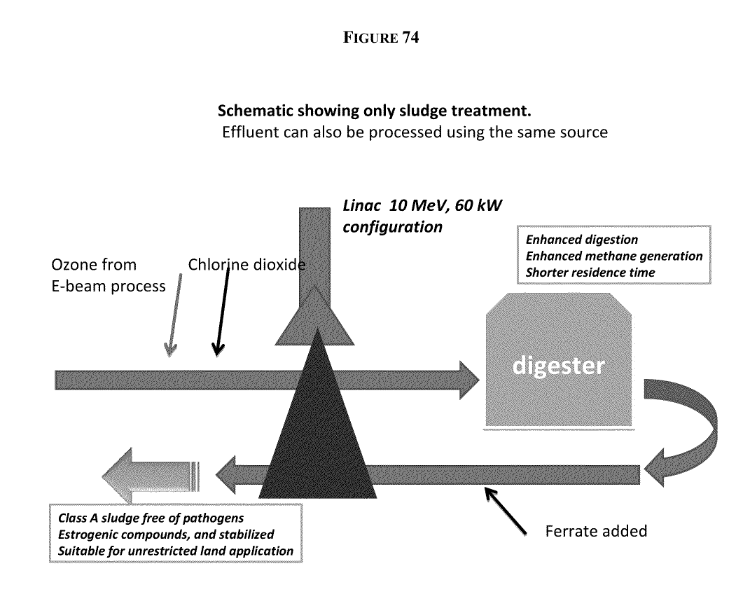

FIG. 74 shows a schematic representation of an exemplary process according to one embodiment of the present disclosure. FIG. 74 is designed for use with biosolids, but is readily adaptable for use with wastewater.

### Example 10

### Electron Beam-Chemical Oxidation (EChO)

Four different methylene blue concentrations were prepared and irritated at 11 kGy with 10 MeV E-beam. Following the E-beam radiation, the bags containing the methylene blue concentrations were opened and allowed to reoxidize in the presence of ambient oxygen. It was observed that while some of the blue color returned, not all of it did. It is believed that this test indicates that a certain percentage of the dye molecules were deactivated an unable to reoxidize. It is also believed that this test indicates the at certain levels, E-Beam irradiation treatment in liquid is a net reductive process.

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

What is claimed is:

1. A method for treating water comprising:
providing a quantity of water;
treating the quantity of water with a chemical oxidant; and
treating the quantity of water with E-beam radiation.

2. The method of claim 1, wherein the water comprises wastewater generated from an aerobic digester or an anaerobic digester.

3. The method of claim 1, wherein the water comprises wastewater generated from a biological waste treatment facility.

4. The method of claim 1, wherein the water comprises wastewater generated from a municipal sludge.

5. The method of claim 1, wherein the water comprises a sludge.

6. The method of claim 1, wherein the chemical oxidant is selected from the group consisting of chlorine dioxide, ferrate, and a combination thereof.

7. The method of claim 1, wherein treating the quantity of water with a chemical oxidant comprises treating the water with a dose of chemical oxidant in the range of 2 mg/L to about 200 mg/L.

8. The method of claim 1, wherein the step of treating the quantity of water with E-beam radiation comprises treating the water with a dose of E-beam radiation sufficient to provide reducing conditions.

9. The method of claim 1, wherein treating the quantity of water with E-beam radiation comprises treating the water with a dose of E-beam radiation in the range of 2 kGy to about 20 kGy.

10. The method of claim 1, wherein treating the quantity of water with a chemical oxidant occurs separately from treating the quantity of water with E-beam radiation.

11. The method of claim 1, wherein treating the quantity of water with a chemical oxidant occurs before treating the quantity of water with E-beam radiation.

12. The method of claim 1, wherein treating the quantity of water with a chemical oxidant occurs after treating the quantity of water with E-beam radiation.

13. The method of claim 1, wherein treating the quantity of water with E-beam radiation occurs both before and after treating the quantity of water with E-beam radiation.

14. The method of claim 1, further comprising recovering ozone generated by the E-beam radiation.

15. The method of claim 1, further comprising recovering methane.

16. The method of claim 1, further comprising recovering a Class-A biosolid.

17. The method of claim 1, wherein the water comprises an estrogenic compound.
